(19) United States
(12) Patent Application Publication
(10) Pub. No.: US 2023/0151136 A1
(43) Pub. Date: May 18, 2023

(54) CATALYST COMPOSITION FOR POLYURETHANES

(71) Applicant: MOMENTIVE PERFORMANCE MATERIALS INC., Waterford, NY (US)

(72) Inventors: Gnuni KARAPETYAN, Cologne (DE); Roger Christopher CLARK, Vienna, WV (US); Jason STENGEL, Williamstown, WV (US); Yevgen BEREZHANSKYY, Parkersburg, WV (US)

(21) Appl. No.: 17/907,860

(22) PCT Filed: Mar. 3, 2020
(86) PCT No.: PCT/US2020/020779

§ 371 Date: Aug. 29, 2022

(51) Int. Cl. C08G 18/16; C08G 18/22; C08G 18/18; C08G 18/48; C08G 18/63; C08G 18/40; C08G 18/32; C08G 18/66; C08G 18/76; C08J 9/06

(52) U.S. Cl. CPC C08G 18/163; C08G 18/222; C08G 18/632; C08G 18/1833; C08G 18/3275; C08G 18/4072; C08G 18/4829; C08G 18/6688; C08G 18/7614; C08J 9/06; C08G 2110/0008; C08G 2110/0016; C08G 2110/0025; C08G 2150/60; C08G 2170/60; C08J 2201/022; C08J 2205/05; C08J 2205/06; C08J 2205/08; C08J 2205/10; C08J 2205/052; C08J 2207/02; C08J 2207/04; C08J 2375/08

(57) ABSTRACT

The present invention relates to a composition comprising a copper(II)-salt capable of being used as a catalyst, a process for the manufacture of said composition, the use of said composition as a catalyst, in particular, as catalyst for the reaction of at least one isocyanate compound with at least one isocyanate-reactive compound, in particular for the manufacture of polyisocyanate polyaddition products, such as polyurethanes, in particular, polyurethane foams.

### DESCRIPTION

The present invention relates to a composition comprising a copper(II)-salt (Cu(II)-salt) capable of being used as a catalyst, a process for the manufacture of said composition, the use of said composition as a catalyst, in particular, as catalyst for the reaction of at least one isocyanate compound with at least one isocyanate-reactive compound, in particular for the manufacture of polyisocyanate polyaddition products, such as polyurethanes, in particular, polyurethane foams.

Polyurethane foams are produced by reacting a di- or polyisocyanate (or prepolymers made thereof) with compounds containing two or more active hydrogens (chain extenders, polyether polyols, polyester polyols, polyether amines and others), generally in the presence of blowing agent (chemical blowing agents like water etc. and physical blowing agents like pentane, cyclopentane, halohydrocarbons etc.), catalysts (tertiary amines, and metalorganic derivatives of tin, bismuth, zinc and others), silicone-based surfactants and other auxiliary agents. Two major reactions are promoted by the catalysts among the reactants during the preparation of polyurethane (PU) foam, gelling and blowing. Development of efficient gelling catalysts exhibiting high catalytic activity beneficially enables a decrease of curing times required for polyurethane foams and hereby advantageously reduce production cycles of final foam articles. Organotin compounds have been often the catalysts of choice promoting gel reaction. Organotin catalysts are being more and more challenged from some environmental and worker exposure standpoint. Consequently, efficient, non-toxic gel catalysts are highly required in PU industry.

US2017/0225158A1 describes the use of copper catalyst composition comprising a copper (II) compound dissolved in a solvent for preparation of mechanically frothed foams and elastomers. WO2012/006263A1 describes the use of copper catalysts for the production of polyurethane elastomers. The catalyst is composed of copper atom and certain polydentate ligands. The polydentate ligands are generally derivatives of Schiff base and contain at least one nitrogen. WO2002048229A1 describes amine containing carbamates as catalyst in the manufacture of polyurethanes.

Most polyurethane foams emit volatile organic compounds. These emissions can be composed of, for example, contaminations present in raw materials, catalysts, degradation products or unreacted volatile starting materials or other additives. Amine emissions from polyurethane foam have become a major topic of discussion particularly in car interior applications, in furniture or mattresses and the market is therefore increasingly demanding low-emission foams. The automotive industry in particular requires significant reduction of volatile organic compounds (VOC) and condensable compounds (fogging or FOG) in foams.

An evaluation of VOC and FOG profiles of PU foams can be conducted by VDA 278 test. One of the main components of VOC emitting from flexible molded foams is the amine catalyst. To reduce such emissions, catalysts having a very low vapor pressure should be used. Alternatively, if the catalysts have reactive hydroxyl or amine groups they can be linked to the polymer network. If so, insignificant amounts of residual amine catalyst will be detected in the fogging tests. However, the use of reactive amine is not without difficulties. Reactive amines are known to degrade some fatigue properties such as humid aging compression set. Furthermore, the widely used reactive amines are monofunctional and promote chain termination during polymer growth and by becoming covalently bound to the polymer matrix lose their agility as catalysts. Thus, the development of efficient polyurethane catalysts with low emission profile is one of the important targets of modern polyurethane industry.

Despite the attempts made in the prior art there is still a need for polyurethane foams having improved physical properties such as firmness, stiffness or load bearing capacity as reflected in particular by the higher Indentation Load (Force) Deflection or ILD (IFD) which in turn depends on the curing degree of the polyurethane foams which in turn depends on the catalyst performance.

The present inventors have found out that a specific composition comprising a copper(II)-salt provides an improved catalyst performance leading to better curing degrees and improved physical properties of polyurethane foams. The invented catalyst composition can also be used as an efficient catalyst in polyurethane formation with low emission profile.

In accordance with the present invention there is thus provided a composition, comprising at least one Cu(II)-salt, at least one compound which is obtainable by reacting at least one isocyanate compound and at least one isocyanate-reactive compound having at least one tertiary amino group, and optionally one or more diluents.

In one embodiment of the invention the composition is obtainable by reacting at least one isocyanate compound and at least one isocyanate-reactive compound having at least one tertiary amino group in the presence of at least one Cu(II)-salt and optionally in the presence of one or more diluents. Alternatively it is also possible to first react at least one isocyanate compound and at least one isocyanate-reactive compound having at least one tertiary amino group optionally in the presence of one or more diluents, and thereafter to mix the reaction product with the Cu(II)-salt and optionally one or more diluents.

In a further embodiment of the invention the composition is obtainable by reacting at least one polyisocyanate compound, at least one isocyanate-reactive compound having at least one tertiary amino group and at least one isocyanate-reactive compound which does not have a tertiary amino group in the presence of at least one Cu(II)-salt and optionally in the presence of one or more diluents. Also in this embodiment it is also possible to first react at least one polyisocyanate compound, at least one isocyanate-reactive compound having at least one tertiary amino group and at least one isocyanate-reactive compound which does not have a tertiary amino group optionally in the presence of one or more diluents, and thereafter to mix the reaction product with the Cu(II)-salt and optionally one or more diluents In one embodiment of the invention the composition comprises at least one Cu(II)-salt, at least one component selected from the group consisting of a compound which is obtainable by reacting at least one isocyanate compound and at least one isocyanate-reactive compound having at least one tertiary amino group, and optionally one or more diluents.

By the reaction of the isocyanate compound and the isocyanate-reactive compound having at least one tertiary amino group, which is preferably selected from hydroxy- and/or amino-functional compounds thus preferably a composition is formed that comprises a compound, comprising at least one carbamate (urethane) (from the reaction with a hydroxy-functional compound) and/or urea group (from the reaction with an amino-functional compound) and at least one tertiary amino group (which does not react with the isocyanate group), at least one Cu(II)-salt and optionally one or more diluents.

In accordance with the present invention the isocyanate compound which is used to prepare the composition according to the invention can be selected from monoisocyanates and polyisocyanates (having two or more isocyanate groups), and mixtures thereof. Mixtures may include mixtures of monoisocyanates, mixtures of polyisocyanates, or mixtures of one or more monoisocyanates and one or more polyisocyanates. Preferred are polyisocyanates. For example the isocyanate compound can be selected from the group consisting of: octadecylisocyanate; octylisocyanate; butyl and t-butylisocyanate; cyclohexyl isocyanate; adamantyl isocyanate; ethylisocyanatoacetate; ethoxycarbonylisocyanate; phenylisocyanate; alpha-methylbenzyl isocyanate; 2-phenylcyclopropyl isocyanate; 2-ethylphenylisocyanate; benzylisocyanate; meta and para-tolylisocyanate; 2-, 3-, or 4-nitrophenylisocyanates; 2-ethoxyphenyl isocyanate; 3-methoxyphenyl isocyanate; 4-methoxyphenyl isocyanate; ethyl 4-isocyanatobenzoate; 2,6-dimethylphenylisocyanate; 1-naphythylisocyanate; (naphthyl) ethylisocyanates; isophorone diisocyanate (IPDI); toluene diisocyanate (TDI); diphenylmethane-2,4′-diisocyanate (2,4′-MDI); diphenylmethane-4,4′-diisocyanate (4,4′-MDI); hydrogenated diphenylmethane-4,4′-diisocyanate (H.12 MDI); tetra-methyl xylene diisocyanate (TMXDI); hexamethylene-1,6-diisocyanate (HDI); napthylene-1,5-diisocyanate; 3,3′-dimethoxy-4,4′-biphenyldiisocyanate; 3,3′-dimethyl-4,4′-bimethyl-4,4′-biphenyldiisocyanate; phenylene diisocyanate; 4,4′-biphenyldiisocyanate; trimethylhexamethylene diisocyanate; tetramethylene xylene diisocyanate; 4,4′-methylene-bis (2,6-diethylphenyl isocyanate); 1,12-diisocyanatododecane; 1,5-diisocyanato-2-methylpentane; 1,4-diisocyanatobutane; and cyclohexylene diisocyanate and its isomers; uretdione dimers of HDI; trimethylolpropane trimer of TDI, isocyanurate trimers of TDI, HDI, IPDI, biuret trimers of TDI, HDI, IPDI, and mixtures thereof, and polyisocyanates as mentioned before, where the isocyanate groups are partially reacted with at least one isocyanate-reactive compound which does not have a tertiary amino group, preferably selected from OH-, NH-, and NH₂-functional optionally substituted hydrocarbons, which may contain one or more heteroatoms, such as alcohols, like methanol, tert.-butanol, isopropanol, sec.-butanol, OH-functional monoglycol ether, OH-functional diglycol ether etc. Among them preferred isocyanates include meta and para-tolylisocyanate; isophorone diisocyanate (IPDI); toluene-2,4-diisocyanate (2,4-TDI); toluene-2,6-diisocyanate (2,6-TDI); diphenylmethane-2,4′-diisocyanate (2,4′-MDI); diphenylmethane-4,4′-diisocyanate (4,4′-MDI); hydrogenated diphenylmethane-4,4′-diisocyanate (H.12 MDI); tetra-methyl xylene diisocyanate (TMXDI); hexamethylene-1,6-diisocyanate (HDI); napthylene-1,5-diisocyanate; uretdione dimers of HDI; trimethylolpropane trimer of TDI, isocyanurate trimers of TDI, HDI, IPDI, biuret trimers of TDI, HDI, IPDI, and mixtures thereof. More preferred isocyanates include isophorone diisocyanate (IPDI); toluene-2,4-diisocyanate (2,4-TDI); toluene-2,6-diisocyanate (2,6-TDI); diphenylmethane-2,4′-diisocyanate (2,4′-MDI); diphenylmethane-4,4′-diisocyanate (4,4′-MDI); hydrogenated diphenylmethane-4,4′-diisocyanate (H.12 MDI); hexamethylene-1,6-diisocyanate (HDI); napthylene-1,5-diisocyanate and mixtures thereof.

Three- or higher-valent aliphatic polyisocyanates include, in particular, biurets, allophanates, urethanes, isocyanurates and higher oligomers of diisocyanates of in particular hexamethylene diisocyanate (HDI), 1-isocyanato-3,3,5-trimethyl-5-isocyanatomethyl-cyclohexane (IPDI or isophorone diisocyanate) and/or bis(isocyanatocyclohexyl)-methane etc.. Specific examples of such polyisocyanates include e.g.:
the biuret of hexamethylene diisocyanate and oligomers thereof, e.g.:

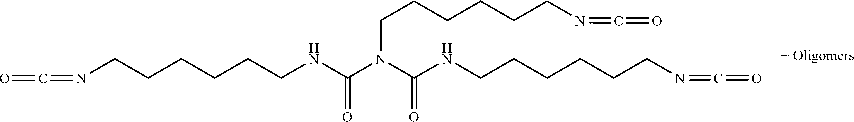

commercially available e.g. as Desmodur® 100.
the isocyanurate trimer of hexamethylene diisocyanate, e.g.:

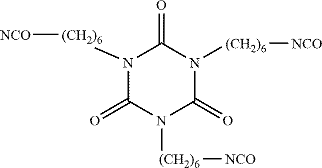

commercially available e.g. as Desmodur® N3300, or higher oligomers thereof such as pentamers:

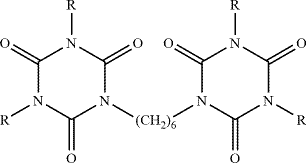

, or asymmetric trimers such as:

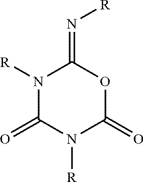

, where R is an isocyanate containing aliphatic residue resulting from HDI, or 4,4′-methylenebis(cyclohexyl isocyanate) (HMDI or hydrogenated MDI).
the isocyanurate trimer of isophorone diisocyanate, e.g.:

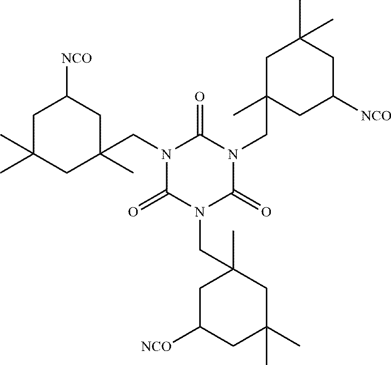

commercially available e.g. as Desmodur® Z4470 or Tolonate IDT 70B.

Further polyisocyanates can be prepared for example from polyhydroxyfunctional compounds or polymers with preferably at least equimolar amount of diisocyanates such as HDI, IPDI or HMDI to form corresponding polyisocyanates.

The preferable isocyanate compounds include aliphatic polyisocyanates, preferably, aliphatic diisocyanate compounds, in particular isophorone diisocyanate (IPDI).

In an embodiment of the invention the isocyanate-reactive compounds having at least one tertiary amino group are selected from the group consisting of alcohols having at least one tertiary amino group, and amines having at least one tertiary amino group and at least one additional amino group selected from primary and secondary amino groups. The isocyanate-reactive compounds may include single isocyanate-reactive compounds or mixtures thereof. The alcohols and amines used as the isocyanate-reactive compounds include saturated, unsaturated and aromatic compounds, preferred are saturated aliphatic alcohols and amines. As the tertiary amino group does not react with the isocyanate group, the reaction product of the isocyanate compound and the isocyanate-reactive compound still has the tertiary amino group. A preferred tertiary amino group is in particular a dialkyl amino group, such as dimethylamino or diethylamino etc. or a cycloamino group such as a piperidino, pyrrolidino, morpholino etc. preferably pyrrolidino.

In an embodiment of the invention the isocyanate-reactive compound comprises at least one ether group, and preferably the isocyanate-reactive compound is selected from the group consisting of aliphatic alcohols having at least one hydroxyl group, at least one tertiary amino group and optionally at least one ether group.

As explained above the compositions of the invention may also comprise a compound which is obtainable by reacting at least one polyisocyanate compound, at least one isocyanate-reactive compound having at least one tertiary amino group and at least one isocyanate-reactive compound which does not have a tertiary amino group. Isocyanate-reactive compounds which do not have a tertiary amino group include various types of alcohols and amines, preferably aliphatic alcohols, such as methanol, ethanol, propanol, butanol and the isomers thereof, or amines such as methylamine, ethylamine, propylamine etc.

Examples of the isocyanate-reactive compound having at least one tertiary amino group are selected from the group consisting of:

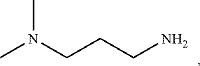

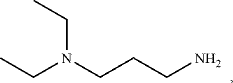

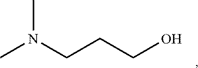

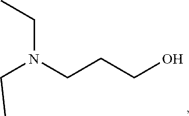

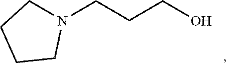

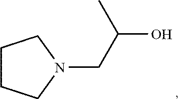

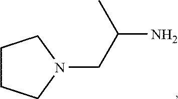

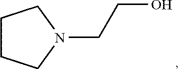

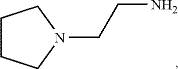

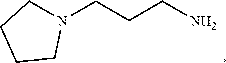

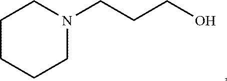

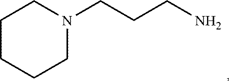

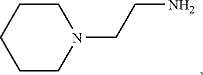

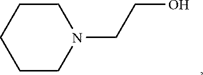

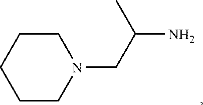

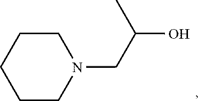

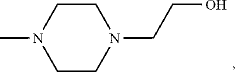

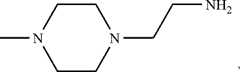

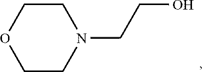

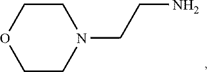

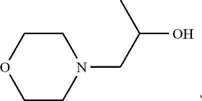

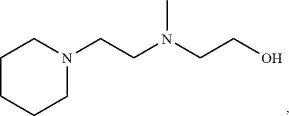

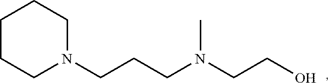

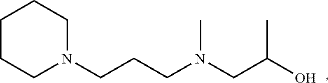

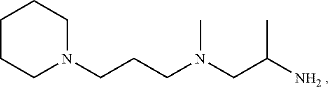

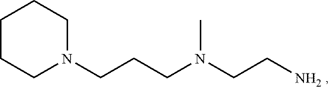

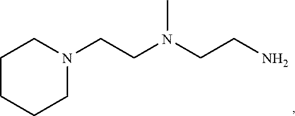

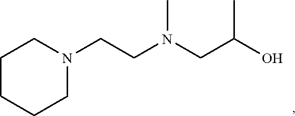

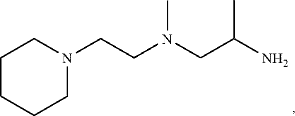

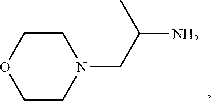

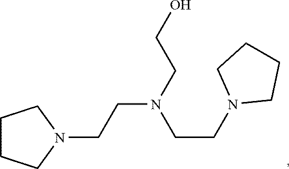

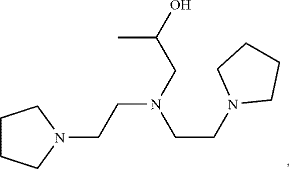

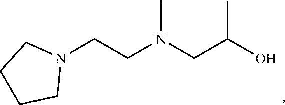

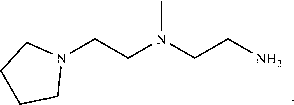

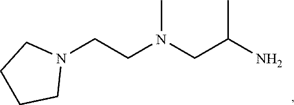

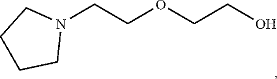

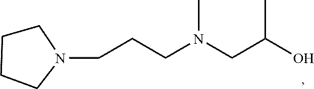

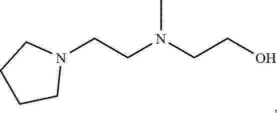

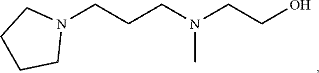

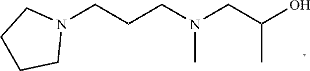

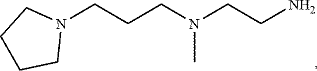

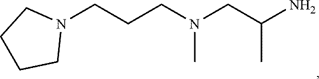

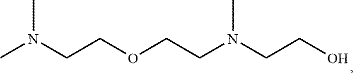

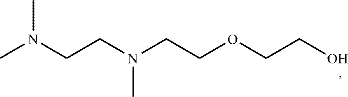

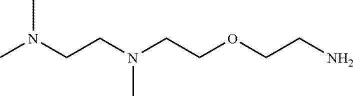

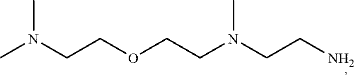

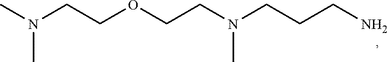

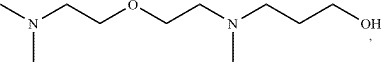

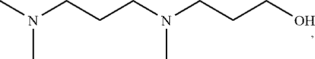

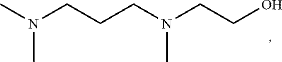

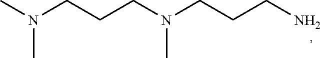

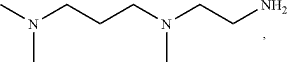

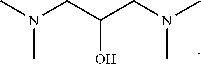

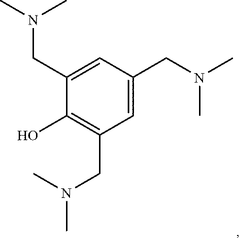

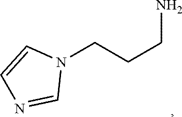

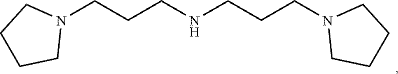

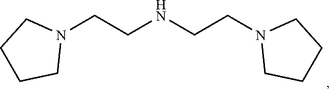

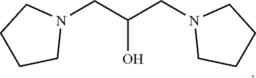

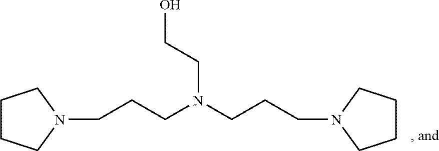

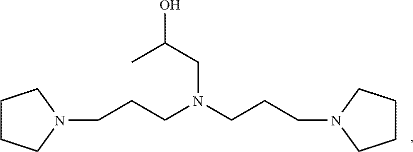

bicyclic tertiary amines, such as those selected from the formulae:

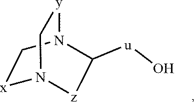

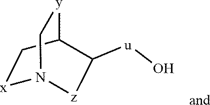

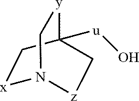

where x, y, z, and u are independently chosen from a bond, a C1-C35 hydrocarbon, a sulfonate ester (R-SO₂OR), or a phosphate ester (RO)₃P(O), where the C1-C35 hydrocarbon may contain aliphatic, cyclic, saturated, unsaturated and aromatic groups, halogen groups, ether groups, carbonates, amides, tertiary amines, or a combination of two or more thereof. Preferably the bicyclic tertiary amines are of the formula:

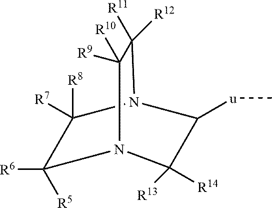

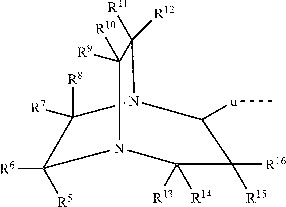

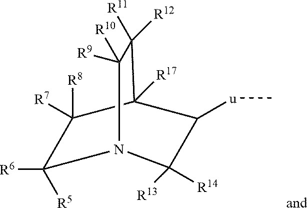

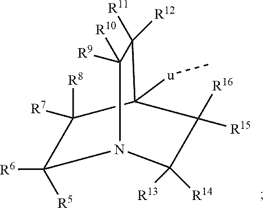

where R₅-R₁₇ are individually chosen from hydrogen, a halogen, a C1-C10 hydrocarbon, carbonate, an ether group, an amide, and a tertiary amine, and “u------” represents u-OH, wherein u is as defined above.

Specific examples of bicyclic tertiary amines include:

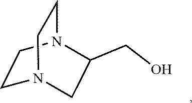

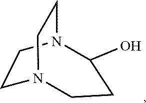

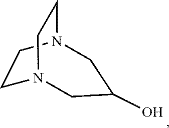

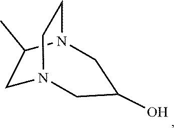

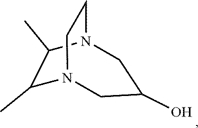

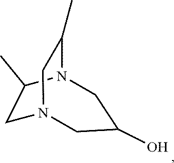

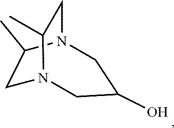

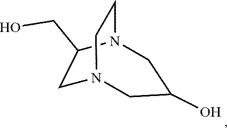

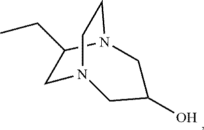

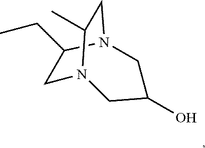

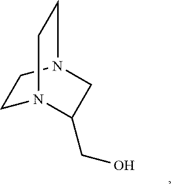

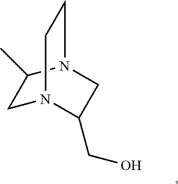

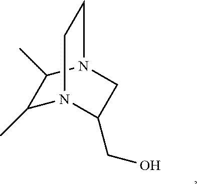

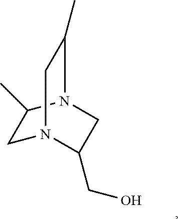

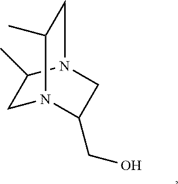

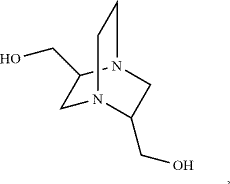

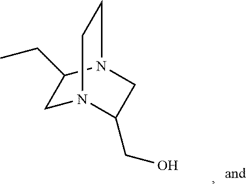

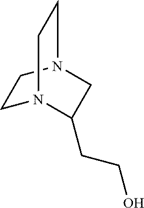 [SMILES: OCCC1CN2CCN1CC2]

, preferably

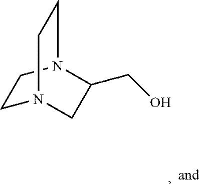

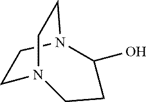

or mixtures thereof. Preferred reaction products of these preferred isocyanate-reactive compounds and mixtures thereof include, in particular, all reaction products with isophorone diisocyanate.

The composition of the invention may comprise any reaction product of any isocyanate and any isocyanate-reactive compound as defined above, and each of the possible combinations shall be included.

Particularly preferred reaction products of any isocyanate and any isocyanate-reactive compound as mentioned above are the reaction products of these isocyanate-reactive compounds with isophorone diisocyanate (IPDI) and hexamethylene-1,6-diisocyanate (HDI), most preferred with isophorone diisocyanate (IPDI). Such compounds include in particular and most preferred the compounds where the two isocyanate groups of the diisocyanates are reacted but may also include the compounds where only one isocyanate group has reacted and all molar ratios in between the two molar ratios as schematically shown for IPDI in the following formula:

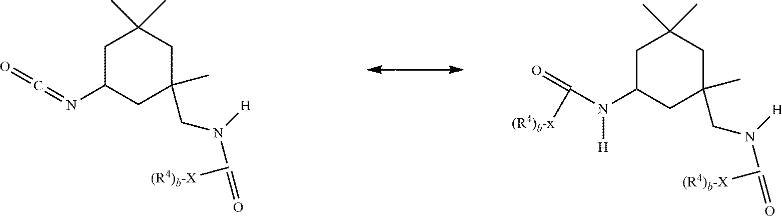

where X is O or N, and
in case X is N, b is 2 and R⁴ is hydrogen and a hydrocarbyl group having at least one tertiary amino group, or any hydrocarbyl group and a hydrocarbyl group having at least one tertiary amino group, and
in case X is O, b is 1 and R⁴ is a hydrocarbyl group having at least one tertiary amino group, where the hydrocarbyl group can be substituted and can comprise one or more heteroatoms. Preferred compositions according to the invention, include: C1 the reaction product of 1-[bis[3-(dimethylamino)propyl]amino]-2-propanol

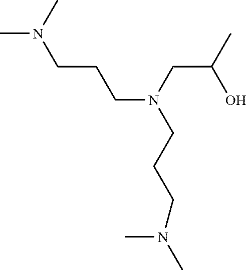 [SMILES: CC(O)CN(CCCN(C)C)CCCN(C)C]

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C2 the reaction product of 2-[2-(dimethylamino)ethoxy]ethanol

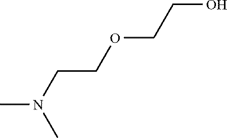

and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI), and more preferably 1,3-bis(1-isocyanato-1-methylethyl)benzene,
C3 the reaction product of 2-[2-(dimethylamino)ethyl-methyl-amino]ethanol

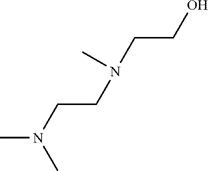

and isophorone diisocyanate, (IPDI), hexamethylene diisocyanate (HDI), and derivatives derived from IPDI and/or HDI such as biurets, isocyanurates, allophanates, and oligomers thereof, preferably isophorone diisocyanate (IPDI),
C4 the reaction product of 3,3′-iminobis(N,N-dimethylpropylamine) (or (N-[3-(dimethylamino)propyl]-N′,N′-dimethyl-propane-1,3-diamine):

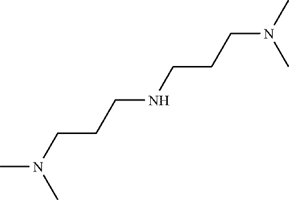

and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI), and more preferably 1,3-bis(1-isocyanato-1-methylethyl)benzene,
C5 the reaction product of dimethylaminoethanol (or 2-(dimethylamino)-ethan-1-ol):

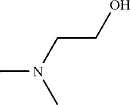

and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI), and more preferably 1,3-bis(1-isocyanato-1-methylethyl)benzene,
C6 The reaction product of diethylaminoethanol (or 2-(diethylamino)ethanol)

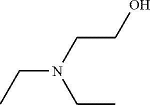

and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI), and more preferably 1,3-bis(1-isocyanato-1-methylethyl)benzene,
C7 the reaction product of 3-(dimethylamino)-1-propylamine

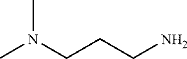

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C8 the reaction product of 3-(diethylamino)-1-propylamine

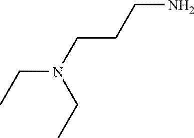

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C9 the reaction product of 3-(diethylamino)-1-propanol

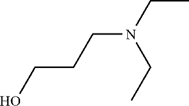

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C10 the reaction product of 1-(3-hydroxypropyl)pyrrolidine

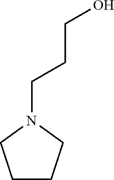

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C11 the reaction product of 1-(2-hydroxyethyl)pyrrolidine

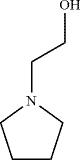

and isophorone diisocyanate(IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C12 the reaction product of 1-(2-hydroxyethyl)piperidine

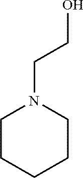

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C13 the reaction product of 1-(3-hydroxypropyl)piperidine

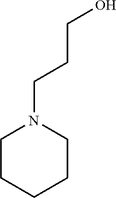

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C14 the reaction product of 1-(2-hydroxypropyl)piperidine

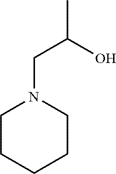

and hexamethylene-1,6-diisocyanate(IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C15 the reaction product of 1-(3-aminopropyl)pyrrolidine

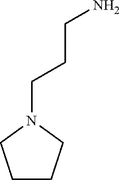

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C16 the reaction product of 1-(2-aminoethyl)pyrrolidine

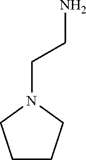

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C17 the reaction product of 1-(3-aminopropyl)piperidine

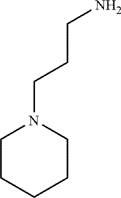

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C18 the reaction product of 1-(2-aminoethyl)piperidine

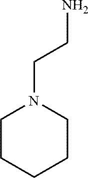

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C19 the reaction product of 1-(piperidin-1-yl)propan-2-ol

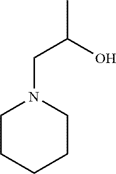

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C20 the reaction product of 1-(pyrrolidine-1-yl)propan-2-ol

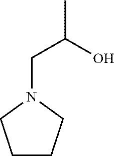

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C21 the reaction product of 1-(1-pyrrolidinyl)-2-propanamine

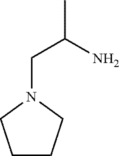

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C22 the reaction product 1-(piperidin-1-yl)propan-2-amine

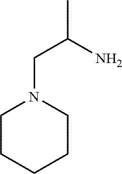

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C23 the reaction product of 2-[2-[2-(dimethylamino)ethoxy]ethyl-methylamino]ethanol

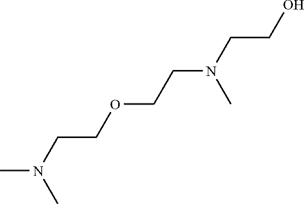

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C24 the reaction product of 3-{[3-(dimethylamino)propyl]-methylamino}propanol

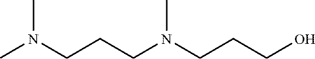

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI), and
C25 the reaction product of 2-{[3-(dimethylamino)propyl]-methyl-amino}ethanol

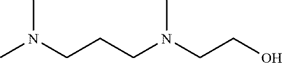

and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI). Particularly preferred reactions products include:
D1 the reaction product of 2-[2-(dimethylamino)ethoxy]ethanol

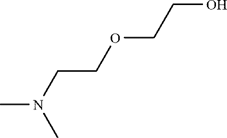

and isophorone diisocyanate,
D2 the reaction product of 2-[2-(dimethylamino)ethoxy]ethanol

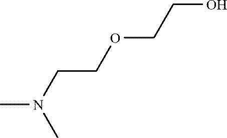

and hexamethylene-1,6-diisocyanate,
D3 the reaction product of 1-[bis[3-(dimethylamino)propyl]amino]-2-propanol

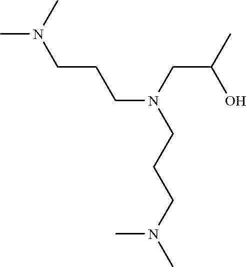 [SMILES: CC(O)CN(CCCN(C)C)CCCN(C)C]

and isophorone diisocyanate,
D4 the reaction product of 2-[2-(dimethylamino)ethoxy]ethanol and

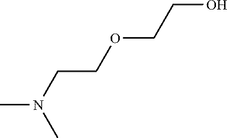

1,3-bis(1-isocyanato-1-methylethyl)benzene,
D5 the reaction product of dimethylaminoethanol

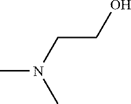

and isophorone diisocyanate,
D6 the reaction product of 2-{[2-(dimethylamino)ethyl]-methylamino}ethanol

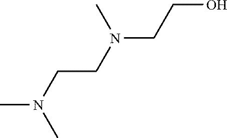

and isophorone diisocyanate,
D7 the reaction product of 3,3′-iminobis(N,N-dimethylpropylamine)

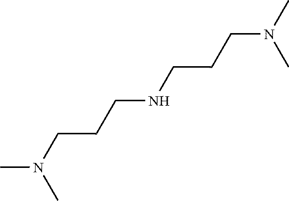

and 1,3-bis(1-isocyanato-1-methylethyl)benzene,
D8 the reaction product of 3,3′-iminobis(N,N-dimethylpropylamine)

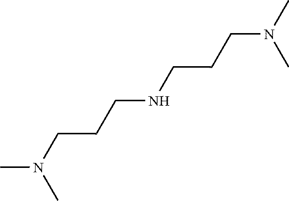

and isophorone diisocyanate,
D9 the reaction product of dimethylaminoethanol

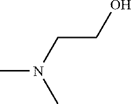

and 1,3-bis(1-isocyanato-1-methylethyl)benzene, and
D10 The reaction product of dimethylaminoethanol

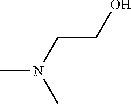

and hexamethylene diisocyanate.
D11 the reaction product of 3-(dimethylamino)-1-propylamine

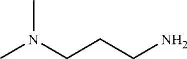

and isophorone diisocyanate,
D12 the reaction product of 3-(dimethylamino)-1-propylamine

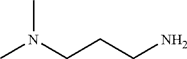

and hexamethylene-1,6-diisocyanate,
D13 the reaction product of 3-(diethylamino)-1-propylamine

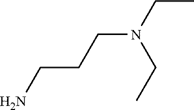

and isophorone diisocyanate,
D14 the reaction product of 3-(diethylamino)-1-propylamine

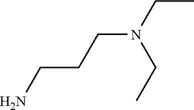

and hexamethylene-1,6-diisocyanate,
D15 the reaction product of 3-(diethylamino)-1-propanol

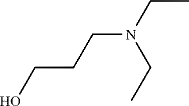

and isophorone diisocyanate,
D16 the reaction product of 3-(diethylamino)-1-propanol

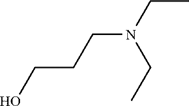

and hexamethylene-1,6-diisocyanate,
D17 the reaction product of 1-(3-hydroxypropyl)pyrrolidine

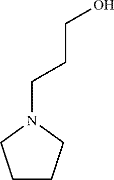

and isophorone diisocyanate,
D18 the reaction product of 1-(3-hydroxypropyl)pyrrolidine

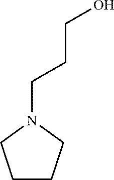

and hexamethylene-1,6-diisocyanate,
D19 the reaction product of 1-(2-hydroxyethyl)pyrrolidine

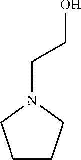

and isophorone diisocyanate,
D20 the reaction product of 1-(2-hydroxyethyl)pyrrolidine

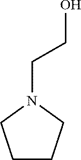

and hexamethylene-1,6-diisocyanate,
D21 the reaction product of 1-(2-hydroxyethyl)piperidine

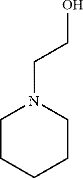

and isophorone diisocyanate,
D22 the reaction product of 1-(2-hydroxyethyl)piperidine

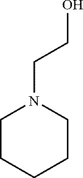

and hexamethylene-1,6-diisocyanate,
D23 the reaction product of 1-(3-hydroxypropyl)piperidine

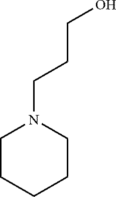

and isophorone diisocyanate,
D24 the reaction product of 1-(3-hydroxypropyl)piperidine

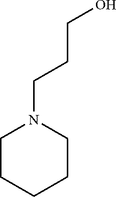

and hexamethylene-1,6-diisocyanate,
D25 the reaction product of 1-(3-aminopropyl)pyrrolidine

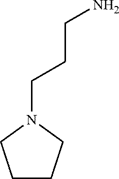

and isophorone diisocyanate,
D26 the reaction product of 1-(3-aminopropyl)pyrrolidine

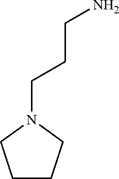

and hexamethylene-1,6-diisocyanate,
D27 the reaction product of 1-(2-aminoethyl)pyrrolidine

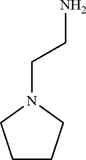

and isophorone diisocyanate,
D28 the reaction product of 1-(2-aminoethyl)pyrrolidine

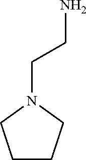

and hexamethylene-1,6-diisocyanate,
D29 the reaction product of 1-(3-aminopropyl)piperidine

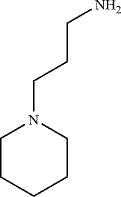

and isophorone diisocyanate,
D30 the reaction product of 1-(3-aminopropyl)piperidine

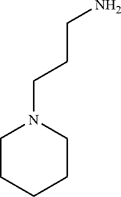

and hexamethylene-1,6-diisocyanate,
D31 the reaction product of 1-(2-aminoethyl)piperidine

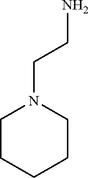

and isophorone diisocyanate,
D32 the reaction product of 1-(2-aminoethyl)piperidine

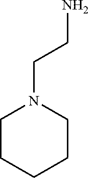

and hexamethylene-1,6-diisocyanate,
D33 the reaction product of 1-(piperidin-1-yl)propan-2-ol

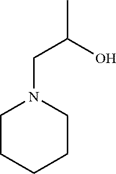

and isophorone diisocyanate,
D34 the reaction product of 1-(piperidin-1-yl)propan-2-ol

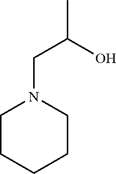

and hexamethylene-1,6-diisocyanate,
D35 the reaction product of 1-(pyrrolidine-1-yl)propan-2-ol

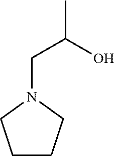

and isophorone diisocyanate,
D36 the reaction product of 1-(pyrolidine-1-yl)propan-2-ol

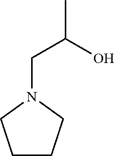

and hexamethylene-1,6-diisocyanate,
D37 the reaction product of 1-(1-pyrrolidinyl)-2-propanamine

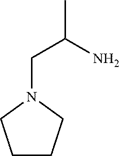

and isophorone diisocyanate,
D38 the reaction product of 1-(1-pyrrolidinyl)-2-propanamine

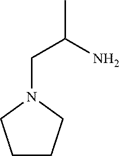

and hexamethylene-1,6-diisocyanate,
D39 the reaction product of 1-(piperidin-1-yl)propan-2-amine

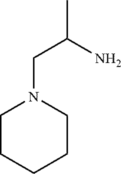

and isophorone diisocyanate,
D40 the reaction product of 1-(piperidin-1-yl)propan-2-amine

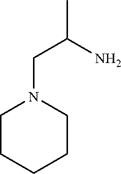

and hexamethylene-1,6-diisocyanate,
D41 the reaction product of 2-[2-[2-(dimethylamino)ethoxy]ethyl-methylamino]ethanol

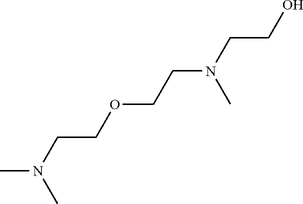

and isophorone diisocyanate,
D42 the reaction product of 2-[2-[2-(dimethylamino)ethoxy]ethyl-methylamino]ethanol

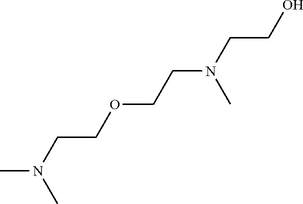

and hexamethylene-1,6-diisocyanate,
D43 the reaction product of 3-{[3-(dimethylamino)propyl]-methylamino}propanol

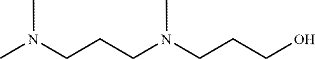

and isophorone diisocyanate,
D44 the reaction product of 3-{[3-(dimethylamino)propyl]-methyl-amino}propanol

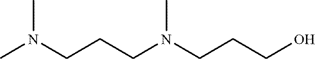

and hexamethylene-1,6-diisocyanate,
D45 the reaction product of 2-{[3-(dimethylamino)propyl]-methyl-amino}ethanol

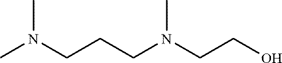

and isophorone diisocyanate, and
D46 the reaction product of 2-{[3-(dimethylamino)propyl]-methyl-amino}ethanol

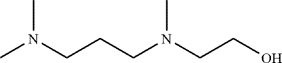

and hexamethylene-1,6-diisocyanate.

Preferred compounds, which are obtainable by reacting at least one isocyanate compound and at least one isocyanate-reactive compound having at least one tertiary amino group are selected from:

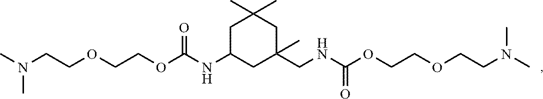

or the HDMI analogue thereof:

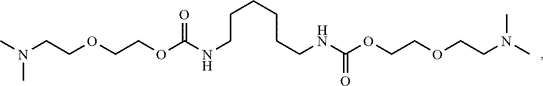

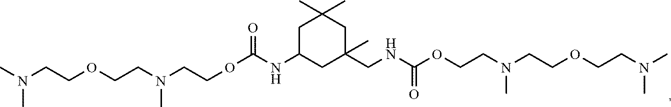

or the HDMI analogue thereof:

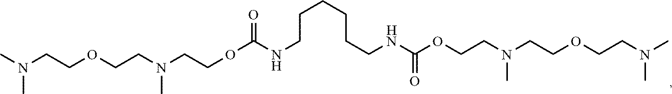

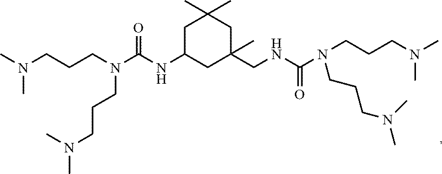

or the HDMI analogue thereof:

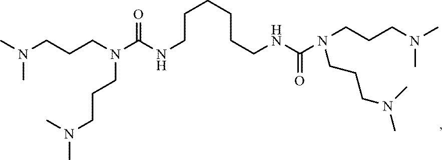

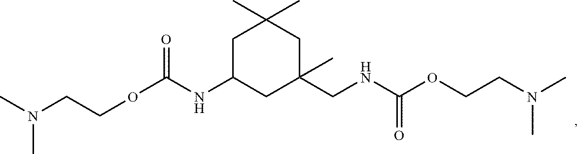

or the HDMI analogue thereof:

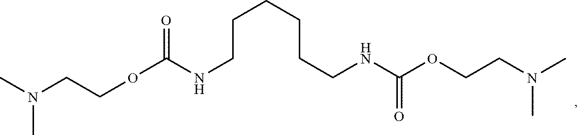

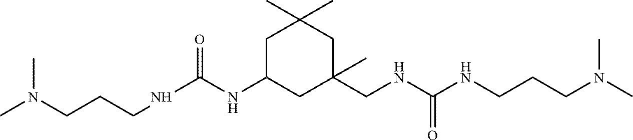

or the HDMI analogue thereof:

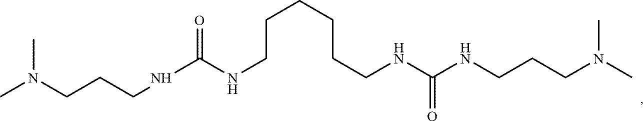

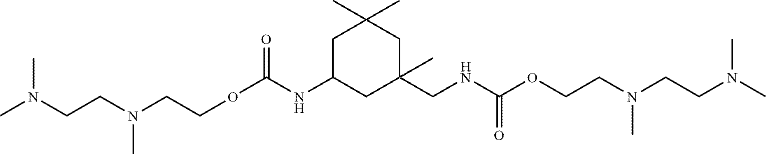

or the HDMI analogue thereof:

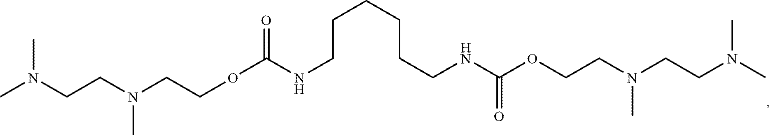

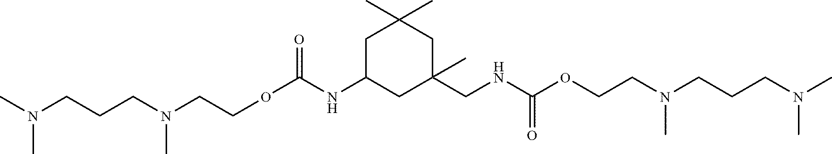

or the HDMI analogue thereof:

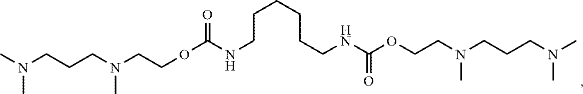

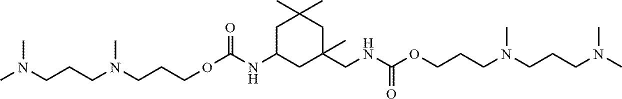

or the HDMI analogue thereof:

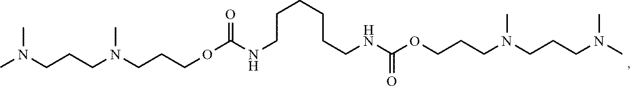

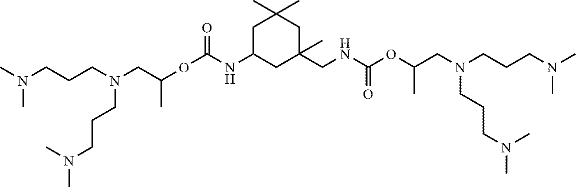

or the HDMI analogue thereof:

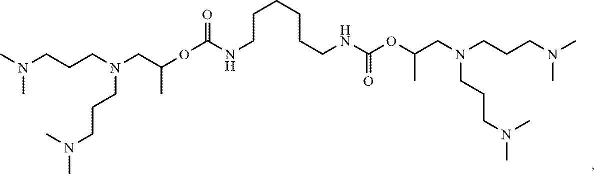

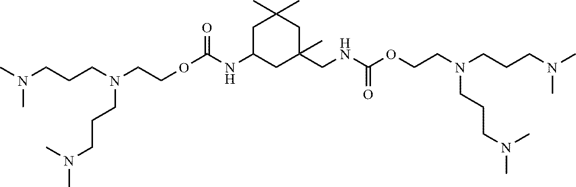

or the HDMI analogue thereof:

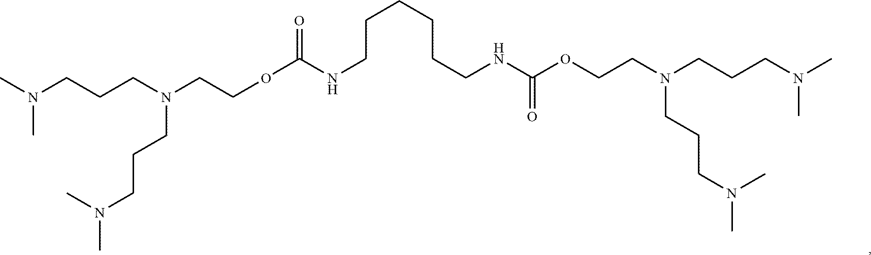

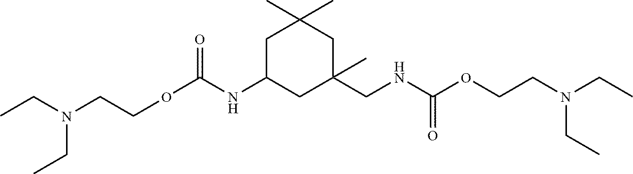 [SMILES: CCN(CC)CCOC(=O)NCC1(C)CC(NC(=O)OCCN(CC)CC)CC(C)(C)C1]

or the HDMI analogue thereof:

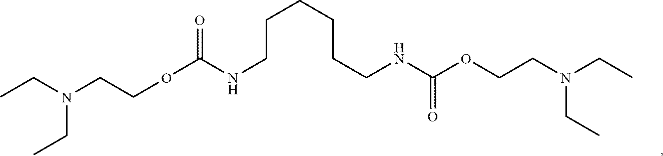

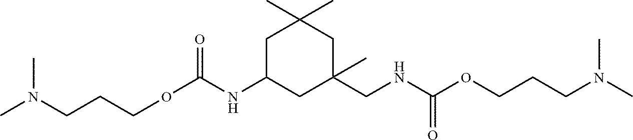

or the HDMI analogue thereof:

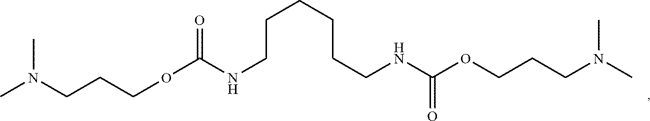

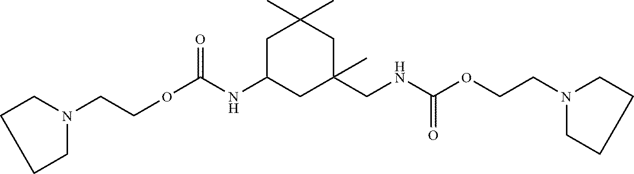 [SMILES: CC1(C)CC(NC(=O)OCCN2CCCC2)CC(C)(CNC(=O)OCCN2CCCC2)C1]

or the HDMI analogue thereof:

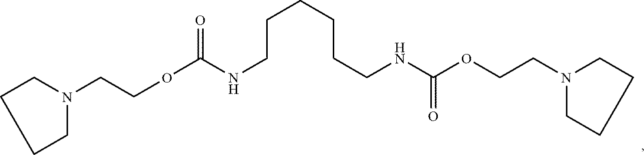

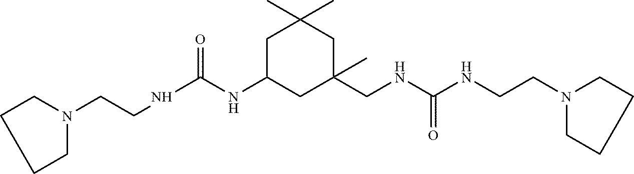 [SMILES: CC1(C)CC(NC(=O)NCCN2CCCC2)CC(C)(CNC(=O)NCCN2CCCC2)C1]

or the HDMI analogue thereof:

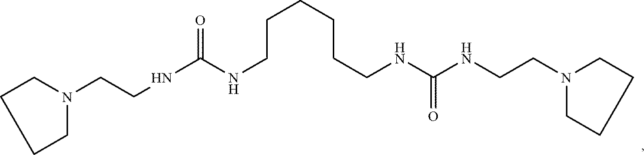

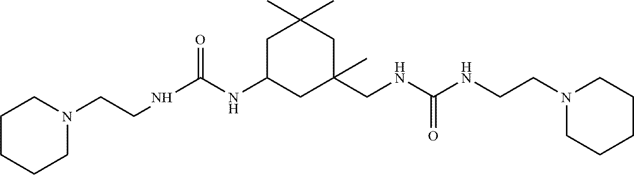 [SMILES: CC1(C)CC(NC(=O)NCCN2CCCCC2)CC(C)(CNC(=O)NCCN2CCCCC2)C1]

or the HDMI analogue thereof:

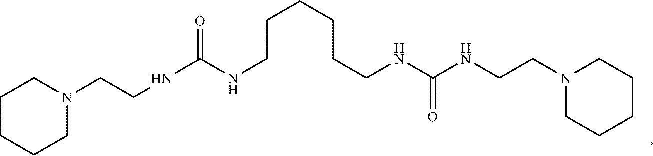

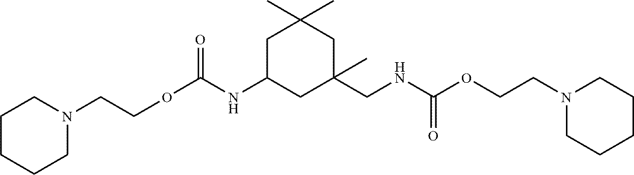 [SMILES: CC1(C)CC(NC(=O)OCCN2CCCCC2)CC(C)(CNC(=O)OCCN2CCCCC2)C1]

or the HDMI analogue thereof:

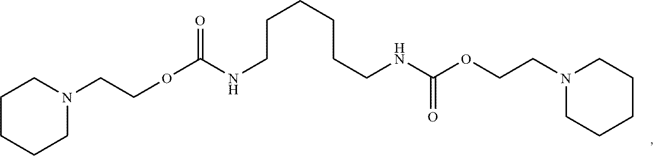

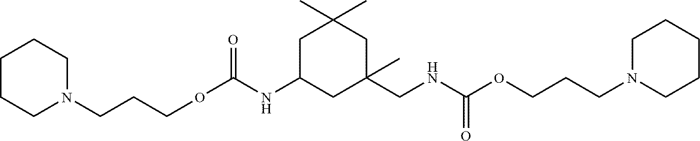 [SMILES: CC1(C)CC(NC(=O)OCCCN2CCCCC2)CC(C)(CNC(=O)OCCCN2CCCCC2)C1]

or the HDMI analogue thereof:

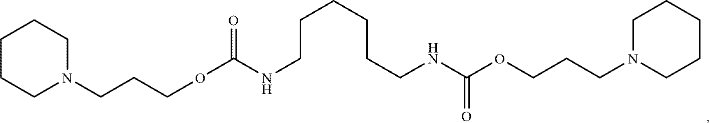

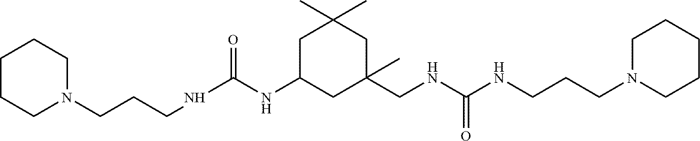 [SMILES: CC1(C)CC(NC(=O)NCCCN2CCCCC2)CC(C)(CNC(=O)NCCCN2CCCCC2)C1]

or the HDMI analogue thereof:

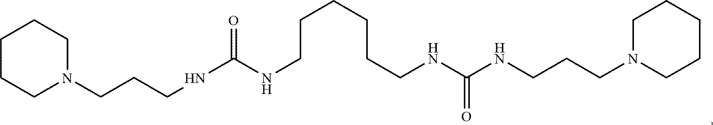

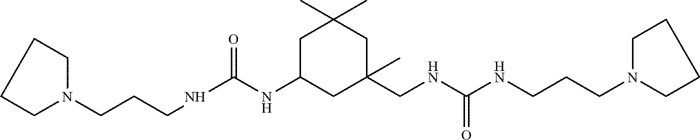 [SMILES: CC1(C)CC(NC(=O)NCCCN2CCCC2)CC(C)(CNC(=O)NCCCN2CCCC2)C1]

or the HDMI analogue thereof:

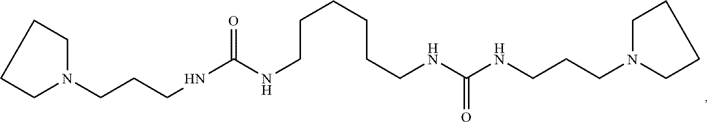

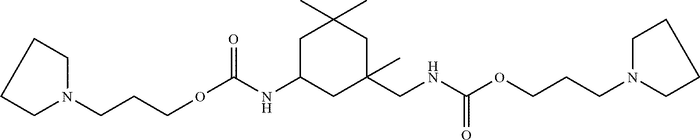 [SMILES: CC1(C)CC(NC(=O)OCCCN2CCCC2)CC(C)(CNC(=O)OCCCN2CCCC2)C1]

or the HDMI analogue thereof:

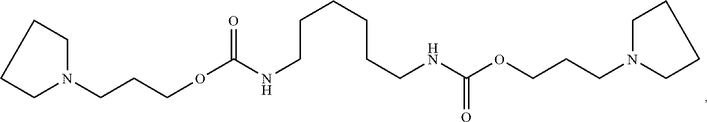

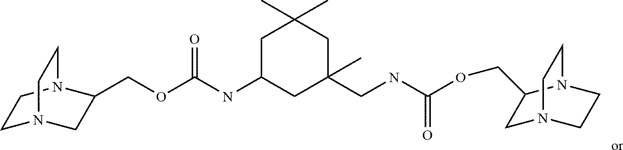

the HDMI analogue thereof:

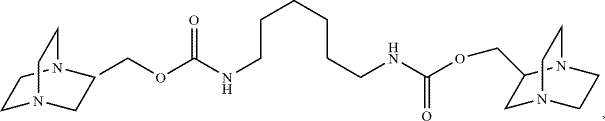

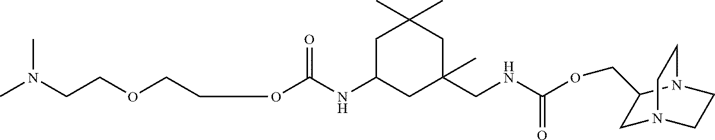 [SMILES: CN(C)CCOCCCOC(=O)NC1CC(C)(C)CC(C)(CNC(=O)OCC2CN3CCN2CC3)C1]

or the HDMI analogue thereof:

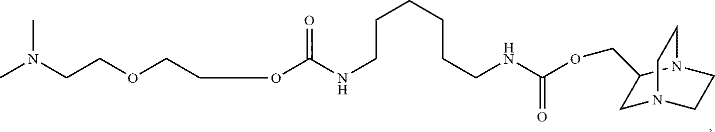

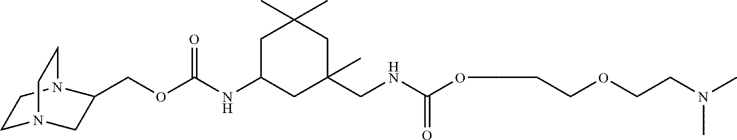 [SMILES: CN(C)CCOCCCOC(=O)NCC1(C)CC(NC(=O)OCC2CN3CCN2CC3)CC(C)(C)C1]

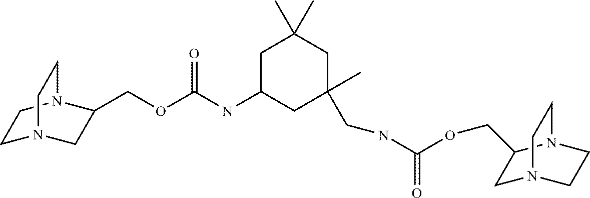 [SMILES: CC1(C)CC(NC(=O)OCC2CN3CCN2CC3)CC(C)(CNC(=O)OCC2CN3CCN2CC3)C1]

or the HDMI analogue thereof:

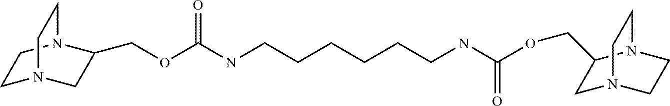 [SMILES: O=C(NCCCCCCNC(=O)OCC1CN2CCN1CC2)OCC1CN2CCN1CC2]

In a further embodiment of the invention it has been found that some specific compounds which are obtainable by reacting at least one isocyanate compound and at least one isocyanate-reactive compound having at least one tertiary amino group, are novel and also active as catalysts, in particular in polyurethane formation, even in the absence of a Cu(II)-salt. Accordingly, the present invention also relates to such compounds, which are selected from:
(1) the reaction product of

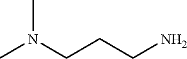

N′,N′-dimethylpropane-1,3-diamine and isophorone diisocyanate,
(2) the reaction product of

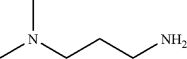

N′,N′-dimethylpropane-1,3-diamine and hexamethylene-1,6-diisocyanate,
(3) the reaction product of

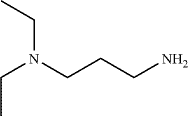

N′,N′-diethylpropane-1,3-diamine and isophorone diisocyanate,
(4) the reaction product of

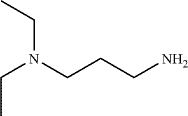

N′,N′-diethylpropane-1,3-diamine and hexamethylene-1,6-diisocyanate,
(5) the reaction product of

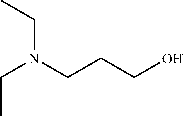

3-(diethylamino)propan-1-ol and isophorone diisocyanate,
(6) the reaction product of

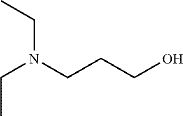

3-(diethylamino)propan-1-ol and hexamethylene-1,6-diisocyanate,
(7) the reaction product of

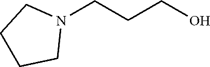

3-pyrrolidin-1-ylpropan-1-ol and isophorone diisocyanate,
(8) the reaction product of

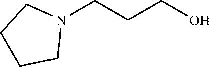

3-pyrrolidin-1-ylpropan-1-ol and hexamethylene-1,6-diisocyanate,
(9) the reaction product of

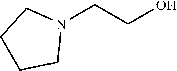

2-pyrrolidin-1-ylethanol and isophorone diisocyanate,
(10) the reaction product of

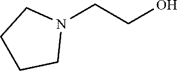

2-pyrrolidin-1-ylethanol and hexamethylene-1,6-diisocyanate,
(11) the reaction product of

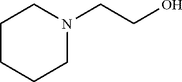

2-(1-piperidyl)ethanol and isophorone diisocyanate,
(12) the reaction product of

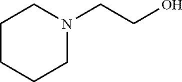

2-(1-piperidyl)ethanol and hexamethylene-1,6-diisocyanate,
(13) the reaction product of

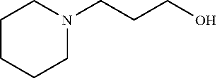

3-(1-piperidyl)propan-1-ol and isophorone diisocyanate,
(14) the reaction product of

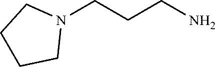

3-pyrrolidin-1-ylpropan-1-amine and isophorone diisocyanate,
(15) the reaction product of

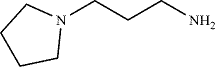

3-pyrrolidin-1-ylpropan-1-amine and hexamethylene-1,6-diisocyanate,
(16) the reaction product of

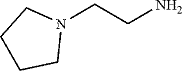

2-pyrrolidin-1-ylethanamine and isophorone diisocyanate,
(17) the reaction product of

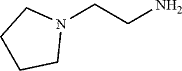

2-pyrrolidin-1-ylethanamine and hexamethylene-1,6-diisocyanate,
(18) the reaction product of

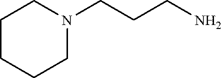

3-(1-piperidyl)propan-1-amine and isophorone diisocyanate,
(19) the reaction product of

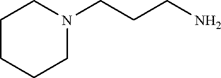

3-(1-piperidyl)propan-1-amine and hexamethylene-1,6-diisocyanate,
(20) the reaction product of

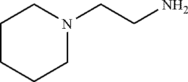

2-(1-piperidyl)ethanamine and isophorone diisocyanate,
(21) the reaction product of

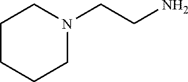

2-(1-piperidyl)ethanamine and hexamethylene-1,6-diisocyanate,
(22) the reaction product of

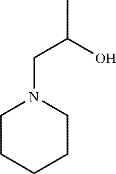

1-(1-piperidyl)propan-2-ol and isophorone diisocyanate,
(23) the reaction product of

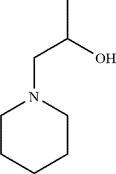

1-(1-piperidyl)propan-2-ol and hexamethylene-1,6-diisocyanate,
(24) the reaction product of

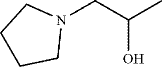

1-pyrrolidin-1-ylpropan-2-ol and isophorone diisocyanate,
(25) the reaction product of

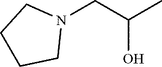

1-pyrrolidin-1-ylpropan-2-ol and hexamethylene-1,6-diisocyanate,
(26) the reaction product of

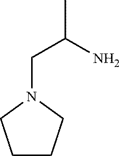

1-pyrrolidin-1-ylpropan-2-amine and isophorone diisocyanate,
(27) the reaction product of

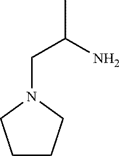

1-pyrrolidin-1-ylpropan-2-amine and hexamethylene-1,6-diisocyanate,
(28) the reaction product of

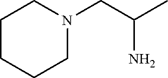

1-(1-piperidyl)propan-2-amine and isophorone diisocyanate,
(29) the reaction product of

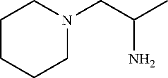

1-(1-piperidyl)propan-2-amine and hexamethylene-1,6-diisocyanate,
(30) the reaction product of

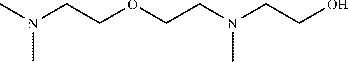

2-[2-[2-(dimethylamino)ethoxy]ethyl-methyl-amino]ethanol and isophorone diisocyanate,
(31) the reaction product of

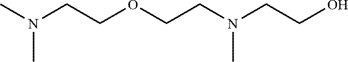

2-[2-[2-(dimethylamino)ethoxy]ethyl-methyl-amino]ethanol and hexamethylene-1,6-diisocyanate,
(32) the reaction product of

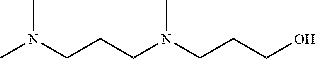

3-[3-(dimethylamino)propyl-methyl-amino]propan-1-ol and isophorone diisocyanate,
(33) the reaction product of

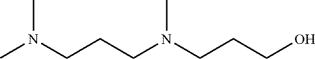

3-[3-(dimethylamino)propyl-methyl-amino]propan-1-ol and hexamethylene-1,6-diisocyanate,
(34) the reaction product of

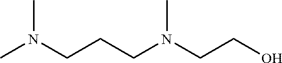

2-[3-(dimethylamino)propyl-methyl-amino]ethanol and isophorone diisocyanate,
(35) the reaction product of

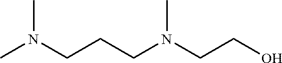

2-[3-(dimethylamino)propyl-methyl-amino]ethanol and hexamethylene-1,6-diisocyanate,
(36) the reaction product of

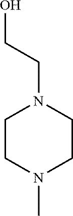

2-(4-methylpiperazin-1-yl)ethanol and isophorone diisocyanate,
(37) the reaction product of

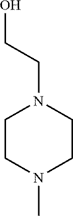

2-(4-methylpiperazin-1-yl)ethanol and hexamethylene-1,6-diisocyanate,
(38) the reaction product of

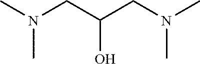

1,3-bis(dimethylamino)propan-2-ol and isophorone diisocyanate,
(39) the reaction product of

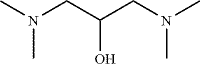

1,3-bis(dimethylamino)propan-2-ol and hexamethylene-1,6-diisocyanate,
(40) the reaction product of

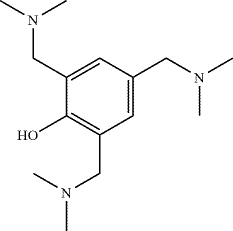

2,4,6-tris[(dimethylamino)methyl]phenol and isophorone diisocyanate,
(41) the reaction product of

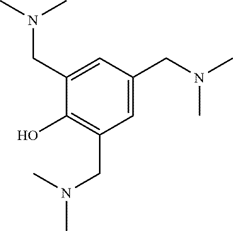

2,4,6-tris[(dimethylamino)methyl]phenol and hexamethylene-1,6-diisocyanate,
(42) the reaction product of

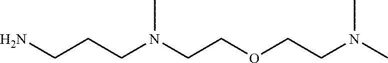

N′-[2-[2-(dimethylamino)ethoxy]ethyl]-N′-methyl-propane-1,3-diamine and isophorone diisocyanate,
(43) the reaction product of

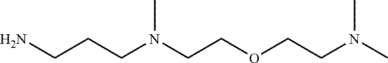

N′-[2-[2-(dimethylamino)ethoxy]ethyl]-N′-methyl-propane-1,3-diamine and hexamethylene-1,6-diisocyanate,
(44) the reaction product of

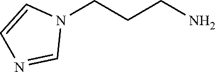

3-imidazol-1-ylpropan-1-amine and isophorone diisocyanate,
(45) the reaction product of

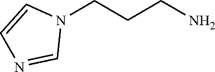

3-imidazol-1-ylpropan-1-amine and hexamethylene-1,6-diisocyanate,
(46) the reaction product of

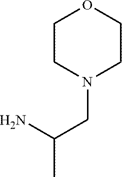

1-morpholinopropan-2-amine and isophorone diisocyanate,
(47) the reaction product of

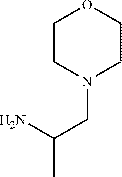

1-morpholinopropan-2-amine and hexamethylene-1,6-diisocyanate,
(48) the reaction product of

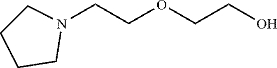 [SMILES: OCCOCCN1CCCC1]

2-(2-pyrrolidin-1-ylethoxy)ethanol and isophorone diisocyanate,
(49) the reaction product of

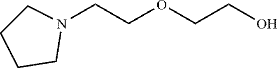 [SMILES: OCCOCCN1CCCC1]

2-(2-pyrrolidin-1-ylethoxy)ethanol and hexamethylene-1,6-diisocyanate,
(50) the reaction product of

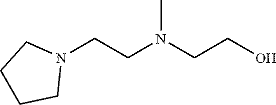

2-[methyl(2-pyrrolidin-1-ylethyl)amino]ethanol and isophorone diisocyanate,
(51) the reaction product

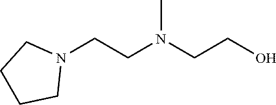

2-[methyl(2-pyrrolidin-1-ylethyl)amino]ethanol and hexamethylene-1,6-diisocyanate,
(52) the reaction product of

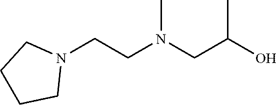

1-[methyl(2-pyrrolidin-1-ylethyl)amino]propan-2-ol and isophorone diisocyanate,
(53) the reaction product of

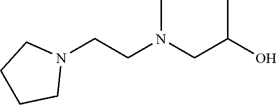

1-[methyl(2-pyrrolidin-1-ylethyl)amino]propan-2-ol and hexamethylene-1,6-diisocyanate,
(54) the reaction product of

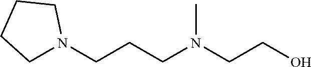

2-[methyl(3-pyrrolidin-1-ylpropyl)amino]ethanol and isophorone diisocyanate,
(55) the reaction product of

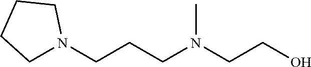

2-[methyl(3-pyrrolidin-1 -ylpropyl)amino]ethanol and hexamethylene-1,6-diisocyanate,
(56) the reaction product of

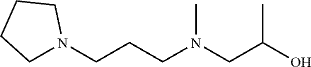

1-[methyl(3-pyrrolidin-1-ylpropyl)amino]propan-2-ol amine and isophorone diisocyanate,
(57) the reaction product of

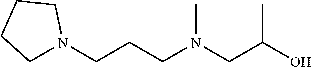

1-[methyl(3-pyrrolidin-1-ylpropyl)amino]propan-2-ol and hexamethylene-1,6-diisocyanate,
(58) the reaction product of

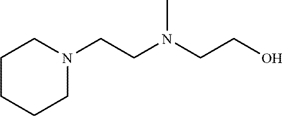

2-[methyl-[2-(1-piperidyl)ethyl]amino]ethanol and isophorone diisocyanate,
(59) the reaction product of

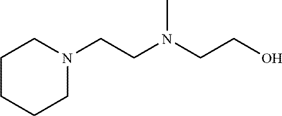

2-[methyl-[2-(1-piperidyl)ethyl]amino]ethanol and hexamethylene-1,6-diisocyanate,
(60) the reaction product of

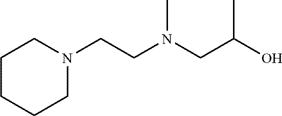

1-[methyl-[2-(1-piperidyl)ethyl]amino]propan-2-ol and isophorone diisocyanate,
(61) the reaction product

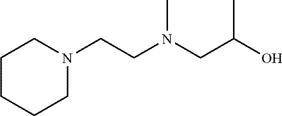

1-[methyl-[2-(1-piperidyl)ethyl]amino]propan-2-ol and hexamethylene-1,6-diisocyanate,
(62) the reaction product of

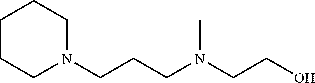

2-[methyl-[3-(1-piperidyl)propyl]amino]ethanol and isophorone diisocyanate,
(63) the reaction product of

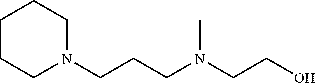

2-[methyl-[3-(1-piperidyl)propyl]amino]ethanol and hexamethylene-1,6-diisocyanate,
(64) the reaction product of

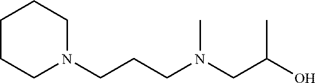

1-[methyl-[3-(1-piperidyl)propyl]amino]propan-2-ol and isophorone diisocyanate, and
(65) the reaction product of

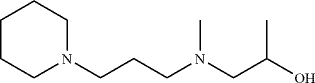

1-[methyl-[3-(1-piperidyl)propyl]amino]propan-2-ol and hexamethylene-1 ,6-diisocyanate.

As stated above such compounds include in particular and most preferred the compounds where the two isocyanate groups of the diisocyanates are reacted but may also include the compounds where only one isocyanate group has reacted and all molar ratios in between the two molar ratios.

In a further embodiment of the invention it relates to compositions comprising one or more of said specific compounds mentioned before together with at least one carboxylic acid, preferably selected from the group consisting of monocarboxylic acid compounds, polycarboxylic acid compounds, such as dicarboxylic acid compounds, and hydroxyl-functional carboxylic acid compounds, as described in more detail below, and the use thereof as a catalyst composition. Said specific compositions may not comprise a Cu(II)-salt but are also active as catalysts, in particular, in polyurethane formation.

In a further embodiment of the invention the compound obtainable by reacting at least one isocyanate compound and at least one isocyanate-reactive compound having at least one tertiary amino group is reacted further with at least one isocyanate compound with the formation of a biurets, allophanates, and isocyanurates of said compound as exemplified in the following schemes. Addition of an isocyanate-group to urethane forming an allophanate:

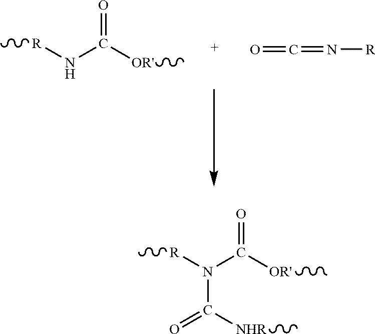

Addition of an isocyanate-group to urea forming a biuret:

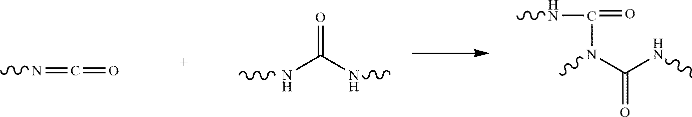

The composition according to the invention comprises at least one copper(II)-salt (Cu(II)-salt), such as Cu(II)-carboxylates, Cu(II)-diketonates, Cu(II)-halides, or a combination of two or more thereof. According to the present invention the terms copper salt, copper(II)salt or Cu(II) salt also include any forms of solvates, in particular, hydrates of such copper(II)-salts. The copper salts may be in particular in the form of hydrates. Carboxylates are, in particular, derived from optionally substituted carboxylic acids such as optionally substituted aliphatic, saturated monocarboxylic acids; optionally substituted aliphatic, unsaturated monocarboxylic acids; optionally substituted aliphatic, saturated poly(such as di-)carboxylic acids, optionally substituted heterocyclic carboxylic acids, optionally substituted aromatic carboxylic acids. Preferably these carboxylic acids include optionally substituted aliphatic saturated carboxylic acids with up to 30 carbon atoms. Optionally substituents include in particular hydroxy, amino (including —NH₂, —NHR and —NR₂ (wherein R is a hydrocarbyl group), halogen, alkoxy (leading to ether function), heterocyclic groups. Among the substituted carboxylic acids, hydroxyfunctional carboxylic acids, such as salicylic acid, lactic acid etc. are most preferred. Preferred Cu(II)-carboxylates, include copper(II)-salts of carbonic acid, methanoic acid, ethanoic acid, propanoic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, icosanoic acid, saturated and unsaturated fatty acids, dicarboxylic acids such as fumaric acid, maleic acid, hydroxyl-substituted carboxylic acids such as lactic acid (2-hydroxypropanoic acid), tartaric acid, aromatic carboxylic acids such as benzoic acid, salicylic acid, heterocyclic carboxylic acids such as nicotinic acid, pyrrolidine-2-carboxylic acid, amino acids such as glycine, alanine, and aminobutyric acid. The most preferred Cu(II)-salts are Cu(II)-carboxylates, in particular, Cu(II)-acetate, Cu(II)-ethylhexanoate, Cu(II)-ricinoleate, Cu(II)-stearate, Cu(II)-palmitate, Cu(II)-laurate, Cu(II)-palmitoleate, Cu(II)-oleate, Cu(II)-linoleate, Cu(II)-linolenate. In particular, Cu(II)-acetate and Cu(II)-ethylhexanoate are preferred.

Cu(II)-diketonates include, in particular, diketonates of the formula:

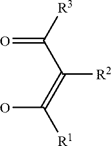

wherein R¹, R², and R³ are preferably optionally substituted alkyl.

The preferred Cu(II)-diketonates is Cu(II)-acetylacetonate. Cu(II)-halides include, in particular, Cu(II)-chloride.

The term copper(II)-salt shall include all copper compounds where copper has the oxidation state +2, independent of the nature of the bond, which may be ionic, coordinate covalent or covalent and any intermediate stage between those.

The composition according to the invention preferably comprises: 10.000 to 99.991 wt-%, preferable 15 to 95 wt-%, more preferable 20 to 90 wt-% of the compound(s) obtainable by reacting at least one isocyanate compound and at least one isocyanate-reactive compound having at least one tertiary amino group,

0.009 to 5 wt-%, preferable 0.05 to 3 wt-%, more preferably 0.5 to 2 wt-% of copper, and 0 to 89.991 wt-% of the diluent(s),

wherein the wt-% are based on the total weight of the composition.

Without being bound to theory it is assumed that the compound which is obtainable by reacting at least one isocyanate compound and at least one isocyanate-reactive compound having at least one tertiary amino group, and in particular the tertiary amino group acts as ligand in the coordination of Cu(II) in the composition of the invention.

The composition according to the invention, optionally comprises one or more diluents. Such diluents may serve to reduce the viscosity of the composition or increase the solubility or incorporation capability of the copper(II)-salts into the composition.

Diluents include isocyanate-reactive compounds or non-isocyanate-reactive compounds, that is, diluents that do not react with isocyanates. In case of using isocyanate-reactive compounds in particular a molar excess of such isocyanate-reactive compounds is used, which serves then as a diluent of the composition according to the invention. With respect to such isocyanate-reactive compounds it can be referred to the preferred embodiments described before. It is of course also possible to add any diluent including isocyanate-reactive compounds after the reaction of at least one isocyanate compound and at least one isocyanate-reactive compound having at least one tertiary amino group. Such isocyanate-reactive compounds may include various types of amines or alcohols, and may also include known amine catalysts for polyurethane formation as explained below.

Non-reactive diluents/solvents may include in particular dialkyl sulfoxides such as dimethyl sulfoxide, diethyl sulfoxide, diisobutyl sulfoxide, and the like; N,N-dialkylalkanolamides such as N,N-dimethylformamide, N,N-dimethylacetamide, N,N-diethylacetamide, etc.; phosphonates such as O,O-dimethyl, O,O-diethyl, O,O-diisopropyl methylphosphonates, O,O-di(2-chloroethyl) vinylphosphonate, etc.; aromatic solvents such as toluene, xylene, benzene, etc.; ether solvents such as diethyl ether, dioxane, diglyme, etc.; tetramethylenesulfone, 1-methyl-2-pyrrolidone, trialkyl phosphates such as trimethyl and triethyl phosphates, acetonitrile, and the like, and organic carbonates like di-methyl-carbonate, ethylene-carbonate, propylene-carbonate, or combinations thereof. The diluent/solvent may be used with a co-solvent such as a fatty acid, a vegetable oil, or a combination thereof.

In a preferred embodiment of the composition according to the invention, the one or more isocyanate-reactive compounds having at least one tertiary amino group is used as a diluent, which means that it is used in a molar excess to the isocyanate compound based on the molar ratio of the isocyanate-reactive groups and the isocyanate groups.

Preferred solvents also include glycols such as ethane-1,2-diol, propane-1,2-diol, propane-1,3-diol, butane-1,4-diol, propane-1,2,3-triol, diethylene glycol, dipropylene glycol, triethylene glycol, tetraethylene glycol, tripropylene glycol, 2-methyl-1,3-propanediol, 2-methyl-2,4-pentandiol. Those diluents/solvents can be used as mixtures or cosolvents together with amines.

In a further preferred embodiment of the composition according to the invention, it can optionally comprise one or more additional amines or amine catalysts for the formation of polyisocyanate polyaddition products, such as amines different from the isocyanate-reactive compounds. For example such catalysts include alkyl amines such as bis(2-dimethylaminoethyl)ether, N,N-dimethylcyclohexylamine, N,N,N′,N′,N″-pentamethyldiethylenetriamine, N,N,N′,N′,N″-pentamethyldipropylenetriamine triethylenediamine, ethanol amines, such as 2-aminoethanol, diethanolamine, triethanolamine, N-methyldiethanolamine, N,N-dimethylethanolamine, N,N-diethylethanolamine, N-methylethanolamine, N-ethylethanolamine, diisopropylamine, bis(2-hydroxypropyl)amine, 2-[2-(dimethylamino)ethoxy]ethanol, 1-[bis[3-(dimethylamino)propyl]amino]-2-propanol, 3-dimethylamino-N,N-dimethylpropionamide, N,N′-dimorpholinodiethyl ether, N,N′-dimethylpiperazine, N-methylmorpholine, N-ethylmorpholine, 2-{[2-(dimethylamino)ethyl]methylamino}ethanol, 3,3′-iminobis(N,N-dimethylpropylamine), 3-(dimethylamino)-1-propylamine, 3-(diethylamino)-1-propanol, 1-(3-hydroxypropyl)pyrrolidine, 1-(2-hydroxypropyl)pyrrolidine, 1-(2-hydroxyethyl)pyrrolidine, 1-(2-hydroxyethyl)piperidine, 1-(3-hydroxypropyl)piperidine, 1-(2-hydroxypropyl)piperidine, 1-(3-aminopropyl)pyrrolidine, 1-(2-aminoethyl)pyrrolidine, 1-(3-aminopropyl)piperidine, 1-(2-aminoethyl)piperidine, 1-(1-pyrolidineyl)-2-propanamine, 1-(piperidin-1-yl)propan 2-amine, N-methoxyethylmorpholine, N-methylimidazole, 1-(3-aminopropyl) imidazole, 2-[2-[2-(dimethylamino)ethoxy]ethyl-methylamino]ethanol, N-methyl dicyclohexylamine, 3-{[3-(dimethylamino)propyl]methylamino}propanol, tris (dimethyl aminopropyl)amine, 2-{[3-(dimethylamino)propyl]methylamino}ethanol, N,N,N′,N′-tetramethyl-hexamethylene diamine, N,N,N′,N′-tetramethylethylenediamine, 2,4,6-tris(dimethylaminomethyl)phenol, 1,3,5-tris(dimethylaminopropyl)- hexahydrotriazine, N,N-dimethylbenzylamine, 1,8 diaza bicyclo 5,4,0 undecene 7, N-methyl-N′-(2-dimethylamino) ethyl-piperazine, N,N′-bis[3-(dimethylamino)propyl]urea, N-[3-(dimethylamino)propyl]urea. N,N,N′,N′-tetrakis(2-hydroxypropyl)ethylenediamine, and N,N,N′,N′-tetrakis(2-hydroxyethyl)ethylenediamine. Preferred amines include alkyl amines, such as bis(2-dimethylaminoethyl)ether, N,N-dimethylaminopropylamine, N,N-dimethylcyclohexylamine, N,N,N′,N′,N″-pentamethyldiethylenetriamine, triethylenediamine, ethanol amines, such as diethanolamine, 2(2-dimethylaminoethoxy)ethanol, N-[2-(dimethylamino)ethyl]-N-methylethanolamine, dimethylethanolamine, or other amines such as 3-dimethylamino-N,N-dimethylpropionamide and N-ethylmorpholine, triethanolamine, 2-dimethylaminoethanol, N,N-dimethylaminopropylamine, diethanolamine, trimethylamine, triethylenediamine, bis(2-dimethylaminoethyl) ether.

In a preferred embodiment the composition according to the invention further comprises at least one carboxylic acid, such as those described in US 6,387,972 B1. Preferably the carboxylic acids are selected from the group consisting of monocarboxylic acid compounds, such as benzoic acid, polycarboxylic acid compounds, such as dicarboxylic acid compounds, such as oxalic acid, malonic acid, succinic acid, glutaric acid, adipic acid, azelaic acid, sebacic acid, and hydroxyl-functional carboxylic acid compounds, in particular, salicylic acid, citric acid.

The present invention also relates to a process for the manufacture of the composition according to the invention. In a preferred embodiment such process comprises reacting at least one isocyanate compound and at least one isocyanate-reactive compound having at least one tertiary amino group in the presence of at least one Cu(II)-salt, and optionally in the presence of one or more diluents as described before. Non-reactive diluents/solvents include e.g. aprotic organic solvents (ethyl acetate, acetone, acetonitrile, ketones, haloalkanes, diglyme, dioxane, ethers - diethylether, methyl butyl ether, tetrahydrofuran, alkanes, dimethyl sulfoxide (DMSO), dimethylformamide (DMF), toluene, benzene, xylene and their analogues or mixtures thereof) which can be used to dissolve or melt the components prior mixing them. In a preferred embodiment of this process, the Cu(II)-salt is mixed with the one or more isocyanate-reactive compounds having at least one tertiary amino group preferably under vigorous stirring, and then the isocyanate compound is added under inert gas atmosphere. The addition of the isocyanate compound is carried out slowly in a continuous manner or in portions in a discontinuous manner. In view of the exothermic reaction the temperature increases. Preferable temperature ranges for the reaction are 20-140° C., more preferable 40-120° C., the most preferable 60-100° C. Generally, it is preferred to perform the reaction under inert atmosphere (nitrogen, argon, or others) to exclude moisture. After reaction completion, the diluents/solvents can be partially or fully removed to afford final compounds, their mixtures or concentrated solutions thereof. Catalyst blends containing diluents like water, glycols (ethylene glycol, di-, tri-ethylene glycol, propylene glycol, di-, tri-propylene glycol, 2-methyl-1,3-propanediol or others), mono- and di-alkyl ethers of glycols, polyether polyols, plasticizers, waxes, and natural oils like castor oil, soybean oil and others and mixtures thereof are recommended to prepare to facilitate the dosing of the catalysts for production of polyurethanes. The resulting mixture according to the invention is normally homogenous and stable, and can be used as such as a catalyst in the manufacture of the polyisocyanate polyaddition products as described below.

In another, however, less preferred embodiment, the process for the manufacture of the composition according to the invention, comprises reacting at least one isocyanate compound and at least one isocyanate-reactive compound having at least one tertiary amino group, optionally in the presence of one or more diluents, and subsequently adding at least one copper(II)-salt.

The composition according to the invention is preferably used as a catalyst composition, in particular, for catalyzing the reaction of at least one isocyanate compound with at least one isocyanate-reactive compound, most preferably as a catalyst for the manufacture of polyisocyanate polyaddition products, that is, polymers that are obtained from polyisocyanates with isocyanate reactive compounds, that is compounds that have an active hydrogen atom, in particular polyols and polyamines. Depending on which isocyanate reactive compounds are used the polyisocyanate polyaddition products have one or more functional groups consisting of the group selected from urethane groups and urea groups. Most preferred the composition of the invention is used as a catalyst for the manufacture of polyurethanes, in particular, polyurethane foams. A typical polyurethane foam-forming composition is for example described in WO2016/039856 and comprises: (a) a polyol; (b) an isocyanate; (c) the composition according to the invention, (d) a surfactant; and (e) optional components, such as a blowing agent and other optional components such as surfactants, fire retardants, chain extenders, cross-linking agents, adhesion promoters, anti-static additives, hydrolysis and UV stabilizers, lubricants, anti-microbial agents, catalysts and/or other application specific additives can be used for production of compact or cellular polyurethane materials [The polyurethanes book, Editors David Randall and Steve Lee, John Willey & Sons, LTD, 2002]. The polyol (a) component may be any polyol useful to form a polyurethane foam.

In a further embodiment of the invention it relates to catalyst composition comprising the composition according to the invention as defined above. In a further embodiment the present invention relates to process for the manufacture of an isocyanate addition product comprising reacting an isocyanate compound with an isocyanate-reactive compound in the presence of the catalyst composition as defined above. Regarding the preferred isocyanates and the isocyanate-reactive compounds it can be referred to the description above. Most preferably the catalyst composition is used in a process for the manufacture of an isocyanate addition product, wherein the isocyanate is a polyisocyanate and the isocyanate-reactive compound is a polyol, and the process is for producing a polyurethane, in particular a polyurethane foam.

The term “polyurethane” as utilized herein refers to the reaction product of an isocyanate containing two or more isocyanate groups with compounds containing two or more active hydrogens, e.g., polyols (polyether polyols, polyester polyols, copolymer polyols also known as graft polyols) and/or primary and secondary amine terminated polymer known as polyamines. These reaction products are generally known to those skilled in the art as polyurethanes and/or polyureas. The reaction in forming cellular and non-cellular foams optionally includes a blowing agent. In the production of a polyurethane foam, the reaction includes a blowing agent and other optional components such as surfactants, fire retardants, chain extenders, cross-linking agents, adhesion promoters, anti-static additives, hydrolysis and UV stabilizers, lubricants, anti-microbial agents, catalysts and/or other application specific additives can be used for production of compact or cellular polyurethane materials [The polyurethanes book, Editors David Randall and Steve Lee, John Willey & Sons, LTD, 2002]. The present catalyst materials of the invention are especially suitable for making flexible, semi-flexible, and rigid foams using the one shot foaming, the quasi-pre-polymer and the pre-polymer processes. The polyurethane manufacturing process of the present invention typically involves the reaction of, e.g., a polyol, generally a polyol having a hydroxyl number from about 10 to about 700, an organic polyisocyanate, a blowing agent and optional additives known to those skilled in the art and one or more catalysts, at least one of which is chosen from the subject tertiary amine compound. As the blowing agent and optional additives, flexible and semi-flexible foam formulations (hereinafter referred to simply as flexible foams) also generally include, e.g., water, organic low boiling auxiliary blowing agent or an optional non-reacting gas, silicone surfactants, optional catalysts, and optional cross-linker(s). Rigid foam formulations often contain both a low boiling organic material and water for blowing.

The “one shot foam process” for making polyurethane foam is a one-step process in which all of the ingredients necessary (or desired) for producing the foamed polyurethane product including the polyisocyanate, the organic polyol, water, catalysts, surfactant(s), optional blowing agents and the like are efficiently mixed , poured onto a moving conveyor or into a mold of a suitable configuration and cured [Chemistry and Technology of Polyols for Polyurethanes, by Mihail lonescu, Rapra Technology LTD. (2005)]. The one shot process is to be contrasted with the prepolymer and quasi-prepolymer processes [Flexible polyurethane foams, by Ron Herrington and Kathy Hock, Dow Plastics, 1997]. In the prepolymer process, most prepolymers in use today are isocyanate-tipped. A strict prepolymer is formed when just enough polyisocyanate is added to react with all hydroxyl sites available. If there is an excess or residual isocyanate monomer present, the product is called a quasi-prepolymer. A prepolymer or a quasi-prepolymer is first prepared in the absence of any foam-generating constituents. In a second step, the high molecular weight polyurethanes materials are formed by the reaction of a prepolymer with water and/or chain extender such as: ethylene glycol, diethylene glycol, 1,4-butane diol or a diamine in the presence of catalyst.

The catalyst composition of the invention may be used as a sole catalyst or in combination with one or more one or more additional catalysts for the formation of polyisocyanate addition products such as tertiary amine catalysts as described above.

Furthermore, the catalyst composition of the invention may comprise two or more different compounds which are obtainable by reacting at least one isocyanate compound and at least one isocyanate-reactive compound having at least one tertiary amino group tertiary amine compounds as described above. The catalyst composition of the invention may be present in the reactive mixture including all required components in an amount of from about 0.005% to about 5%; about 0.01% to about 3.0%; or about 0.03% to about 1.00 based on the total weight of the reactive compositions. Other catalysts useful for producing polyurethane foams include, for example, tertiary amines such as the alkyl amines described above, organometallic catalysts, e.g., organotin catalysts, metal salt catalysts, e.g., alkali metal or alkaline earth metal carboxylate catalysts, other delayed action catalysts, or other known polyurethane catalysts. Organometallic catalysts or metal salt catalysts also can, and often are, used in polyurethane foam formulations. For example for flexible slabstock foams, the generally preferred metal salt and organometallic catalysts are stannous octoate and dibutyltin dilaurate respectively. For flexible molded foams, exemplary organometallic catalysts are dibutyltin dilaurate and dibutyltin dialkylmercaptide. For rigid foams exemplary metal salt and organometallic catalysts are potassium acetate, potassium octoate and dibutyltin dilaurate, respectively. Metal salt or organometallic catalysts normally are used in small amounts in polyurethane formulations, typically from about 0.001 parts per hundred parts (pphp) to about 0.5 phpp based on the total weight of the composition.

Polyols which are useful in the process of the invention for making a polyurethane, particularly via the one-shot foaming procedure, are any of the types presently employed in the art for the preparation of flexible slabstock foams, flexible molded foams, semi-flexible foams, and rigid foams. Such polyols are typically liquids at ambient temperatures and pressures and include polyether polyols and polyester polyols having hydroxyl numbers in the range of from about 15 to about 700. The hydroxyl numbers are preferably between about 20 to about 60 for flexible foams, between about 100 to about 300 for semi-flexible foams and between about 250 to about 700 for rigid foams.

For flexible foams the preferred functionality, i.e., the average number of hydroxyl groups per molecule of polyol, of the polyols is about 2 to about 4 and most preferably about 2.3 to about 3.5. For rigid foams, the preferred functionality is about 2 to about 8 and most preferably about 3 to about 5.

Of the polyamines which are useful in the process of the invention for making a polyurethane, diamines such as, e.g., piperazine, 2,5-dimethylpiperazine, bis(4-aminophenyl)ether, 1,3-phenylenediamine and hexamethylenediamine are preferred. Polyfunctional isocyanate-reactive compounds which can be used in the process for manufacturing the polyurethanes and/or polyureas in the presence of the catalyst composition of the invention, alone or in admixture as copolymers, include for example any of the following non-limiting classes of polyols:
(a) polyether polyols derived from the reaction of polyhydroxyalkanes with one or more alkylene oxides, e.g., ethylene oxide, propylene oxide, etc.;
(b) polyether polyols derived from the reaction of high-functionality alcohols, sugar alcohols, saccharides and/or high functionality amines, if desired in admixture with low-functionality alcohols and/or amines with alkylene oxides, e.g., ethylene oxide, propylene oxide, etc.;
(c) polyether polyols derived from the reaction of phosphorus and polyphosporus acids with alkylene oxides, e.g., ethylene oxide, propylene oxide, etc.,
(d) polyether polyols derived from the reaction of polyaromatic alcohols with alkylene oxides, e.g., ethylene oxide, propylene oxide, etc.;
(e) polyether polyols derived from the reaction of ring-opening polymerization of tetrahydrofurane;
(f) polyether polyols derived from the reaction of ammonia and/or an amine with alkylene oxides, e.g., ethylene oxide, propylene oxide, etc.;
(g) polyester polyols derived from the reaction of a polyfunctional initiator, e.g., a diol, with a hydroxycarboxylic acid or lactone thereof, e.g., hydroxylcaproic acid or s-carprolactone;
(h) polyoxamate polyols derived from the reaction of an oxalate ester and a diamine, e.g., hydrazine, ethylenediamine, etc. directly in a polyether polyol;
(i) polyurea polyols derived from the reaction of a diisocyanate and a diamine, e.g., hydrazine, ethylenediamine, etc. directly in a polyether polyol.

For flexible foams, preferred types of alkylene oxide adducts of polyhydroxyalkanes are the ethylene oxide and propylene oxide adducts of aliphatic triols such as glycerol, trimethylol propane, etc. For rigid foams, the preferred class of alkylene oxide adducts are the ethylene oxide and propylene oxide adducts of ammonia, toluene diamine, sucrose, and phenolformaldehyde-amine resins (Mannich bases).

Grafted or polymer polyols are used extensively in the production of flexible foams and are, along with standard polyols, one of the preferred class of polyols useful in the process of this invention. Polymer polyols are polyols that contain a stable dispersion of a polymer, for example in the polyols a) to e) above and more preferably the polyols of type a). Other polymer polyols useful in the process of this invention are polyurea polyols and polyoxamate polyols.

The polyisocyanates that are useful in the polyurethane foam formation process of this invention are organic compounds that contain at least two isocyanate groups and generally will be any of the known aromatic or aliphatic polyisocyanates. Suitable organic polyisocyanates include, for example, the hydrocarbon diisocyanates, (e.g. the alkylenediisocyanates and the arylene diisocyanates), such as methylene diphenyl diisocyanate (MDI) and 2,4- and 2,6-toluene diisocyanate (TDI), as well as known triisocyanates and polymethylene poly(phenylene isocyanates) also known as polymeric or crude MDI. For flexible and semi-flexible foams, the preferred isocyanates generally are, e.g., mixtures of 2,4-tolylene diisocyanate and 2,6-tolylene diisocyanate (TDI) in proportions by weight of about 80% and about 20% respectively and also about 65% and about 35% respectively based on the total weight of the composition of TDI; mixtures of TDI and polymeric MDI, preferably in the proportion by weight of about 80% TDI and about 20% of crude polymeric MDI to about 50% TDI and about 50% crude polymeric MDI based on the total weight of the composition; and all polyisocyanates of the MDI type. For rigid foams, the preferred isocyanates are, e.g., polyisocyanates of the MDI type and preferably crude polymeric MDI.

The amount of polyisocyanate included in the foam formulations used relative to the amount of other materials in the formulations is described in terms of “Isocyanate Index”. “Isocyanate Index” means the actual amount of polyisocyanate used divided by the theoretically required stoichiometric amount of polyisocyanate required to react with all the active hydrogen in the reaction mixture multiplied by one hundred (100) [see Oertel, Polyurethane Handbook, Hanser Publishers, New York, N.Y. (1985)]. The Isocyanate Indices in the reaction mixtures used in the process of this invention generally are between 60 and 140. More usually, the Isocyanate Index is: for flexible TDI foams, typically between 85 and 120; for molded TDI foams, normally between 90 and 105; for molded MDI foams, most often between 70 and 90; and for rigid MDI foams, generally between 90 and 130. Some examples of polyisocyanurate rigid foams are produced at indices as high as 250-400.

Water often is used as a reactive blowing agent in both flexible and rigid foams. In the production of flexible slabstock foams, water generally can be used in concentrations of, e.g., between 2 to 6.5 parts per hundred parts (pphp) of polyol blend, and more often between 3.5 to 5.5 pphp of polyol blend. Water levels for TDI molded foams normally range, e.g., from 3 to 4.5 pphp of polyol blend. For MDI molded foam, the water level, for example, is more normally between 2.5 and 5 pphp. Water levels for rigid foam, for example, range from 0.5 to 5 pphp, and more often from 0.5 to 2 pphp of polyol blend. Physical blowing agents such as blowing agents based on volatile hydrocarbons or halogenated hydrocarbons and other non-reacting gases can also be used in the production of polyurethane foams in accordance with the present invention. A significant proportion of the rigid insulation foam produced is blown with volatile hydrocarbons or halogenated hydrocarbons and the preferred blowing agents are the hydrochlorofluorocarbons (HCFC) and the volatile hydrocarbons pentane and cyclopentane. In the production of flexible slabstock foams, water is the main blowing agent; however, other blowing agents can be used as auxiliary blowing agents. For flexible slabstock foams, the preferred auxiliary blowing agents are carbon dioxide and dichloromethane (methylene chloride). Other blowing agents may also be used such as, e.g., the chlorofluorocarbon (CFC) and the trichloromonofluoromethane (CFC-11).

Flexible molded foams typically do not use an inert, auxiliary blowing agent, and in any event incorporate less auxiliary blowing agents than slabstock foams. However, there is a great interest in the use of carbon dioxide in some molded technology. MDI molded foams in Asia and in some developing countries use methylene chloride, CFC-11 and other blowing agents. The quantity of blowing agent varies according to the desired foam density and foam hardness as recognized by those skilled in the art. When used, the amount of hydrocarbon-type blowing agent varies from, e.g., a trace amount up to about 50 parts per hundred parts of polyol blend (pphp) and CO₂ varies from, e.g., about 1 to about 10 pphp of polyol blend.

Crosslinkers also may be used in the production of polyurethane foams. Crosslinkers are typically small molecules; usually less than 350 molecular weight, which contain active hydrogens for reaction with the isocyanate. The functionality of a crosslinker is greater than 3 and preferably between 3 and 5. The amount of crosslinker used can vary between about 0.1 pphp and about 20 pphp based on polyol blend and the amount used is adjusted to achieve the required foam stabilization or foam hardness. Examples of crosslinkers include glycerine, diethanolamine, triethanolamine and tetrahydroxyethylethylenediamine.

Silicone surfactants that may be used in the process of this invention include, e.g., “hydrolysable” polysiloxane-polyoxyalkylene block copolymers, “non-hydrolysable” polysiloxane-polyoxyalkylene block copolymers, cyanoalkylpolysiloxanes, alkylpolysiloxanes, and polydimethylsiloxane oils. The type of silicone surfactant used and the amount required depends on the type of foam produced as recognized by those skilled in the art. Silicone surfactants can be used as such or dissolved in solvents such as glycols. For flexible slabstock foams, the reaction mixture usually contains from about 0.1 to about 6 pphp of silicone surfactant, and more often from about 0.7 to about 2.5 pphp. For flexible molded foam the reaction mixture usually contains about 0.1 to about 5 pphp of silicone surfactant, and more often about 0.5 to about 2.5 pphp. For rigid foams, the reaction mixture usually contains about 0.1 to about 5 pphp of silicone surfactant, and more often from about 0.5 to about 3.5 pphp. The amount used is adjusted to achieve the required foam cell structure and foam stabilization.

Temperatures useful for the production of polyurethanes vary depending on the type of foam and specific process used for production as well understood by those skilled in the art. Flexible slabstock foams are usually produced by mixing the reactants generally at an ambient temperature of between about 20° C. and about 40° C. The conveyor on which the foam rises and cures is essentially at ambient temperature, which temperature can vary significantly depending on the geographical area where the foam is made and the time of year. Flexible molded foams usually are produced by mixing the reactants at temperatures between about 20° C. and about 30° C., and more often between about 20° C. and about 25° C. The mixed starting materials are fed into a mold typically by pouring. The mold preferably is heated to a temperature between about 20° C. and about 70° C., and more often between about 40° C. and about 65° C. Sprayed rigid foam starting materials are mixed and sprayed at ambient temperature. Molded rigid foam starting materials are mixed at a temperature in the range of about 20° C. to about 35° C. The preferred process used for the production of flexible slabstock foams, molded foams, and rigid foams in accordance with the present invention is the “one-shot” process where the starting materials are mixed and reacted in one step.

Accordingly in an embodiment of the invention it relates to a process for the manufacture of an isocyanate addition product according to any of the previous claims, wherein the isocyanate addition product is a polyurethane, preferably a polyurethane foam, selected from a cellular or non-cellular polyurethanes, and the process optionally comprises a blowing agent. In such process optionally comprises the addition of a surfactant, a fire retardant, a chain extender, a cross-linking agent, an adhesion promoter, an anti-static additive, a hydrolysis stabilizer, a UV stabilizer, a lubricant, an anti-microbial agent, or any other common auxiliary additive used in the production of polyurethane, or a combination of two or more thereof. Accordingly in an embodiment of the invention it also relates to an isocyanate addition product forming a foam formed from the process of the manufacture of an isocyanate addition product as described before, which uses the catalyst composition of the invention. Such isocyanate addition product forming a foam is for example selected from the group consisting of slabstock, molded foams, flexible foams, rigid foams, semi-rigid foams, spray foams, thermoformable foams, footwear foams, open-cell foams, closed-cell foams and adhesives.

In the following the preferred embodiments of the invention are summarized:
1. A composition, comprising at least one Cu(II)-salt, at least one compound which is obtainable by reacting at least one isocyanate compound and at least one isocyanate-reactive compound having at least one tertiary amino group, and optionally one or more diluents.
2. A composition according to embodiment 1, comprising a compound obtainable by reacting at least one isocyanate compound and at least one isocyanate-reactive compound having at least one tertiary amino group in the presence of at least one Cu(II)-salt and optionally in the presence of one or more diluents.
3. A composition according to embodiments 1 or 2, comprising a compound obtainable by reacting at least one polyisocyanate compound, at least one isocyanate-reactive compound having at least one tertiary amino group and at least one isocyanate-reactive compound which does not have a tertiary amino group in the presence of at least one Cu(II)-salt and optionally in the presence of one or more diluents.
4. A composition according to any of the previous embodiments, comprising a compound, comprising at least one carbamate (urethane) and/or urea group and at least one tertiary amino group, at least one Cu(II)-salt and optionally one or more diluents.
5. A composition according to any of the previous embodiment, wherein the isocyanate compound is selected from the group consisting of polyisocyanates and monoisocyanates, such as octadecylisocyanate; octylisocyanate; butyl and t-butylisocyanate; cyclohexyl isocyanate; adamantyl isocyanate; ethylisocyanatoacetate; ethoxycarbonylisocyanate; phenylisocyanate; alphamethylbenzyl isocyanate; 2-phenylcyclopropyl isocyanate; 2-ethylphenylisocyanate; benzylisocyanate; meta and para-tolylisocyanate; 2-, 3-, or 4-nitrophenylisocyanates; 2-ethoxyphenyl isocyanate; 3-methoxyphenyl isocyanate; 4-methoxyphenyl isocyanate; ethyl 4-isocyanatobenzoate; 2,6-dimethylphenylisocyanate; 1-naphythylisocyanate; (naphthyl) ethylisocyanates; isophorone diisocyanate (IPDI); toluene diisocyanate (TDI); diphenylmethane-2,4′-diisocyanate (2,4′-MDI); diphenylmethane-4,4′-diisocyanate (4,4′-MDI); hydrogenated diphenylmethane-4,4′-diisocyanate (H12 MDI); tetra-methyl xylene diisocyanate (TMXDI); hexamethylene-1,6-diisocyanate (HDI); napthylene-1,5-diisocyanate; 3,3′-dimethoxy-4,4′-biphenyldiisocyanate; 3,3′-dimethyl-4,4′-bimethyl-4,4′-biphenyldiisocyanate; phenylene diisocyanate; 4,4′-biphenyldiisocyanate; trimethylhexamethylene diisocyanate; 4,4′-methylene-bis (2,6-diethylphenyl isocyanate); 1,12-diisocyanatododecane; 1,5-diisocyanato-2-methylpentane; 1,4-diisocyanatobutane; and cyclohexylene diisocyanate and its isomers; uretidione dimers of HDI; trimethylolpropane trimer of TDI, isocyanurate trimers of TDI, HDI, IPDI; biuret trimers of TDI, HDI, or IPDI; and polyisocyanates as mentioned before, where the isocyanate groups are partially reacted with at least one isocyanate-reactive compound which does not have a tertiary amino group, preferably selected from OH—, NH—, and NH₂-functional optionally substituted hydrocarbons, which may contain one or more heteroatoms, such as alcohols, like methanol, tert.-butanol, isopropanol, sec.-butanol, OH-functional monoglycol ether, OH-functional diglycol ether etc.
6. A composition according to any of the previous embodiments, wherein the isocyanate compound is selected from polyisocyanates.
7. A composition according to any of the previous embodiments, wherein the isocyanate compound is isophorone diisocyanate (IPDI).
8. A composition according to any of the previous embodiments, wherein the isocyanate-reactive compounds having at least one tertiary amino group are selected from the group consisting of alcohols having at least one tertiary amino group, and amines having at least one tertiary amino group and at least one additional amino group selected from primary and secondary amino groups.
9. A composition according to the previous embodiment, wherein the isocyanate-reactive compound comprises as least one ether group (—O—), and preferably the isocyanate-reactive compound is selected from the group consisting of aliphatic alcohols having at least one hydroxyl group, at least one tertiary amino group and optionally at least one ether group.
10. A composition according any of the previous embodiments, wherein the isocyanate-reactive compound having at least one tertiary amino group is selected from the group consisting of:

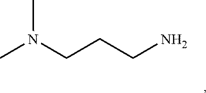

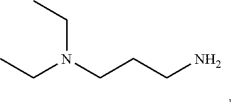

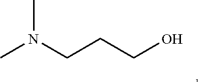

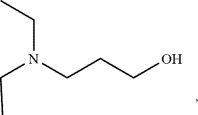

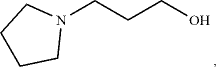

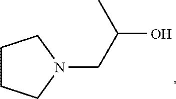

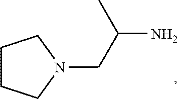

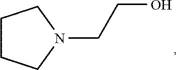

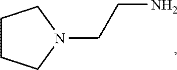

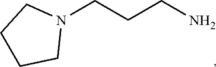

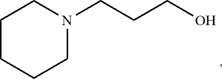

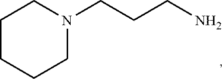

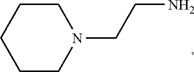

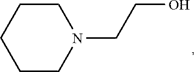

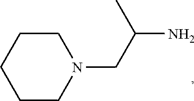

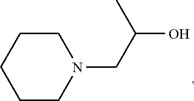

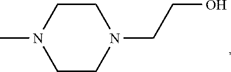

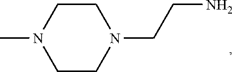

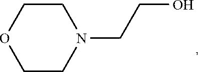

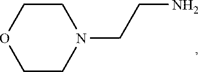

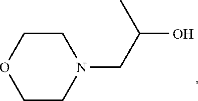

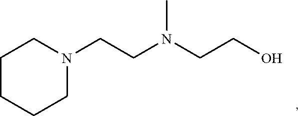

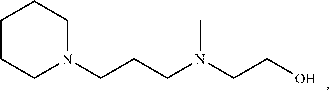

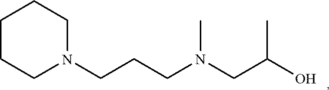

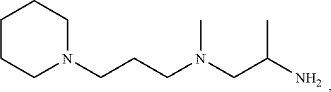

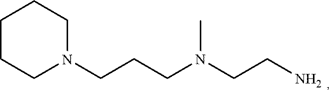

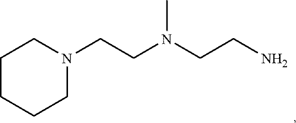

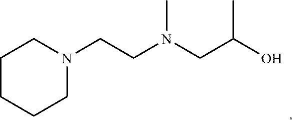

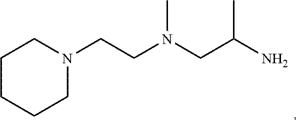

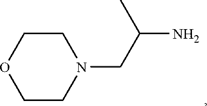

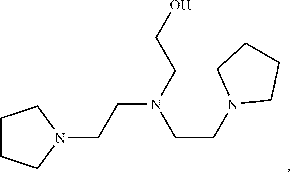

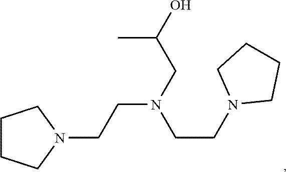

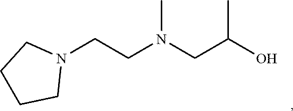

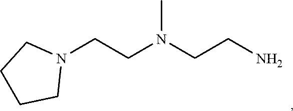

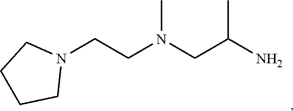

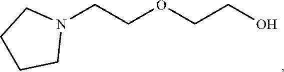

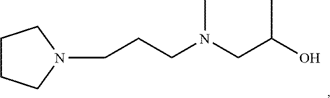

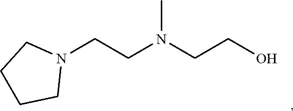

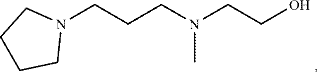

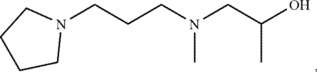

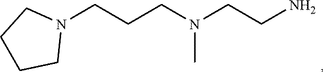

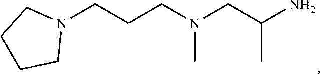

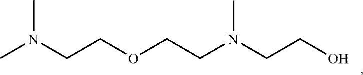

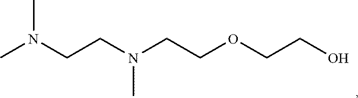

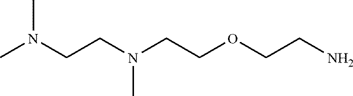

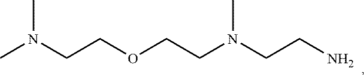

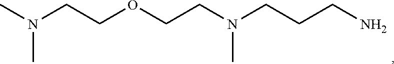

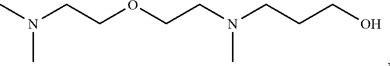

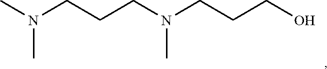

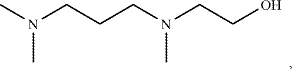

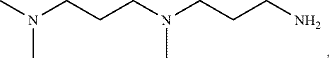

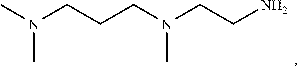

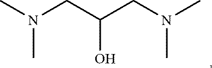

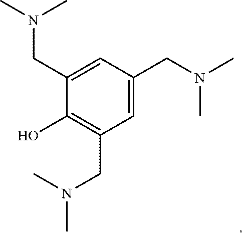

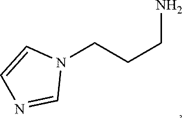

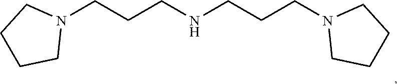

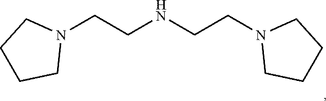

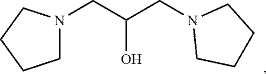

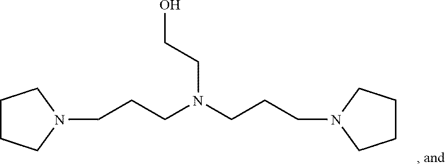

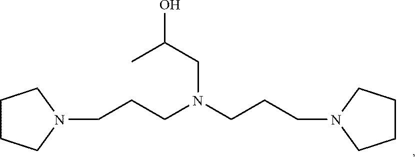

and bicyclic tertiary amines, such as

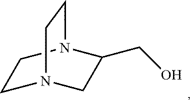

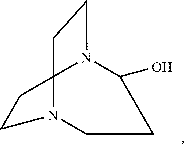

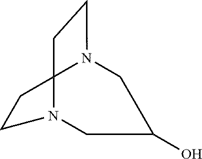 [SMILES: OC1CN2CCC23CCN3C1]

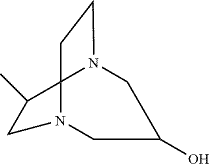

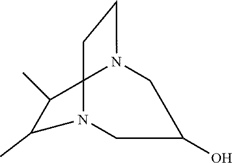

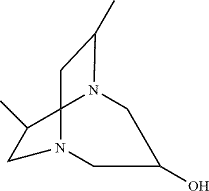

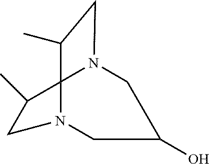

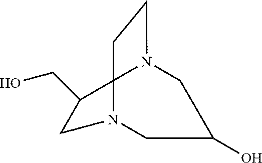 [SMILES: OCC1CN2CC(O)CN3CCC132]

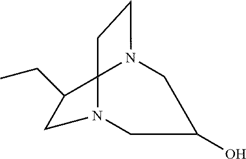

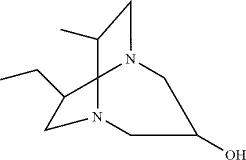

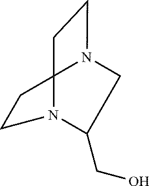 [SMILES: OCC1CN2CCC23CCN13]

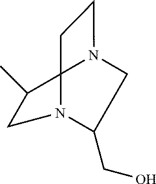

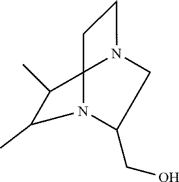

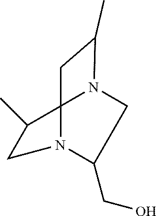

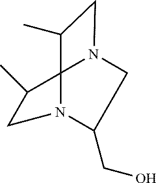

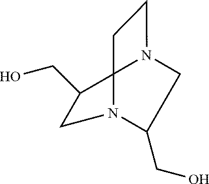 [SMILES: OCC1CN2CCC23C(CO)CN13]

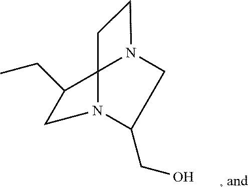

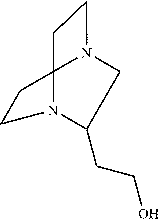 [SMILES: OCCC1CN2CCC23CCN13]

, preferably

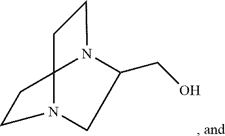

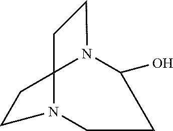 [SMILES: OC1CCN2CCC23CCN13]

or mixtures thereof.
11. A composition according to the previous embodiments, wherein the compound is selected from:
C1 the reaction product of 1-[bis[3-(dimethylamino)propyl]amino]-2-propanol and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C2 the reaction product of 2-[2-(dimethylamino)ethoxy]ethanol and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI), and more preferably 1,3-bis(1-isocyanato-1-methylethyl)benzene,
C3 the reaction product of 2-{[2-(dimethylamino)ethyl]methylamino}ethanol and isophorone diisocyanate, (IPDI), hexamethylene diisocyanate (HDI), and derivatives derived from IPDI and/or HDI such as biurets, isocyanurates, allophanates, and oligomers thereof, preferably isophorone diisocyanate (IPDI),
C4 the reaction product of 3,3′-iminobis(N,N-dimethylpropylamine) and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI), and more preferably 1,3-bis(1-isocyanato-1-methylethyl)benzene,
C5 the reaction product of dimethylaminoethanol and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI), and more preferably 1,3-bis(1-isocyanato-1-methylethyl)benzene,
C6 The reaction product of diethylaminoethanol and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI), and more preferably 1,3-bis(1-isocyanato-1-methylethyl)benzene,
C7 the reaction product of 3-(dimethylamino)-1-propylamine and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C8 the reaction product of 3-(diethylamino)-1-propylamine and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C9 the reaction product of 3-(diethylamino)-1-propanol and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C10 the reaction product of 1-(3-hydroxypropyl)pyrrolidine and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C11 the reaction product of 1-(2-hydroxyethyl)pyrrolidine and isophorone diisocyanate(IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C12 the reaction product of 1-(2-hydroxyethyl)piperidine and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C13 the reaction product of 1-(3-hydroxypropyl)piperidine and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),,
C14 the reaction product of 1-(2-hydroxypropyl)piperidine and hexamethylene-1,6-diisocyanate(IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),,
C15 the reaction product of 1-(3-aminopropyl)pyrrolidine and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C16 the reaction product of 1-(2-aminoethyl)pyrrolidine and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C17 the reaction product of 1-(3-aminopropyl)piperidine and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C18 the reaction product of 1-(2-aminoethyl)piperidine and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C19 the reaction product of 1-(piperidin-1-yl)propan-2-ol and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C20 the reaction product of 1-(pyrrolidine-1-yl)propan-2-ol and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C21 the reaction product of 1-(1-pyrrolidinyl)-2-propanamine and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C22 the reaction product 1-(piperidin-1-yl)propan-2-amine and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C23 the reaction product of 2-[2-[2-(dimethylamino)ethoxy]ethyl-methylamino]ethanol and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI),
C24 the reaction product of 3-{[3-(dimethylamino)propyl]methylamino}propanol and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI), and
C25 the reaction product of 2-{[3-(dimethylamino)propyl]methylamino}ethanol and isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI).
12. A composition according to the previous embodiment, wherein the compound is selected from:

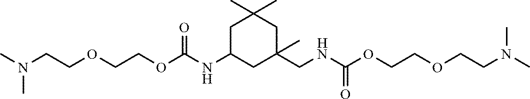

or the HDMI analogue thereof:

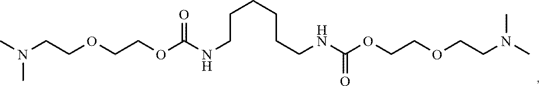

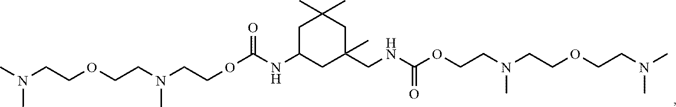

or the HDMI analogue thereof:

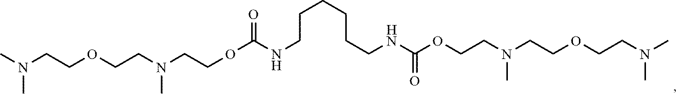

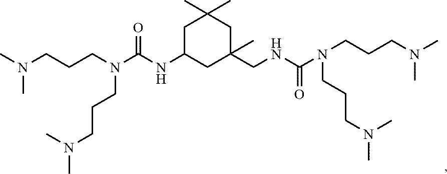

or the HDMI analogue thereof:

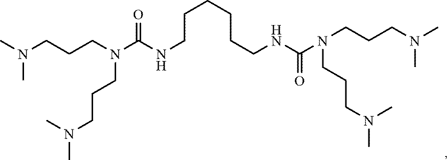

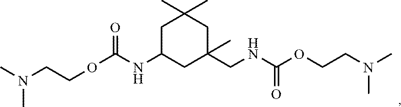

or the HDMI analogue thereof:

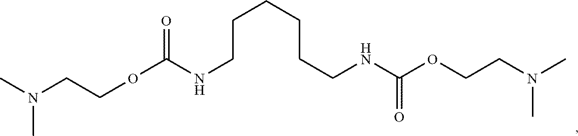

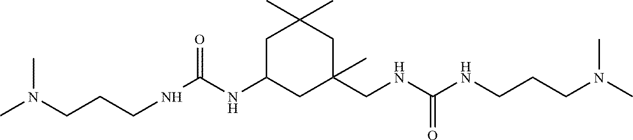

or the HDMI analogue thereof:

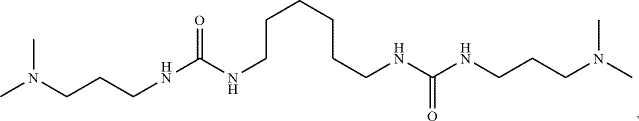

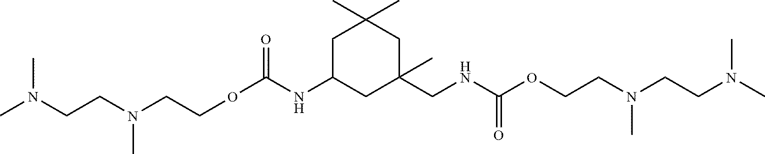

or the HDMI analogue thereof:

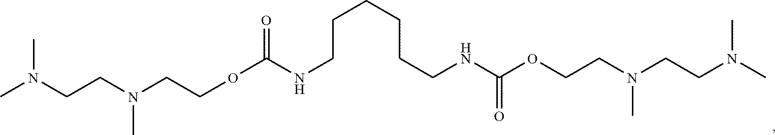

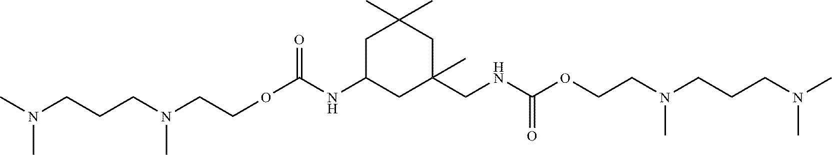

or the HDMI analogue thereof:

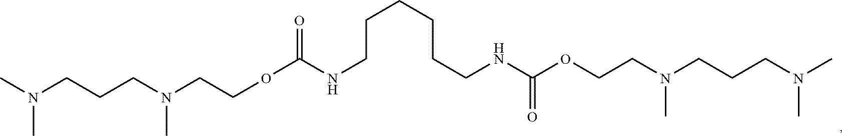

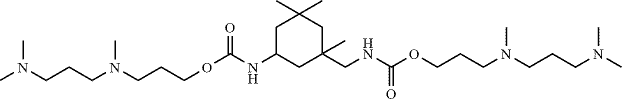

or the HDMI analogue thereof:

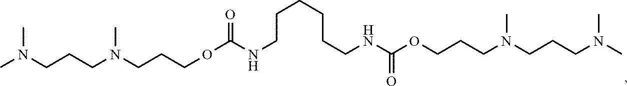

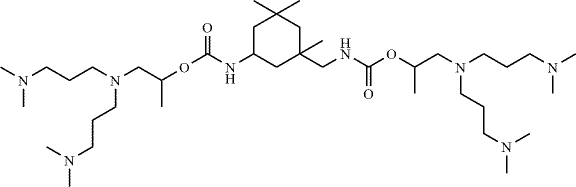

or the HDMI analogue thereof:

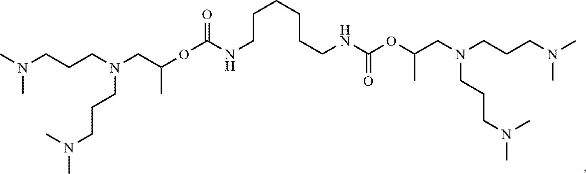

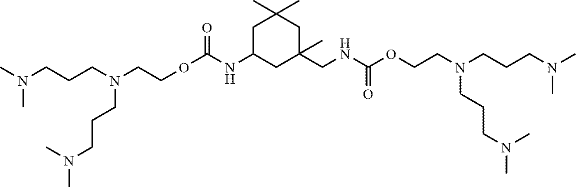

or the HDMI analogue thereof:

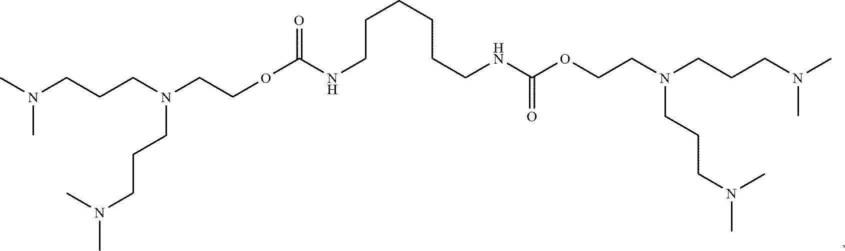

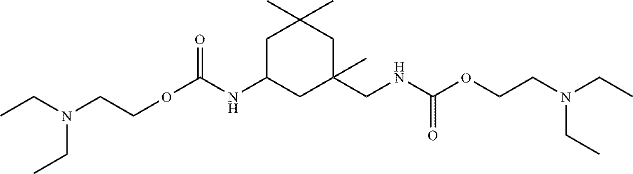 [SMILES: CCN(CC)CCOC(=O)NCC1(C)CC(NC(=O)OCCN(CC)CC)CC(C)(C)C1]

or the HDMI analogue thereof:

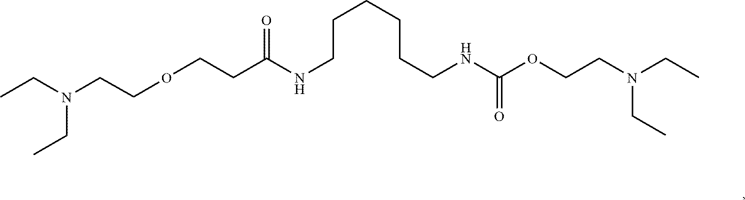

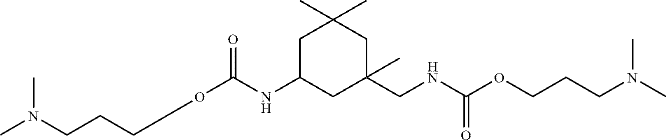

or the HDMI analogue thereof:

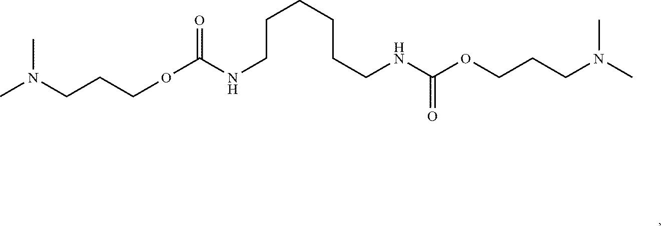

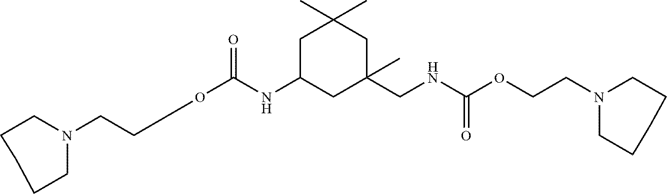 [SMILES: CC1(C)CC(NC(=O)OCCCN2CCCCC2)CC(C)(CNC(=O)OCCN2CCCCC2)C1]

or the HDMI analogue thereof:

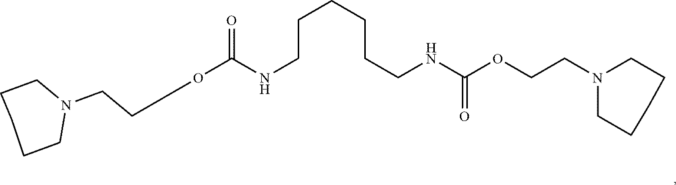

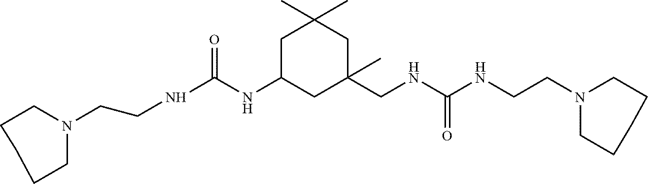 [SMILES: CC1(C)CC(NC(=O)NCCN2CCCCC2)CC(C)(CNC(=O)NCCN2CCCCC2)C1]

or the HDMI analogue thereof:

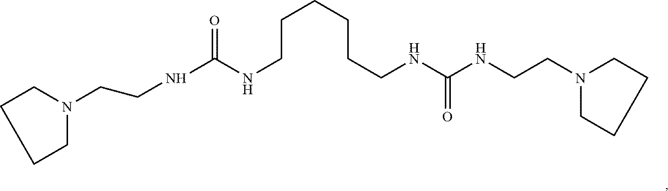

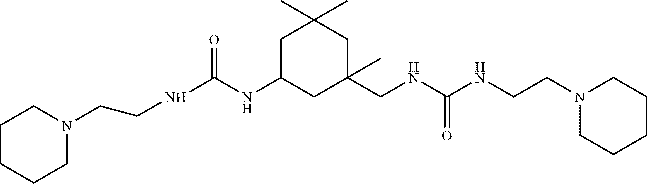 [SMILES: CC1(C)CC(NC(=O)NCCN2CCCCC2)CC(C)(CNC(=O)NCCN2CCCCC2)C1]

or the HDMI analogue thereof:

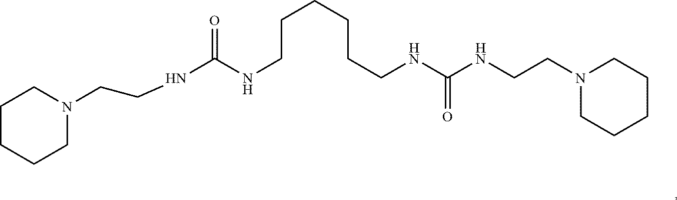

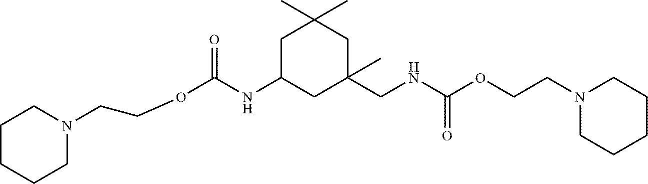 [SMILES: CC1(C)CC(NC(=O)OCCN2CCCCC2)CC(C)(CNC(=O)OCCN2CCCCC2)C1]

or the HDMI analogue thereof:

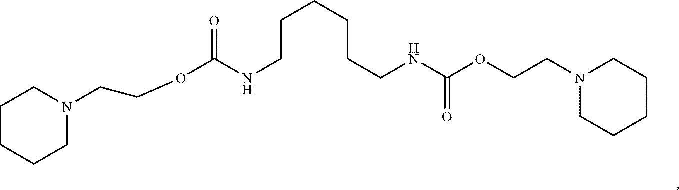

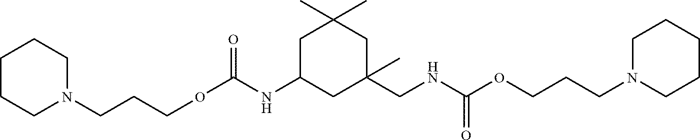 [SMILES: CC1(C)CC(NC(=O)OCCCN2CCCCC2)CC(C)(CNC(=O)OCCCN2CCCCC2)C1]

or the HDMI analogue thereof:

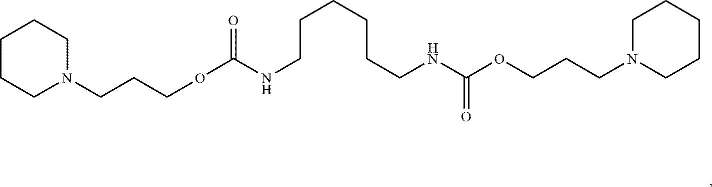

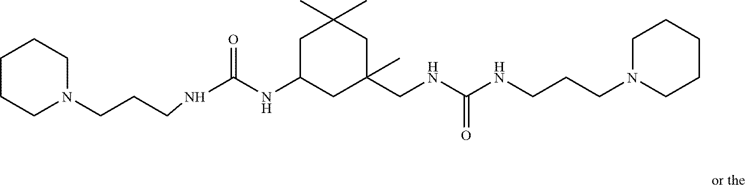

HDMI analogue thereof:

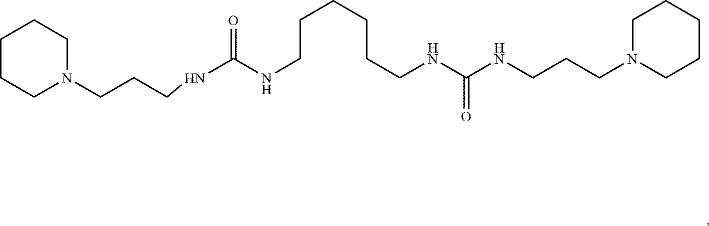

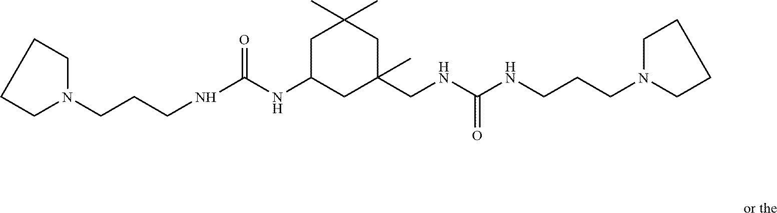

HDMI analogue thereof:

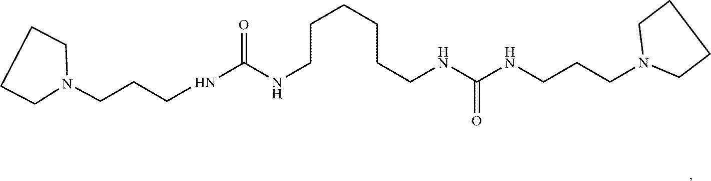

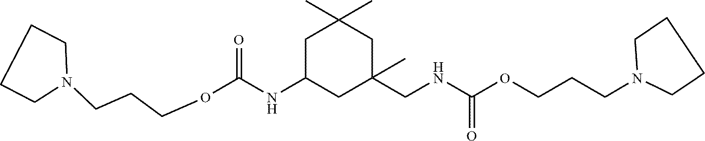 [SMILES: CC1(C)CC(NC(=O)OCCCN2CCCC2)CC(C)(CNC(=O)OCCCN2CCCC2)C1]

or the HDMI analogue thereof:

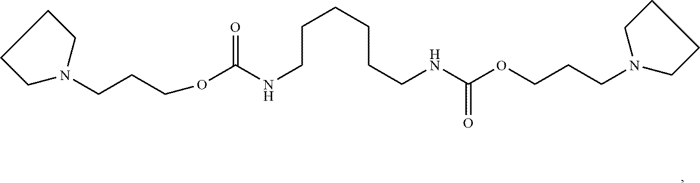

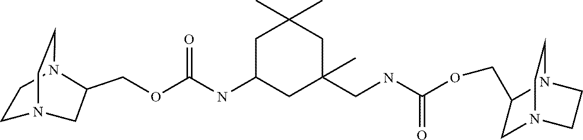 [SMILES: CC1(C)CC(NC(=O)OC[C@H]2CN3CCN2CC3)CC(C)(CNC(=O)OCC2CN3CCN2CC3)C1]

or the HDMI analogue thereof:

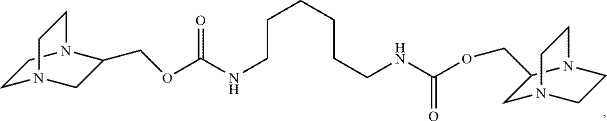

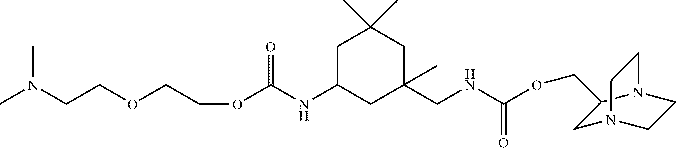 [SMILES: CN(C)CCOCCOC(=O)NC1CC(C)(C)CC(C)(CNC(=O)OCC2CN3CCN2CC3)C1]

or the HDMI analogue thereof:

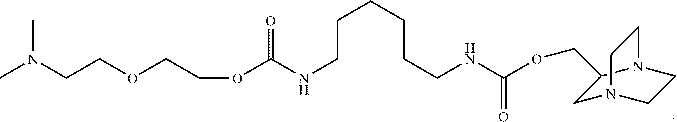

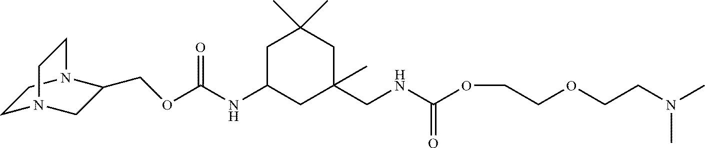 [SMILES: CN(C)CCOCCOC(=O)NCC1(C)CC(NC(=O)OCC2CN3CCN2CC3)CC(C)(C)C1]

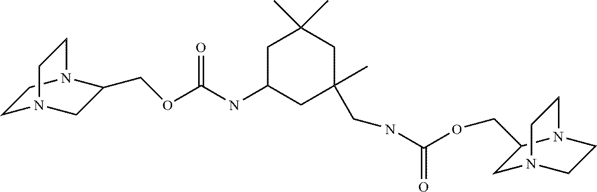 [SMILES: CC1(C)CC(NC(=O)OCC2CN3CCN2CC3)CC(C)(CNC(=O)OCC2CN3CCN2CC3)C1]

or the HDMI analogue thereof:

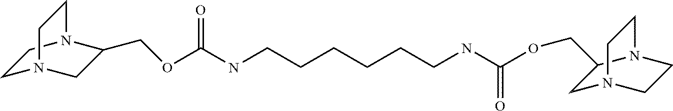 [SMILES: O=C(NCCCCCCNC(=O)OCC1CN2CCN1CC2)OCC1CN2CCN1CC2]

A compound selected from the group consisting of:
(1) the reaction product of 3-(dimethylamino)-1-propylamine and isophorone diisocyanate,
(2) the reaction product of 3-(dimethylamino)-1-propylamine and hexamethylene-1,6-diisocyanate,
(3) the reaction product of 3-(diethylamino)-1-propylamine and isophorone diisocyanate,
(4) the reaction product of 3-(diethylamino)-1-propylamine and hexamethylene-1,6-diisocyanate,
(5) the reaction product of 3-(diethylamino)-1-propanol and isophorone diisocyanate,
(6) the reaction product of 3-(diethylamino)-1-propanol and hexamethylene-1,6-diisocyanate,
(7) the reaction product of 1-(3-hydroxypropyl)pyrrolidine and isophorone diisocyanate,
(8) the reaction product of 1-(3-hydroxypropyl)pyrrolidine and hexamethylene-1,6-diisocyanate,
(9) the reaction product of 1-(2-hydroxyethyl)pyrrolidine and isophorone diisocyanate,
(10) the reaction product of 1-(2-hydroxyethyl)pyrrolidine and hexamethylene-1,6-diisocyanate,
(11) the reaction product of 1-(2-hydroxyethyl)piperidine and isophorone diisocyanate,
(12) the reaction product of 1-(2-hydroxyethyl)piperidine and hexamethylene-1,6-diisocyanate,
(13) the reaction product of 1-(3-hydroxypropyl)piperidine and isophorone diisocyanate,
(14) the reaction product of 1-(3-aminopropyl)pyrrolidine and isophorone diisocyanate,
(15) the reaction product of 1-(3-aminopropyl)pyrrolidine and hexamethylene-1,6-diisocyanate,
(16) the reaction product of 1-(2-aminoethyl)pyrrolidine and isophorone diisocyanate,
(17) the reaction product of 1-(2-aminoethyl)pyrrolidine and hexamethylene-1,6-diisocyanate,
(18) the reaction product of 1-(3-aminopropyl)piperidine and isophorone diisocyanate,
(19) the reaction product of 1-(3-aminopropyl)piperidine and hexamethylene-1,6-diisocyanate,
(20) the reaction product of 1-(2-aminoethyl)piperidine and isophorone diisocyanate,
(21) the reaction product of 1-(2-aminoethyl)piperidine and hexamethylene-1,6-diisocyanate,
(22) the reaction product of 1-(piperidin-1-yl)propan-2-ol and isophorone diisocyanate,
(23) the reaction product of 1-(piperidin-1-yl)propan-2-ol and hexamethylene-1,6-diisocyanate,
(24) the reaction product of 1-(pyrrolidine-1-yl)propan-2-ol and isophorone diisocyanate,
(25) the reaction product of 1-(pyrrolidine-1-yl)propan-2-ol and hexamethylene-1,6-diisocyanate,
(26) the reaction product of 1-(1-pyrrolidineyl)-2-propanamine and isophorone diisocyanate,
(27) the reaction product of 1-(1-pyrrolidineyl)-2-propanamine and hexamethylene-1,6-diisocyanate,
(28) the reaction product of 1-(piperidin-1-yl)propan 2-amine and isophorone diisocyanate,
(29) the reaction product of 1-(piperidin-1-yl)propan 2-amine and hexamethylene-1,6-diisocyanate,
(30) the reaction product of 2-[2-[2-(dimethylamino)ethoxy]ethyl-methylamino]ethanol and isophorone diisocyanate,
(31) the reaction product of 2-[2-[2-(dimethylamino)ethoxy]ethyl-methylamino]ethanol and hexamethylene-1,6-diisocyanate,
(32) the reaction product of 3-{[3-(dimethylamino)propyl]methylamino}propanol and isophorone diisocyanate,
(33) the reaction product of 3-{[3-(dimethylamino)propyl]methylamino}propanol and hexamethylene-1,6-diisocyanate,
(34) the reaction product of 2-{[3-(dimethylamino)propyl]methylamino}ethanol and isophorone diisocyanate,
(35) the reaction product of 2-{[3-(dimethylamino)propyl]methylamino}ethanol and hexamethylene-1,6-diisocyanate,
(36) the reaction product of N-hydroxyethyl-N′-methylpiperazine and isophorone diisocyanate,
(37) the reaction product of N-hydroxyethyl-N′-methylpiperazine and hexamethylene-1,6-diisocyanate,
(38) the reaction product of 1,3-bis(dimethylamino)-2-propanol and isophorone diisocyanate,
(39) the reaction product of 1,3-bis(dimethylamino)-2-propanol and hexamethylene-1,6-diisocyanate,
(40) the reaction product of 2,4,6-tris(dimethylaminoethyl)phenol and isophorone diisocyanate,
(41) the reaction product of 2,4,6-tris(dimethylaminoethyl)phenol and hexamethylene-1,6-diisocyanate,
(42) the reaction product of 3-(dimethylamino)-1-propylamine and isophorone diisocyanate,
(43) the reaction product of 3-(dimethylamino)-1-propylamine and hexamethylene-1,6-diisocyanate,
(44) the reaction product of (2-{2-[(3-aminopropyl)(methyl)amino]ethoxy}ethyl)dimethylamine and isophorone diisocyanate,
(45) the reaction product of (2-{2-[(3-aminopropyl)(methyl)amino]ethoxy}ethyl)dimethylamine and hexamethylene-1,6-diisocyanate,
(46) the reaction product of 1-(3-aminopropyl)imidazole and isophorone diisocyanate,
(47) the reaction product of 1-(3-aminopropyl)imidazole and hexamethylene-1,6-diisocyanate,
(48) the reaction product of 4-(2-aminopropyl)morpholine and isophorone diisocyanate,
(49) the reaction product of 4-(2-aminopropyl)morpholine and hexamethylene-1,6-diisocyanate,
(50) the reaction product of 2-(2-pyrrolidinylethoxy)ethanol and isophorone diisocyanate,
(51) the reaction product of 2-(2-pyrrolidinylethoxy)ethanol and hexamethylene-1,6-diisocyanate,
(52) the reaction product of 2-(2-pyrrolidinylethyl N-methylamino)ethanol and isophorone diisocyanate,
(53) the reaction product of 2-(2-pyrrolidinylethyl N-methylamino)ethanol and hexamethylene-1,6-diisocyanate,
(54) the reaction product of N-(2-pyrrolidinylethyl)-N-methyl-2-hydroxypropyl amine and isophorone diisocyanate,
(55) the reaction product of N-(2-pyrrolidinylethyl)-N-methyl-2-hydroxypropyl amine and hexamethylene-1,6-diisocyanate,
(56) the reaction product of 2-(3-pyrrolidinylpropyl N-methylamino)ethanol and isophorone diisocyanate,
(57) the reaction product of 2-(3-pyrrolidinylpropyl N-methylamino)ethanol and hexamethylene-1,6-diisocyanate,
(58) the reaction product of N-(3-pyrrolidinylpropyl)-N-methyl-2-hydroxypropyl amine and isophorone diisocyanate,
(59) the reaction product of N-(3-pyrrolidinylpropyl)-N-methyl-2-hydroxypropyl amine and hexamethylene-1,6-diisocyanate,
(60) the reaction product of 2-(2-piperidinylethyl N-methylamino)ethanol and isophorone diisocyanate,
(61) the reaction product of 2-(2-piperidinylethyl N-methylamino)ethanol and hexamethylene-1,6-diisocyanate,
(62) the reaction product of N-(2-piperidinylethyl)-N-methyl-2-hydroxypropyl amine and isophorone diisocyanate,
(63) the reaction product of N-(2-piperidinylethyl)-N-methyl-2-hydroxypropyl amine and hexamethylene-1,6-diisocyanate,
(64) the reaction product of 2-(3-piperidinylpropyl N-methylamino)ethanol and isophorone diisocyanate,
(65) the reaction product of 2-(3-piperidinylpropyl N-methylamino)ethanol and hexamethylene-1,6-diisocyanate,
(66) the reaction product of N-(3-piperidinylpropyl)-N-methyl-2-hydroxypropyl amine and isophorone diisocyanate, and
(67) the reaction product of N-(3-piperidinylpropyl)-N-methyl-2-hydroxypropyl amine and hexamethylene-1,6-diisocyanate.

13. A composition according to any of the previous embodiments, wherein the compound obtainable by reacting at least one isocyanate compound and at least one isocyanate-reactive compound having at least one tertiary amino group optionally in the presence of at least one Cu(II)-salt and optionally in the presence of one or more diluents, is reacted further with at least one isocyanate compound with the formation of biurets, allophanates, and isocyanurates of the compound.

14. A composition according to any of the previous embodiments, wherein the at least one Cu(II)-salt is selected from Cu(II)-carboxylates.

15. A composition according to any of the previous embodiments, comprising 10 to 99.991 wt-%, preferable 15 to 95 wt-%, more preferable 20 to 90 wt-% of the compound(s) obtainable by reacting at least one isocyanate compound and at least one isocyanate-reactive compound having at least one tertiary amino group, 0.009 to 5 wt-%, preferable 0.05 to 3 wt-%, more preferably 0.5 to 2 wt-% of copper, and 0 to 89.991 wt-% of the diluent(s),

wherein the wt-% are based on the total weight of the composition.

16. A composition according to any of the previous embodiments, which comprises one or more isocyanate-reactive compounds having at least one tertiary amino group.

17. A composition according to any of the previous embodiments, which further comprises one or more additional catalysts for the formation of polyisocyanate polyaddition products.

18. A composition according to any of the previous embodiments, which further comprises at least one carboxylic acid, preferably selected from the group consisting of monocarboxylic acid compounds, polycarboxylic acid compounds, such as dicarboxylic acid compounds, and hydroxyl-functional carboxylic acid compounds.

19. A composition according to any of the previous embodiments, which further comprises at least one carboxylic acid selected from the group consisting of salicyclic acid, benzoic acid, oxalic acid, malonic acid, succinic acid, glutaric acid, adipic acid, azelaic acid, sebacic acid, and citric acid, or

a composition comprising at least one compound of embodiment 13 and at least one carboxylic acid selected from the group consisting of salicyclic acid, benzoic acid, oxalic acid, malonic acid, succinic acid, glutaric acid, adipic acid, azelaic acid, sebacic acid, and citric acid, which does not comprise a Cu(II)-salt.

20. A process for the manufacture of the composition according to any of the previous embodiments, which process comprises reacting at least one isocyanate compound and at least one isocyanate-reactive compound having at least one tertiary amino group in the presence of at least one Cu(II)-salt, and optionally in the presence of one or more diluents.

21. A process for the manufacture of the composition according to any of the previous embodiments, which process comprises reacting at least one isocyanate compound and at least one isocyanate-reactive compound having at least one tertiary amino group, optionally in the presence of one or more diluents, and subsequently adding at least one copper(II)-salt.

22. The process for the manufacture of the composition according to the previous embodiments, wherein the reaction is carried out at a temperature of about 20-140° C., more preferable about 40-120° C., and most preferable about 60-100° C.

23. Use of the compositions according to any of the previous embodiments, or a compound of embodiment 13, or the composition of embodiment 20 which does not comprise a Cu(II)-salt, as a catalyst.

24. Use according to the previous embodiment as a catalyst for the reaction of at least one isocyanate compound with at least one isocyanate-reactive compound.

25. Use according to the previous embodiments as a catalyst for the manufacture of polyisocyanate polyaddition products.

26. Use according to the previous embodiments wherein the polyisocyanate polyaddition products have one or more functional groups consisting of the group selected from urethane groups and urea groups.

27. Use according to the previous embodiments as a catalyst for the manufacture of polyurethanes, in particular polyurethane foams.

28. A catalyst composition comprising the composition according to any of the previous embodiments, or a compound of embodiment 13, or the composition of embodiment 20 which does not comprise a Cu(II)-salt, or a compound of claim 13, or the composition of claim 20 which does not comprise a Cu(II)-salt.

29. A process for the manufacture of an isocyanate addition product comprising reacting an isocyanate compound with an isocyanate-reactive compound in the presence of the composition as defined in any of the previous embodiments.

30. The process for the manufacture of an isocyanate addition product, according to embodiment 29, wherein the isocyanate is a polyisocyanate and the isocyanate-reactive compound is a polyol, and the process is for producing a polyurethane, in particular a polyurethane foam.

31. The process for the manufacture of an isocyanate addition product according to any of the previous embodiments, wherein the isocyanate addition product is a polyurethane, preferably a polyurethane foam, selected from cellular or non-cellular polyurethanes, and the process optionally comprises a blowing agent.

32. The process for the manufacture of an isocyanate addition product according to any of the previous embodiments, wherein the process is for producing a polyurethane, and the process optionally comprises the addition of a surfactant, a fire retardant, a chain extender, a cross-linking agent, an adhesion promoter, an anti-static additive, a hydrolysis stabilizer, a UV stabilizer, a lubricant, an anti-microbial agent, or a combination of two or more thereof.

33. The process for the manufacture of an isocyanate addition product according to any of the previous embodiments, wherein the composition as defined in any of the previous claims is present in an amount of about 0.005 wt-% to about 5 wt-% based on the total weight of the total composition including all components.

34. An isocyanate addition product forming a foam obtainable from the process of the manufacture of an isocyanate addition product of any of the previous embodiments.

35. An isocyanate addition product forming a foam according to the previous embodiment, selected from the group consisting of slabstock, molded foams, flexible foams, rigid foams, semi-rigid foams, spray foams, thermoformable foams, microcellular foams, footwear foams, open-cell foams, closed-cell foams, adhesives.

While the scope of the present invention is defined by the appended claims, the following examples illustrate certain aspects of the invention and, more particularly, describe methods for evaluation. The examples are presented for illustrative purposes and are not to be construed as limitations on the present invention.

### EXAMPLES

### Example 1 [Copper Containing Catalyst Starting From Copper(II) Acetate Monohydrate]

5.16 g Copper(II) acetate monohydrate (25.8 mmol) was dissolved in 114.84 g (862 mmol) 2-[2-(dimethylamino)ethoxy]ethanol at room temperature via vigorous stirring. 65.67 g isophorone diisocyanate (295 mmol) was added under nitrogen atmosphere in three portions (33%, 33% and 34%). The reaction temperature is allowed to return to 25-35° C. after adding of each portion of IPDI. After the complete addition of IPDI the reaction mixture is held at 70° C. for additional 2 hour. The resulting mixture was cooled down to ~40° C. and transferred to laboratory glass bottle. The catalyst composition is a homogeneous and stable mixture at room temperature.

### Comparative Example 1 [Copper Free Catalyst]

To 94.45 g (709 mmol) of 2-[2-(dimethylamino)ethoxy]ethanol under nitrogen atmosphere and vigorous stirring 54.00 g (234 mmol) isophorone diisocyanate (IPDI) was added in three portions (33%, 33% and 34%) keeping the temperature below 70° C. The reaction temperature is allowed to return to 25-35° C. after adding of each portion of IPDI. After the complete addition of IPDI the reaction mixture is held at 70° C. for additional 2 hours. The resulting mixture was cooled down to ~40° C. and transferred to laboratory glass bottle. The catalyst composition is a homogeneous and stable mixture at room temperature.

### Example 2 [Catalyst Mixtures Containing Salicylic Acid and Copper (II)]

The reaction was carried out as described in the previous Example 1. After the complete addition of IPDI, the reaction mixture is held at 70° C. for additional 2 hour. Next, salicylic acid is added at 70° C. and the mixture is kept at 70° C. for additional 2 hours. The resulting mixture is cooled down to ~40° C. and transferred to laboratory glass bottle. The catalyst composition is a homogeneous and stable mixture at room temperature.

### Comparative Example 2 [Catalyst Mixtures Containing Salicylic Acid]

The reaction was carried out as described in the previous Comparative Example 1. After the complete addition of IPDI, the reaction mixture is held at 70° C. for additional 2 hour. Next, salicylic acid is added at 70° C. and the mixture is kept at 70° C. for additional 2 hours. The resulting mixture is cooled down to ~40° C. and transferred to laboratory glass bottle. The catalyst composition is a homogeneous and stable mixture at room temperature.

Table 1 summarizes the previous examples.

TABLE 1

Examples 1, 2 and Comparative Examples 1, 2

| | | | | |
|---|---|---|---|---|
| Examples | 1 | CEx 1 | 2 | CEx 2 |
| 2-[2-(dimethylamino)ethoxy]ethanol in gram | 114.84 | 94.45 | 114.84 | 94.45 |
| copper(II) acetate monohydrate in gram | 5.16 | - | - | - |
| IPDI in gram | 65.67 | 54 | 65.67 | 54 |
| salicylic acid in gram | - | | 1.74 | 1.43 |

The catalyst compositions of Examples 1 and 2 and Comparative Examples 1 and 2 were evaluated in the manufacture of PU foams (0.8 parts per weight or pbw.) as shown in Table 2 below.

### Examples 3, 4 and Comparative Examples 3, 4 (Polyurethane Foams)

The polyurethane foams were prepared according to the following procedure. A premix of a reactive polyether polyol (Hyperlite® 1629; hydroxyl number of 29.5 - 33.5 mg KOH/g), a reactive polyether polyol modified with a styrene-acrylonitrile polymer (Hyperlite® 1639; hydroxyl number of 16.5 - 20.5 mg KOH/g), EO-rich cell opener (Voranol™ CP 1421; hydroxyl number of 33 mg KOH/g), 90 wt-% aqueous solution of diethanolamine (DEOA 90 wt-% in water), silicone stabilizer (Niax® L-3640), strong blowing catalyst Niax Catalyst EF-100 and water was prepared according to the Table 2 (in weight parts) by mixing thoroughly in a plastic bucket for 20 minutes using propeller stirrer with ring at 1500 rpm. From the premix, 4 batches each of 399.86 g were weighed to an appropriate mixing plastic container and corresponding catalysts compositions (Examples 1 and 2, Comparative examples 1 and 2) were correspondingly added to obtain 4 polyol blends (Table 2). The polyol blend was mixed thoroughly in the plastic container for 30 seconds using propeller stirrer with ring at 3000 rpm. 164.4 g Scuranate T80 isocyanate (TDI, with NCO content of 48.1%) was added and the reactive mixture was mixed for 4-6 seconds. The reactive mixture was immediately poured into a 30×30×10 cm aluminum mold and the mold was immediately closed and clamped. The mold lid had 4 vent openings with a diameter of 0.4 mm at the four corners. The mold temperature was controlled at 65° C. via a hot water circulating thermostat. Release agent Chem-Trend® PU-1705M was used to coat the mold. Foams were demolded after 4 minutes. The processing and physical characteristics of the foam were evaluated as follows:

TABLE 2

Preparation and evaluation of polyurethane foams (Examples 3, 4 and Comparative Examples 3, 4)

| | |
|---|---|
| Physical Characteristic | Test Method |
| Density | ASTM D 3574 -05 |
| Exit Time | Exit time is the time elapsed, in seconds, from the addition of the isocyanate to the reaction mixture to the first appearance of foam extrusion from the four vents of the mold. |
| Force-to-Crush FTC, N | ASTM 3574-05. Force-to-crush (FTC) is the peak force required to deflect a foam pad with the standard 323 cm² (50 sq. in.) indentor, 1 minute after demold, to 50% of its original thickness. It is measured with a load-testing machine using the same setup as that used for measuring foam hardness. A load tester crosshead speed of 50.8 cm/minute is used. The FTC value is a good relative measure of the degree of cell openness characteristic of a foam, i.e., the lower the value, the more open the foam. |
| Hot ILD | ASTM 3574-05. The indentation load deflection (hot ILD) is measured on the same pad used for the FTC measurement 3 minutes after demold. Following the FTC measurement, the foam pad is completely crushed by a mechanical crusher before the measurement of ILD at 50% compression is taken. The hot ILD value is a good relative measure of the curing degree of a foam 3 minutes after demold. The higher the hot ILD value, the higher the curing degree of the foam. |
| ILD | ASTM 3574-05. The indentation load deflection (ILD) is measured on the same pad used for the FTC and hot ILD measurements at least 48 hours after demold. Following the FTC and hot ILD measurements, the foam pad is completely crushed by a mechanical crusher before the measurement of ILD at 50% compression is taken. The ILD value is a good relative measure of the curing degree of a foam at least 48 hours after demold. The higher the ILD value, the higher the curing degree of the foam. |

| Examples | 3 | CEx3 | 4 | CEx 4 |
|---|---|---|---|---|
| Hyperlite® 1629 | 80.00 | | | |
| Hyperlite® 1639 | 20.00 | | | |
| Voranol™ CP 1421 | 1.00 | | | |
| DEOA (90 wt-% in water) | 0.88 | | | |
| Water added | 3.75 | | | |
| Niax Silicone L-3640 | 0.80 | | | |
| Niax Catalyst EF-100 | 0.20 | | | |
| Catalyst composition of Example 1 | 0.80 | | | |
| Catalyst composition of Comparative Example 1 | | 0.80 | | |
| Catalyst composition of Example 2 | | | 0.80 | |
| Catalyst composition of Comparative Example 2 | | | | 0.80 |
| TDI Scuranate T80 | 43.8 | 43.8 | 43.8 | 43.8 |
| Processing and physical characteristics | | | | |
| Isocyanate Index | 100 | 100 | 100 | 100 |
| Exit time, sec | 25 | 22 | 27 | 22 |
| FTC, N | 649 | 387 | 522 | 370 |
| Hot ILD, N | 313 | 263 | 314 | 282 |
| ILD, N | 672 | 402 | 583 | 404 |
| Density, kg/m3 | 49 | 49 | 49 | 48 |

Assessment of the catalytic performance of copper-based catalysts composition is performed by comparison of processing and physical characteristics, the hot ILD and ILD values, in particularly. Hot ILD values represent the load-bearing ability of the cellular material after demolding and crushing the foam to open cells. The higher the value, the firmer, the tighter and the better cured is the foam after demolding and crushing to open cells. As is evident from the Table 2 polyurethane foams prepared with the inventive catalyst compositions of Examples 1 and 2, which are based on copper(II), show significantly higher Force to crush (FTC), hot ILD and ILD compared to Comparative Examples 1 and 2 which do not use the inventive catalyst composition. For instance, the hot ILD of polyurethane foam from the Example 3 is 313 N whereas the Comparative Example 3 is only 263 N. Similarly, the hot ILD of Example 4 is 314 N whereas the Comparative Example 4 is only 282 N. It is noteworthy that also ILD values of polyurethane foams from Example 3 and Example 4, 672 N and 583 N respectively, are significantly higher compared to Comparative Example 3 and Comparative Example 4, 402 and 404 N correspondingly. Thus, the beneficially higher hot ILD and ILD values of polyurethane foams Example 3 and Example 4 were surprisingly achieved by using copper-based compositions Example 1 and Example 2. Improved catalytic performance of copper-based compositions can beneficially reduce the demolding time leading to faster production cycles resulting to higher productivity.

### Example 5 and Comparative Examples 5 to 8

As described in Examples 3, 4 and Comparative Examples 3, 4 above new polyurethane foams were made (Ex 5 and CEx 6 to 8) and their processing and physical characteristics were evaluated as shown in Table 3.

TABLE 3

| Examples | CEx 5 | Ex 5 | CEx 6 | CEx 7 | CEx 8 |
|---|---|---|---|---|---|
| Hyperlite® 1629 | 80.00 | | | | |
| Hyperlite® 1639 | 20.00 | | | | |
| Voranol™ CP 1421 | 1.00 | | | | |
| DEOA (90 wt-% in water) | 0.88 | | | | |
| Water added | 3.75 | | | | |
| Niax Silicone L-3640 | 0.80 | | | | |
| Niax Catalyst EF-100 | 0.20 | | | | |
| Catalyst composition of Comparative Example 1 | 0.80 | | | | |
| Catalyst composition of Example 1 | | 0.80 | | | |
| Cu(OAc)₂*H₂O | | | 0.02 | 0.22 | 2.22 |
| TDI Sucranate T80 | 43.9 | 43.9 | 43.9 | 43.9 | 43.9 |
| Processing and physical characteristics of PU foams | | | | | |
| Isocyanate Index | 100 | 100 | 100 | 100 | 100 |
| Exit time, sec | 25 | 26 | Collapse | | |
| FTC, N | 409 | 765 | | | |
| hot ILD, N | 198 | 257 | | | |
| ILD, N | 298 | 388 | | | |
| Density, kg/m3 | 42 | 43 | | | |

As is evident from the Table 3, in contrast to Comparative Catalyst Example 1 (Comparative Example 5) the inventive catalyst composition of Example 1 (Example 5) provided polyurethane foams with significantly higher Force to crush, hot ILD and ILD values. Comparative Examples 6 to 8, using only copper(II)-acetate monohydrate in varying amounts, introduced via premixing with the added water directly, show that without the amino carbamate co-catalyst copper(II) acetate does not perform in water blown polyurethane systems. Particularly, even in higher concentrations copper(II) acetate does not perform in water blown polyurethane systems (Comparative Examples 7 and 8).

### Example 6 and Comparative Example 9; Example 7 and Comparative Example 10 (Evaluation of the Storage Stability of Formulated Polyol Blends Comprising the catalyst Composition of the Invention)

The time a formulated polyol system can be stored in storage tanks without losing any of its properties is known as shelf life. The impact of the copper-based catalyst on the shelf life of a formulated polyol system is described by experiments of Table 4. Triple measurements were made for each example and the results were averaged. A premix of a reactive polyether polyol (Hyperlite® 1629), a reactive polyether polyol modified with a styrene-acrylonitrile polymer (Hyperlite® 1639), EO-rich cell opener (Voranol™ CP 1421), 90 wt-% aqueous solution of diethanolamine, silicone stabilizer (Niax® L-3640), Niax Catalyst EF-100 and water was prepared according to the Table 4 (in weight parts) by mixing thoroughly in a plastic bucket for 20 minutes using propeller stirrer with ring at 1500 rpm. From the premix, 12 batches each of 352.95 g were weighed to an appropriate mixing plastic container. Corresponding catalyst compositions of Examples 1 and Comparative Example 1 were correspondingly added to six batches of each and the mixtures were subsequently mixed thoroughly in the plastic container for 30 seconds using propeller stirrer with ring at 3000 rpm to obtain formulated polyol systems. For triple measurements three charges of the freshly prepared formulated polyol system for each catalyst composition of Example 1 (Ex 6) and Comparative Example 1 (CEx 9) were immediately used to prepare polyurethane foam pads. The other six batches of formulated polyol systems (three batches with each catalyst composition of Example 1 and Comparative Example 1) were hermetically closed with caps and stored at ~20-23° C. for 7 days. After 7 days of storage the batches were used to prepare polyurethane foam pads.

The manufacture of polyurethane foams from freshly prepared or stored formulated polyol blends was done in the same manner. The caps were removed from the plastic container, the formulated polyol system was mixed thoroughly in the plastic container for 30 seconds using propeller stirrer with ring at 3000 rpm. 145.7 g Scuranate T80 isocyanate (TDI, with NCO content of 48.1%) was added and the reactive mixture was mixed for 4-6 seconds. The reactive mixture was poured into a 30×30×10 cm aluminum mold and the mold was immediately closed and clamped. The mold lid had 4 vent openings with a diameter of 0.4 mm at the four corners. The mold temperature was controlled at 65° C. via a hot water circulating thermostat. Release agent Chem-Trend® PU-1705M was used to coat the mold. Foams were demolded after 4 minutes.

TABLE 4

Storage stability of the catalyst composition in polyol blend (1,4 pbw) - 7 days (triple measurements)

| Examples | CEx 9 | Ex 6 |
|---|---|---|
| Hyperlite® 1629 | 80.00 | |
| Hyperlite® 1639 | 20.00 | |
| Voranol™ CP 1421 | 1.00 | |
| DEOA (90 wt-% in water) | 0.88 | |
| Water added | 3.75 | |
| Niax Silicone L-3640 | 0.80 | |
| Niax Catalyst EF-100 | 0.20 | |
| Catalyst composition of Comparative Example 1 | 1.40 | |
| Catalyst composition of Example 1 | | 1.40 |
| TDI Scuranate T80 | 44.0 | 44.0 |
| Processing and physical characteristics of PU foams | | |
| Isocyanate Index | 100 | 100 |
| Exit time, sec | 24 (24) | 20 (20) |
| FTC, N | 578 (753) | 681 (781) |
| hot ILD, N | 229 (236) | 289 (297) |
| ILD, N | 371 (386) | 472 (454) |
| Density, kg/m3 | 44 (44) | 44 (44) |

As shown above and as in the previous examples in comparison to the catalyst composition Comparative Example 1, the inventive catalyst composition according to Example 1 provides significantly higher FTC, hot ILD, and ILD values, which confirms the beneficial catalytic effect of the catalyst composition. Moreover, the significantly improved catalytic performance of the inventive Catalyst composition according to Example 1 remains unchanged after storing the formulated polyol blends for 7 days (Table 4, see the values presented in brackets). The registered negligible differences of the values of hot ILD and ILD are negligible and can be ignored.

As described in the procedure of Example 6 and Comparative Example 9 above new polyurethane foams were formed and evaluated additionally at different catalyst loadings and for longer storage time as shown in the Table 5. Triple measurements were made for each example and the results were averaged. In brackets the values are given for the polyurethane foams that were obtained after a storage of the formulated polyol blends in hermetically closed plastic cups at ~20-23° C. for 11 days.

TABLE 5

Storage stability of the catalyst composition in formulated polyol blend - 11 days (triple measurements)

| Examples | CEx 10 | Ex 7 |
|---|---|---|
| Hyperlite® 1629 | 80.00 | |
| Hyperlite® 1639 | 20.00 | |
| Voranol™ CP 1421 | 1.00 | |
| DEOA (90% in water) | 0.88 | |
| Water | 3.75 | |
| Niax Silicone L-3640 | 0.80 | |
| Niax Catalyst EF-100 | 0.20 | |
| Catalyst composition of Comparative Example 1 | 1.40 | |
| Catalyst composition of Example 1 | | 0.80 |
| TDI Sucranate T80 | 44.0 | 44.0 |
| Processing and physical characteristics of PU foams | | |
| Isocyanate Index | 100 | 100 |
| Exit time, sec | 24 (24) | 30 (32) |
| FTC, N | 758 (646) | 616 (622) |
| hot ILD, N | 215 (224) | 234 (238) |
| ILD, N | 376 (378) | 497 (483) |
| Density, kg/m3 | 44 (44) | 44 (44) |

As in the previous examples also above in Table 5 in comparison to the catalyst composition Comparative Example 1, the inventive catalyst composition according to Example 1 provides higher FTC, hot ILD, and ILD values. This confirms the beneficial higher catalytic effect of the catalyst composition of the Example 1. In addition, the catalytic performance of the inventive Catalyst composition according to Example 1 remains unchanged after storing the corresponding formulated polyol blends for 11 days (Table 5, see the values in presented in brackets). The registered negligible differences of the values of hot ILD and ILD are negligible and can be ignored. Moreover, it is shown that by using even lower catalyst loading (0.80 pbw) the inventive catalyst composition of Example 1 provided higher hot ILD and ILD values than at higher catalyst loading (1.40 pbw) of Comparative Example 1. Furthermore, 0.80 pbw of the inventive catalyst composition provided higher ILDs which highlights its postmolding efficiency (for Example 1 and Example 2).

### Examples 8, 9

Copper(II) 2-ethylhexanoate was purchased from Sigma-Aldrich. Following the procedure of Example 1 catalyst compositions using copper(II) 2-ethylhexanoate were prepared as shown in Table 6. In particularly, in Example 8 the molar concentration of copper(II) 2-ethylhexanoate is in the same range as the molar concentration of copper(II) acetate in Example 1. Noteworthy the concentration of copper(II) in Example 2 is significantly increased. Both catalyst compositions are homogeneous and stable mixture at room temperature.

TABLE 6

Manufacture of a catalyst composition using copper(ll)-ethylhexanoate

| | | |
|---|---|---|
| Examples | 8 | 9 |
| 2-[2-(dimethylamino)ethoxy]ethanol in gram | 120.00 | 120.00 |
| 2-[2-(dimethylamino)ethoxy]ethanol in mmol | 901 | 901 |
| IPDI in gram | 68.61 | 68.61 |
| Cu(2-ethylhexanote)₂ in g | 9.79 | 21.30 |

It was confirmed that the use of copper(II)-ethylhexanoate enables to increase copper (II) loading in the catalyst compositions of the invention.

### Examples 10 and 11

As described in Example 6 and Comparative Example 9 above, polyurethane foams corresponding to compositions of Examples 8 and 9 were made and evaluated as shown in Table 9. Double measurements were made for each example and the results were averaged. In brackets the values are given for the polyurethane foams that were obtained after a storage of the formulated polyol blends at ~ 20 - 23° C. for 6 days.

TABLE 9

Comparison of the impact of copper (II) salts kind on catalytic performance and the shelf life of formulated polyol blends after 6 days of storage.

| Examples | 10 | 11 |
|---|---|---|
| Hyperlite® 1629 | 80.00 | |
| Hyperlite® 1639 | 20.00 | |
| Voranol™ CP 1421 | 1.00 | |
| DEOA (90% wt-in water) | 0.88 | |
| Water added | 3.75 | |
| Niax Silicone L-3640 | 0.80 | |
| Niax Catalyst EF-100 | 0.20 | |
| Catalyst composition of Example 8 | 0.60 | |
| Catalyst composition of Example 1 | | 0.60 |
| TDI Sucranate T80 | 43.9 | |
| Processing and physical characteristics | | |
| Isocyanate Index | 100 | |
| Exit time, sec | 29 (34) | 28 (30) |
| FTC, N | 589 (600) | 506 (541) |
| hot ILD, N | 250 (240) | 246 (235) |
| ILD, N | 526 (523) | 534 (523) |
| Density, kg/m3 | 45 (44) | 45 (45) |

Considering the fact that in catalyst composition of Example 8 the molar concentration of copper(II) 2-ethylhexanoate is in the same range as the molar concentration of copper(II) acetate in Example 1, Table 9 (Examples 10 and 11) highlights that the inventive catalyst compositions are providing comparable hot ILD, and ILD values. In addition, the catalytic performance of the inventive catalyst compositions according to Example 1 and Example 8 remain unchanged after storing the formulated polyol blends for 6 days at ~ 20 - 23° C. (Table 9, see the values presented in brackets).

### Comparative Examples 13 to 15

Following the procedure of Example 1 catalyst compositions using Zinc(2-ethylhexanoate)₂, Ziconium(2-ethylhexanoate)₄ and Bismuth(neodecanoate)₃ were prepared as shown in Table 10.

TABLE 10

Comparative catalyst compositions based on Zinc(2-ethylhexanoate)₂ or Zn(EH)₂, Zirconium(2-ethylhexanoate)₄or Zr(EH)₄ and Bismuth(neodecanoate)₃ or Bi(ND)₃

| Comparative Examples | Added inorganic salt | IPDI (in g) | 2-[2-(dimethylamino)ethoxy]ethanol in gram | Zn(EH)₂ in g | Bi(ND)₃ in g | Zr(EH)₄ in g |
|---|---|---|---|---|---|---|
| 13 | Zinc(2-ethylhexanoate)₂ | 65.69 | 114.84 | 5.16 | | |
| 14 | Bismuth(neodecanoate)₃ | 65.69 | 114.84 | | 5.16 | |
| 15 | Zirconium(2-ethylhexanoate)₄ | 65.69 | 114.84 | | | 5.16 |

Following the procedure of Example 3, it was impossible either to get homogeneous clear catalyst compositions or to get higher hot ILD or ILD values when making foams using the Zr-, Zn- or Bi based catalyst compositions of comparative examples 13, 14, 15.

1. A composition, comprising at least one Cu(II)-salt, at least one compound which is obtainable by reacting at least one isocyanate compound and at least one isocyanate-reactive compound having at least one tertiary amino group, and optionally one or more diluents.

2. The composition according to claim 1, comprising a compound obtainable by reacting the at least one isocyanate compound and the at least one isocyanate-reactive compound having at least one tertiary amino group in the presence of at least one Cu(II)-salt and optionally in the presence of one or more diluents.

3. The composition according to claim 1, comprising a compound obtainable by reacting at the least one polyisocyanate compound, the at least one isocyanate-reactive compound having at least one tertiary amino group, and at least one isocyanate-reactive compound which does not have a tertiary amino group in the presence of at least one Cu(II)-salt and optionally in the presence of one or more diluents.

4. The composition according to claim 1 , comprising a compound, comprising at least one carbamate (urethane) and/or urea group and at least one tertiary amino group, at least one Cu(II)-salt and optionally one or more diluents.

5. The composition according to claim 1, wherein the at least one isocyanate compound is selected from the group consisting of polyisocyanates and monoisocyanates, such as octadecylisocyanate; octylisocyanate; butyl and t-butylisocyanate; cyclohexyl isocyanate; adamantyl isocyanate; ethylisocyanatoacetate; ethoxycarbonylisocyanate; phenylisocyanate; alphamethylbenzyl isocyanate; 2-phenylcyclopropyl isocyanate; 2-ethylphenylisocyanate; benzylisocyanate; meta and para-tolylisocyanate; 2-, 3-, or 4-nitrophenylisocyanates; 2-ethoxyphenyl isocyanate; 3-methoxyphenyl isocyanate; 4-methoxyphenyl isocyanate; ethyl 4-isocyanatobenzoate; 2,6-dimethylphenylisocyanate; 1-naphythylisocyanate; (naphthyl) ethylisocyanates; isophorone diisocyanate (IPDI); toluene diisocyanate (TDI); diphenylmethane-2,4′-diisocyanate (2,4′-MDI); diphenylmethane-4,4′-diisocyanate (4,4′-MDI); hydrogenated diphenylmethane-4,4′-diisocyanate (H.12 MDI); tetra-methyl xylene diisocyanate (TMXDI); hexamethylene-1,6-diisocyanate (HDI); napthylene-1,5-diisocyanate; 3,3′-dimethoxy-4,4′-biphenyldiisocyanate; 3,3′-dimethyl-4,4′-bimethyl-4,4′-biphenyldiisocyanate; phenylene diisocyanate; 4,4′-biphenyldiisocyanate; trimethylhexamethylene diisocyanate; 4,4′-methylene-bis (2,6-diethylphenyl isocyanate); 1,12-diisocyanatododecane; 1,5-diisocyanato-2-methylpentane; 1,4-diisocyanatobutane; and cyclohexylene diisocyanate and its isomers; uretidione dimers of HDI; trimethylolpropane trimer of TDI, isocyanurate trimers of TDI, HDI, IPDI; biuret trimers of TDI, HDI, or IPDI; and polyisocyanates as mentioned before, where the isocyanate groups are partially reacted with at least one isocyanate-reactive compound which does not have a tertiary amino group selected from OH—, NH—, and NH₂-functional optionally substituted hydrocarbons, which may contain one or more heteroatoms, such as.

6. The composition according to claim 1, wherein the at least one isocyanate compound is selected from polyisocyanates.

7. The composition according claim 1, wherein the at least one isocyanate compound is isophorone diisocyanate (IPDI).

8. The composition according to claim 1, wherein the at least one isocyanate-reactive compound having at least one tertiary amino group is selected from the group consisting of alcohols having at least one tertiary amino group, and amines having at least one tertiary amino group and at least one additional amino group selected from primary and secondary amino groups.

9. The composition according to claim 8, wherein the at least one isocyanate-reactive compound comprises at least one ether group (—O—), and the isocyanate-reactive compound is selected from the group consisting of aliphatic alcohols having at least one hydroxyl group, at least one tertiary amino group and optionally at least one ether group.

10. The composition according to claim 1, wherein the at least one isocyanate-reactive compound having at least one tertiary amino group is selected from the group consisting of: 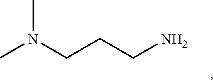 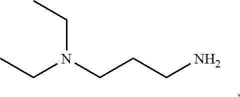 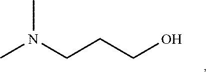 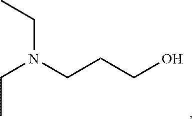 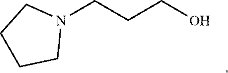 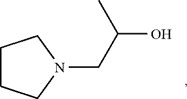 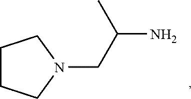 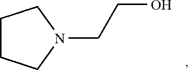 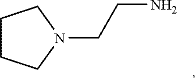 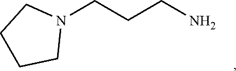 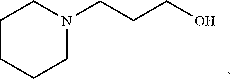 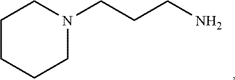 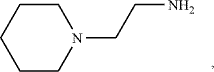 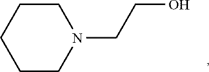 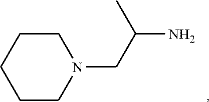 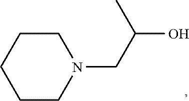 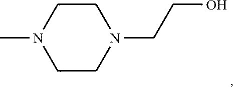 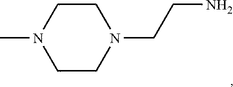 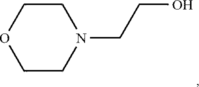 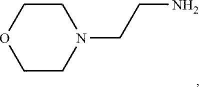 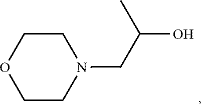 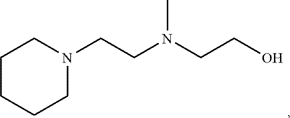 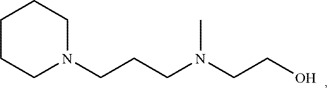 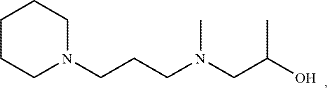 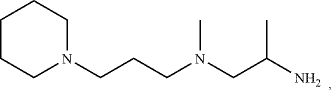 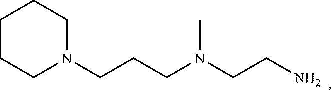 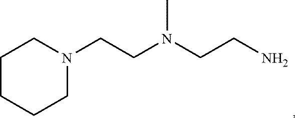 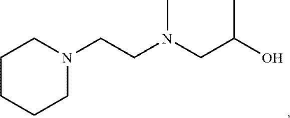 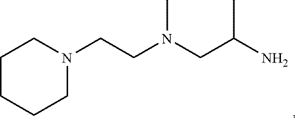 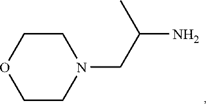 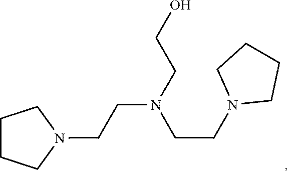 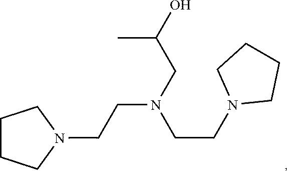 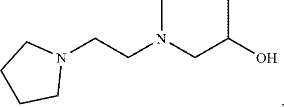 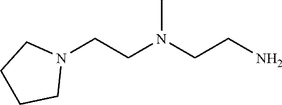 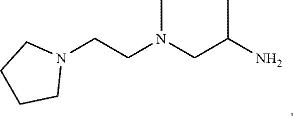 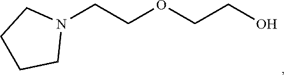 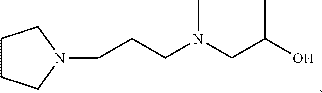 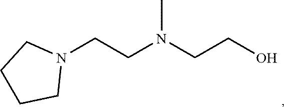 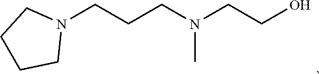 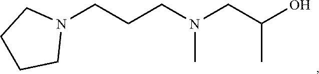 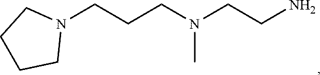 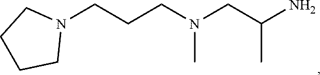 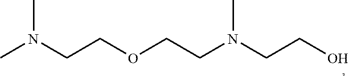 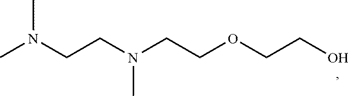 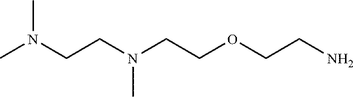 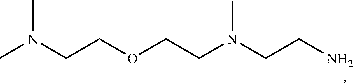 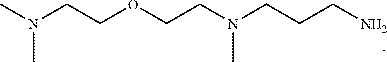 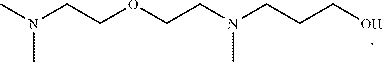 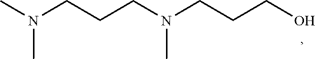 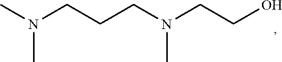 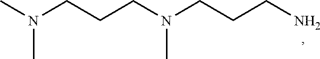 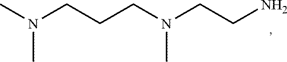 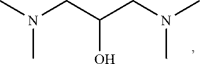 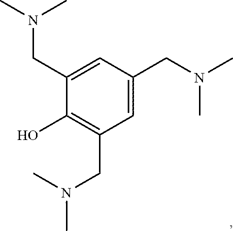 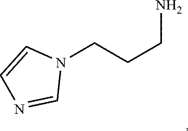 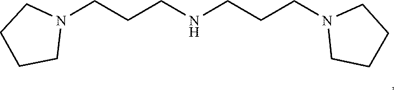 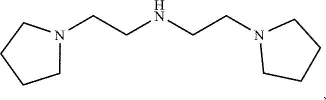 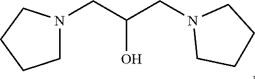 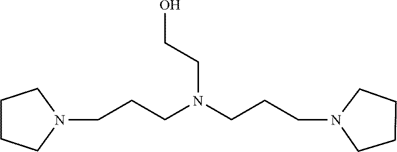 [SMILES: OCCN(CCCN1CCCC1)CCCN1CCCC1]
, and 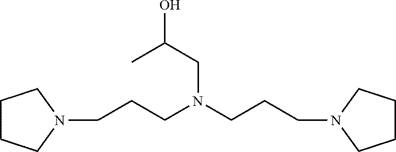 [SMILES: CC(O)CN(CCCN1CCCC1)CCCN1CCCC1]
and bicyclic tertiary amines, such as 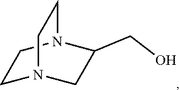 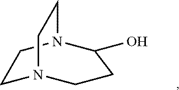 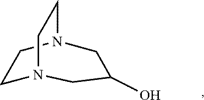 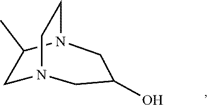 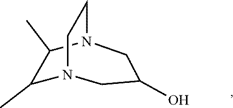 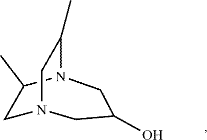 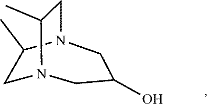 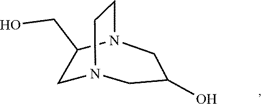 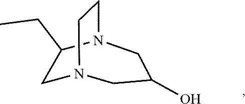 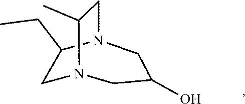 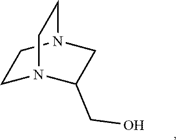 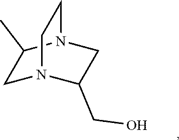 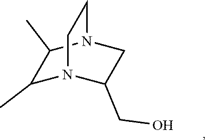 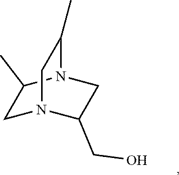 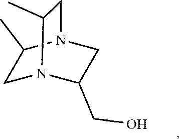 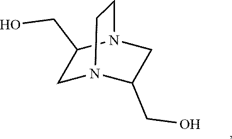 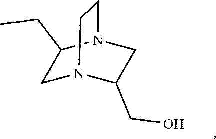
, and 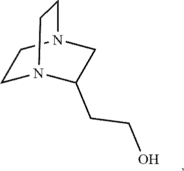 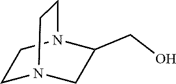
, and 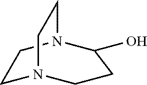
or mixtures thereof.

11. The composition according to claim 1, wherein the at least one compound is selected from:
C1 the reaction product of 1-[bis[3-(dimethylamino)propyl]amino]-2-propanol and isophorone diisocyanate (IPDI), hexamethylene diisocyanate (HDI), and derivatives derived from IPDI and/or HDI such as biurets, isocyanurates, allophanates, and oligomers thereof,
C2 the reaction product of 2-[2-(dimethylamino)ethoxy]ethanol and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof,
C3 the reaction product of 2-{[2-(dimethylamino)ethyl]methylamino}ethanol and isophorone diisocyanate, (IPDI), hexamethylene diisocyanate (HDI), and derivatives derived from IPDI and/or HDI such as biurets, isocyanurates, allophanates, and oligomers thereof,
C4 the reaction product of 3,3′-iminobis(N,N-dimethylpropylamine) and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof,
C5 the reaction product of dimethylaminoethanol and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof,
C6 The reaction product of diethylaminoethanol and 1,3-bis(1-isocyanato-1-methylethyl)benzene, isophorone diisocyanate (IPDI), hexamethylene diisocyanate (HDI), and derivatives derived from IPDI and/or HDI such as biurets, isocyanurates, allophanates, and oligomers thereof,
C7 the reaction product of 3-(dimethylamino)-1-propylamine and isophorone diisocyanate (IPDI), hexamethylene diisocyanate (HDI), and derivatives derived from IPDI and/or HDI such as biurets, isocyanurates, allophanates, and oligomers thereof,
C8 the reaction product of 3-(diethylamino)-1-propylamine and isophorone diisocyanate (IPDI), hexamethylene diisocyanate (HDI), and derivatives derived from IPDI and/or HDI such as biurets, isocyanurates, allophanates, and oligomers thereof,
C9 the reaction product of 3-(diethylamino)-1-propanol and isophorone diisocyanate (IPDI), hexamethylene diisocyanate (HDI), and derivatives derived from IPDI and/or HDI such as biurets, isocyanurates, allophanates, and oligomers thereof,
C10 the reaction product of 1-(3-hydroxypropyl)pyrrolidine and isophorone diisocyanate (IPDI), hexamethylene diisocyanate (HDI), and derivatives derived from IPDI and/or HDI such as biurets, isocyanurates, allophanates, and oligomers thereof,
C11 the reaction product of 1-(2-hydroxyethyl)pyrrolidine and isophorone diisocyanate(IPDI), hexamethylene diisocyanate (HDI), and derivatives derived from IPDI and/or HDI such as biurets, isocyanurates, allophanates, and oligomers thereof,
C12 the reaction product of 1-(2-hydroxyethyl)piperidine and isophorone diisocyanate (IPDI), hexamethylene diisocyanate (HDI), and derivatives derived from IPDI and/or HDI such as biurets, isocyanurates, allophanates, and oligomers thereof,
C13 the reaction product of 1-(3-hydroxypropyl)piperidine and isophorone diisocyanate (IPDI), hexamethylene diisocyanate (HDI), and derivatives derived from IPDI and/or HDI such as biurets, isocyanurates, allophanates, and oligomers thereof,
C14 the reaction product of 1-(2-hydroxypropyl)piperidine and hexamethylene-1,6-diisocyanate(IPDI), hexamethylene diisocyanate (HDI), and derivatives derived from IPDI and/or HDI such as biurets, isocyanurates, allophanates, and oligomers thereof,
C15 the reaction product of 1-(3-aminopropyl)pyrrolidine and isophorone diisocyanate (IPDI), hexamethylene diisocyanate (HDI), and derivatives derived from IPDI and/or HDI such as biurets, isocyanurates, allophanates, and oligomers thereof,
C16 the reaction product of 1-(2-aminoethyl)pyrrolidine and isophorone diisocyanate (IPDI), hexamethylene diisocyanate (HDI), and derivatives derived from IPDI and/or HDI such as biurets, isocyanurates, allophanates, and oligomers thereof,
C17 the reaction product of 1-(3-aminopropyl)piperidine and isophorone diisocyanate (IPDI), hexamethylene diisocyanate (HDI), and derivatives derived from IPDI and/or HDI such as biurets, isocyanurates, allophanates, and oligomers thereof,
C18 the reaction product of 1-(2-aminoethyl)piperidine and isophorone diisocyanate (IPDI), hexamethylene diisocyanate (HDI), and derivatives derived from IPDI and/or HDI such as biurets, isocyanurates, allophanates, and oligomers thereof,
C19 the reaction product of 1-(piperidin-1-yl)propan-2-ol and isophorone diisocyanate (IPDI), hexamethylene diisocyanate (HDI), and derivatives derived from IPDI and/or HDI such as biurets, isocyanurates, allophanates, and oligomers thereof,
C20 the reaction product of 1-(pyrrolidine-1-yl)propan-2-ol and isophorone diisocyanate (IPDI), hexamethylene diisocyanate (HDI), and derivatives derived from IPDI and/or HDI such as biurets, isocyanurates, allophanates, and oligomers thereof,
C21 the reaction product of 1-(1-pyrrolidinyl)-2-propanamine and isophorone diisocyanate (IPDI), hexamethylene diisocyanate (HDI), and derivatives derived from IPDI and/or HDI such as biurets, isocyanurates, allophanates, and oligomers thereof,
C22 the reaction product 1-(piperidin-1-yl)propan-2-amine and isophorone diisocyanate (IPDI), hexamethylene diisocyanate (HDI), and derivatives derived from IPDI and/or HDI such as biurets, isocyanurates, allophanates, and oligomers thereof,
C23 the reaction product of 2-[2-[2-(dimethylamino)ethoxy]ethyl-methylamino]ethanol and isophorone diisocyanate (IPDI), hexamethylene diisocyanate (HDI), and derivatives derived from IPDI and/or HDI such as biurets, isocyanurates, allophanates, and oligomers thereof,
C24 the reaction product of 3-{[3-(dimethylamino)propyl]methylamino}propanol and isophorone diisocyanate (IPDI), hexamethylene diisocyanate (HDI), and derivatives derived from IPDI and/or HDI such as biurets, isocyanurates, allophanates, and oligomers thereof, and
C25 the reaction product of 2-{[3-(dimethylamino)propyl]methylamino}ethanol and isophorone diisocyanate (IPDI), hexamethylene diisocyanate (HDI), and derivatives derived from IPDI and/or HDI such as biurets, isocyanurates, allophanates, and oligomers thereof.

12. The composition according to claim 11,
wherein the at least one compound is selected from: 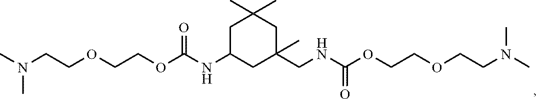
or the HDMI analogue thereof: 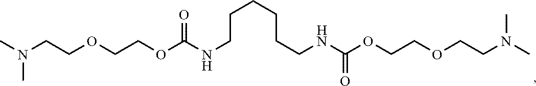 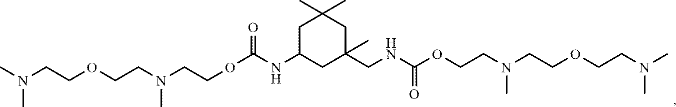
or the HDMI analogue thereof: 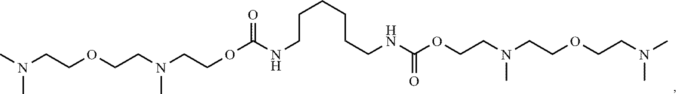 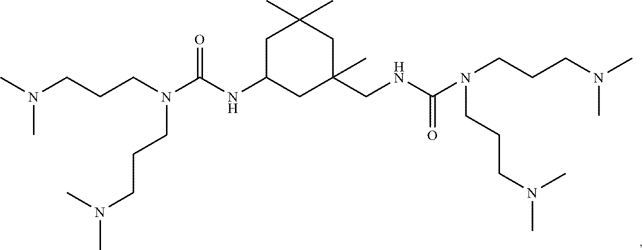
or the HDMI analogue thereof: 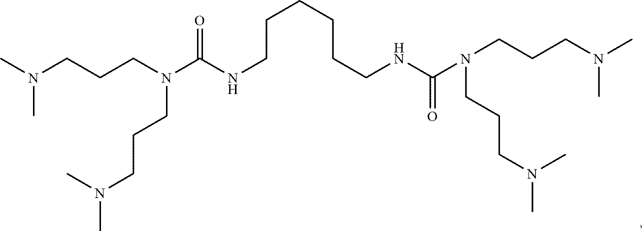 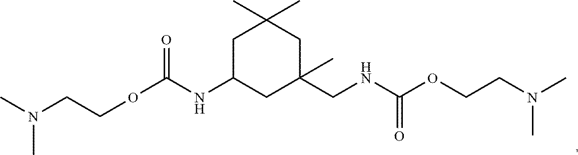
or the HDMI analogue thereof: 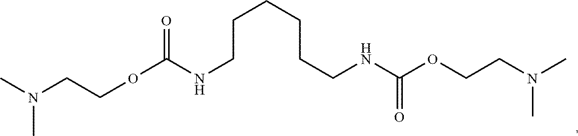 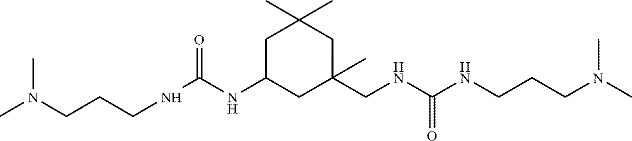
or the HDMI analogue thereof: 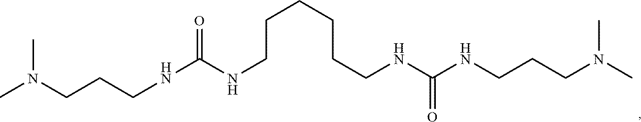 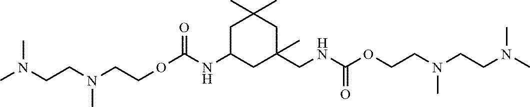
or the HDMI analogue thereof: 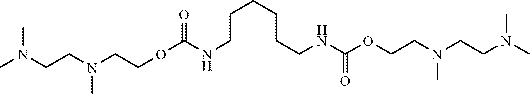 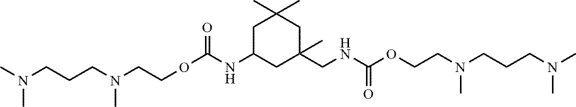
or the HDMI analogue thereof: 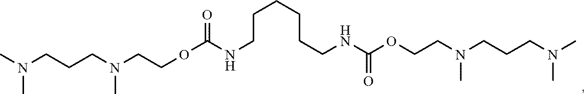 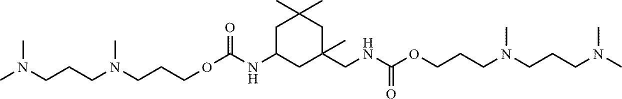
or the HDMI analogue thereof: 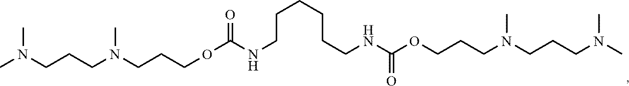 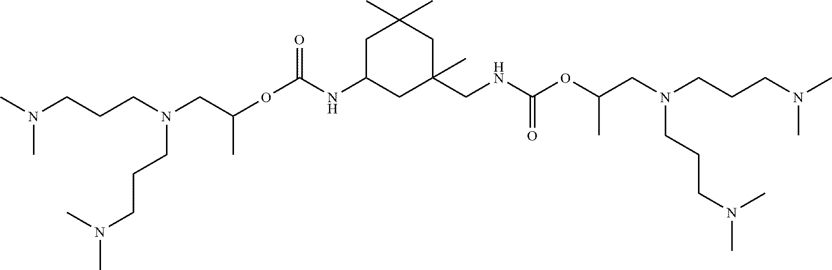
or the HDMI analogue thereof: 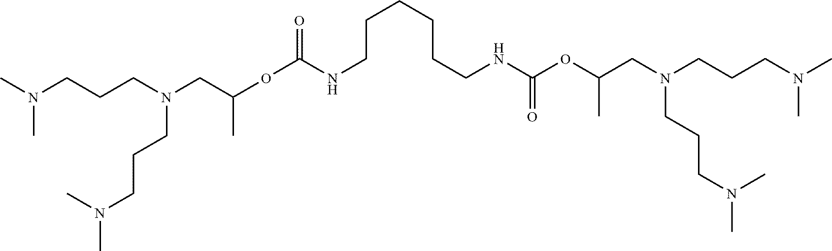 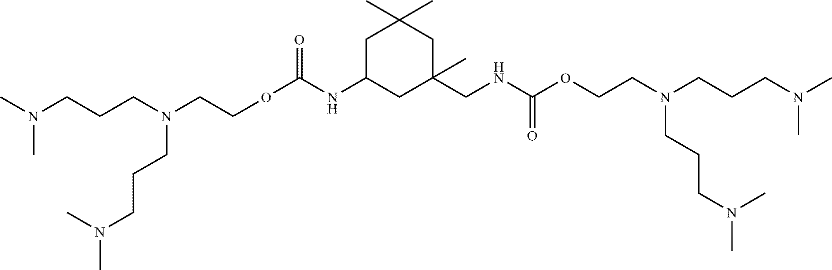
or the HDMI analogue thereof: 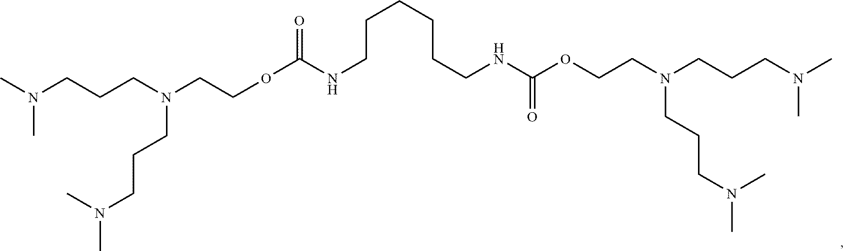 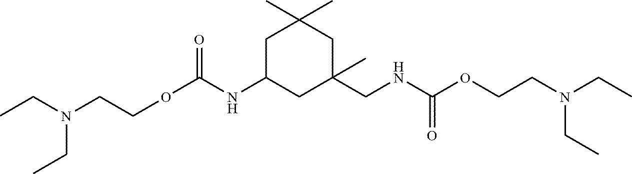 [SMILES: CCN(CC)CCOC(=O)NCC1(C)CC(NC(=O)OCCN(CC)CC)CC(C)(C)C1]
or the HDMI analogue thereof: 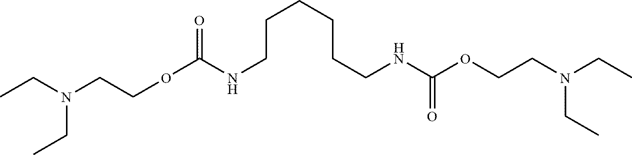 [SMILES: CCN(CC)CCOC(=O)NCCCCCCNC(=O)OCCN(CC)CC] 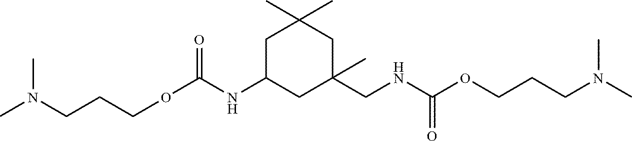
or the HDMI analogue thereof: 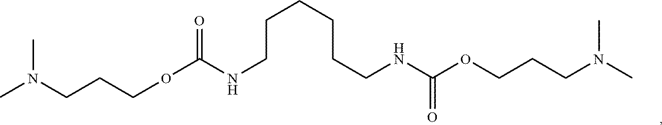 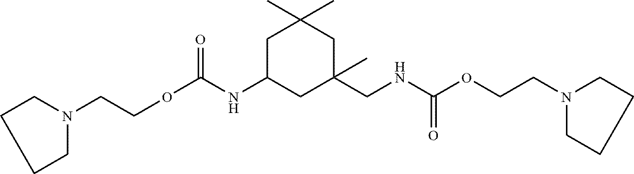 [SMILES: CC1(C)CC(NC(=O)OCCN2CCCC2)CC(C)(CNC(=O)OCCN2CCCC2)C1]
or the HDMI analogue thereof: 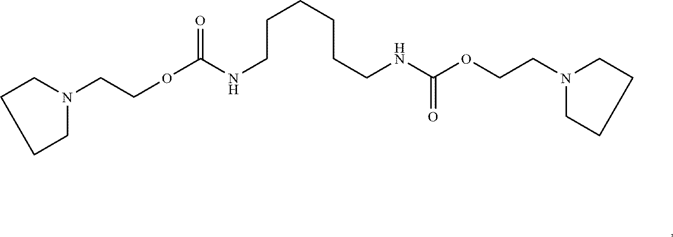 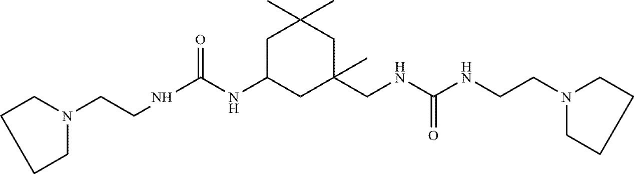 [SMILES: CC1(C)CC(NC(=O)NCCN2CCCC2)CC(C)(CNC(=O)NCCN2CCCC2)C1]
or the HDMI analogue thereof: 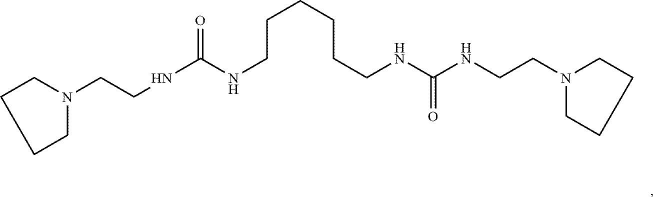 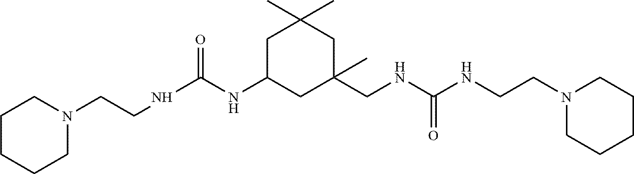 [SMILES: CC1(C)CC(NC(=O)NCCN2CCCCC2)CC(C)(CNC(=O)NCCN2CCCCC2)C1]
or the HDMI analogue thereof: 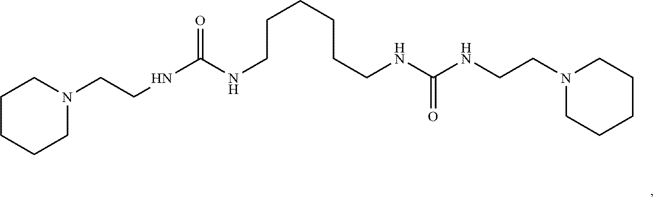 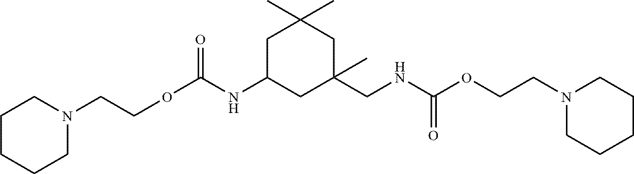 [SMILES: CC1(C)CC(NC(=O)OCCN2CCCCC2)CC(C)(CNC(=O)OCCN2CCCCC2)C1]
or the HDMI analogue thereof: 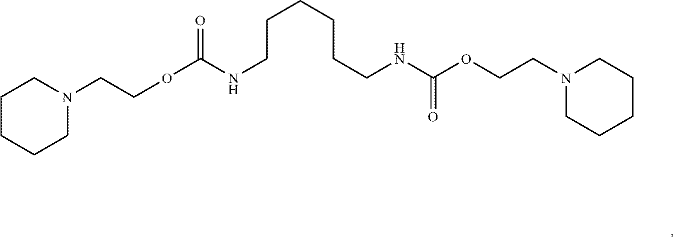 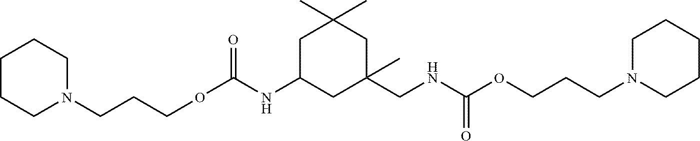 [SMILES: CC1(C)CC(NC(=O)OCCCN2CCCCC2)CC(C)(CNC(=O)OCCCN2CCCCC2)C1]
or the HDMI analogue thereof: 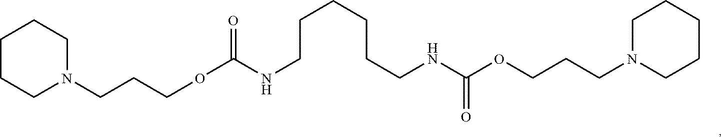 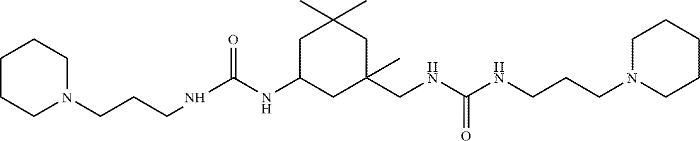 [SMILES: CC1(C)CC(NC(=O)NCCCN2CCCCC2)CC(C)(CNC(=O)NCCCN2CCCCC2)C1]
or
the HDMI analogue thereof: 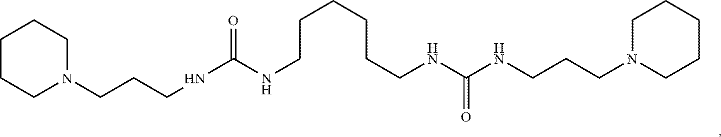 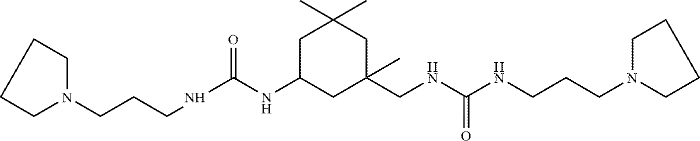 [SMILES: CC1(C)CC(NC(=O)NCCCN2CCCC2)CC(C)(CNC(=O)NCCCN2CCCC2)C1]
or
the HDMI analogue thereof: 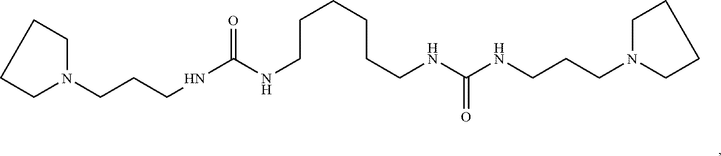 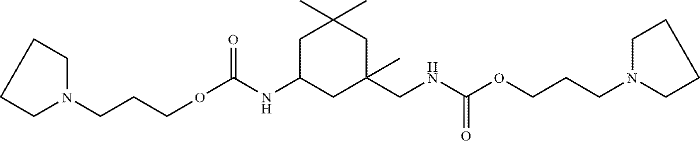 [SMILES: CC1(C)CC(NC(=O)OCCCN2CCCC2)CC(C)(CNC(=O)OCCCN2CCCC2)C1]
or the HDMI analogue thereof: 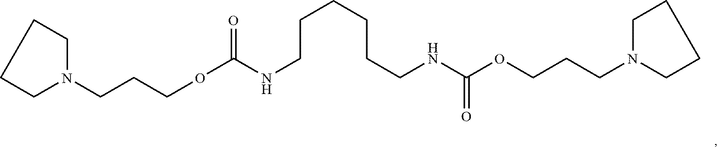 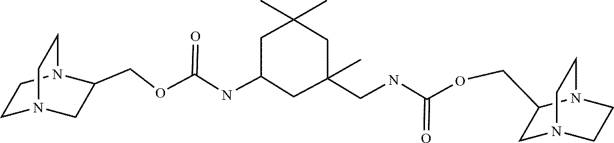 [SMILES: CC1(C)CC(NC(=O)OCC2CN3CCN2CC3)CC(C)(CNC(=O)OCC2CN3CCN2CC3)C1]
or the HDMI analogue thereof: 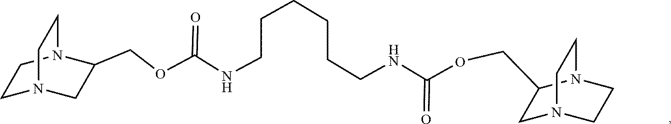 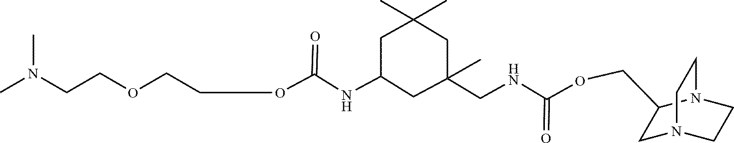 [SMILES: CN(C)CCOCCOC(=O)NC1CC(C)(C)CC(C)(CNC(=O)OCC2CN3CCN2CC3)C1]
or the HDMI analogue thereof: 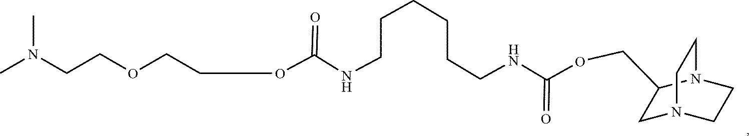 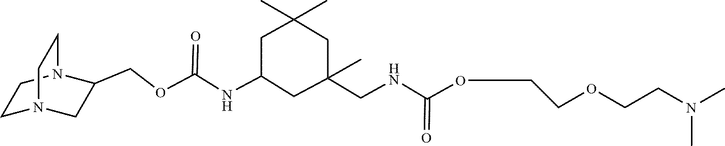 [SMILES: CN(C)CCOCCOC(=O)NCC1(C)CC(NC(=O)OCC2CN3CCN2CC3)CC(C)(C)C1] 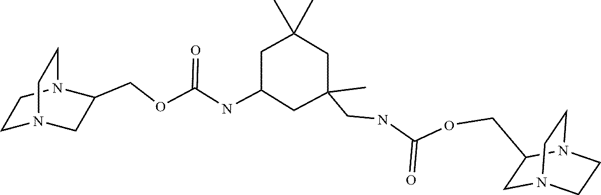 [SMILES: CC1(C)CC(NC(=O)OCC2CN3CCN2CC3)CC(C)(CNC(=O)OCC2CN3CCN2CC3)C1]
or the HDMI analogue thereof: 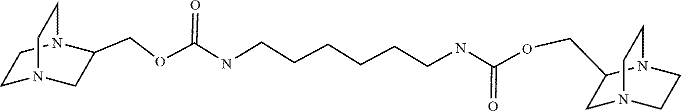 [SMILES: O=C(NCCCCCCNC(=O)OCC1CN2CCN1CC2)OCC1CN2CCN1CC2]
.

13. A compound selected from the group consisting of:
(1) the reaction product of 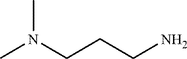
N′,N′-dimethylpropane-1,3-diamine and isophorone diisocyanate,
(2) the reaction product of 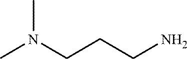
N′,N′-dimethylpropane-1,3-diamine and hexamethylene-1,6-diisocyanate,
(3) the reaction product of 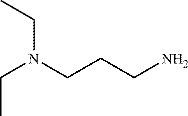
N′,N′-diethylpropane-1,3-diamine and isophorone diisocyanate,
(4) the reaction product of 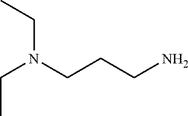
N′,N′-diethylpropane-1 ,3-diamine and hexamethylene-1,6-diisocyanate,
(5) the reaction product of 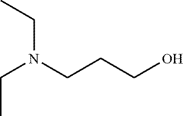
3-(diethylamino)propan-1-ol and isophorone diisocyanate,
(6) the reaction product of 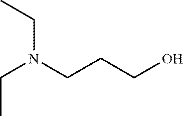
3-(diethylamino)propan-1-ol and hexamethylene-1,6-diisocyanate,
(7) the reaction product of 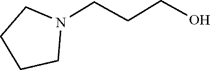
3-pyrrolidin-1-ylpropan-1-ol and isophorone diisocyanate,
(8) the reaction product of 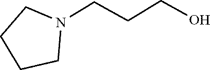
3-pyrrolidin-1-ylpropan-1-ol and hexamethylene-1,6-diisocyanate,
(9) the reaction product of 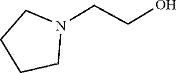
2-pyrrolidin-1-ylethanol and isophorone diisocyanate,
(10) the reaction product of 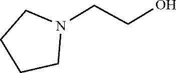
2-pyrrolidin-1-ylethanol and hexamethylene-1,6-diisocyanate,
(11)the reaction product of 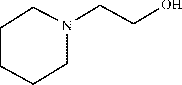
2-(1-piperidyl)ethanol and isophorone diisocyanate,
(12)the reaction product of 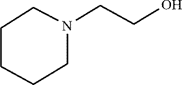
2-(1-piperidyl)ethanol and hexamethylene-1,6-diisocyanate,
(13) the reaction product of 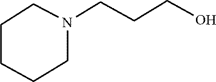
3-(1-piperidyl)propan-1-ol and isophorone diisocyanate,
(14)the reaction product of 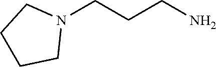
3-pyrrolidin-1-ylpropan-1-amine and isophorone diisocyanate,
(15) the reaction product of 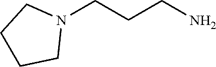
3-pyrrolidin-1-ylpropan-1-amine and hexamethylene-1,6-diisocyanate,
(16) the reaction product of 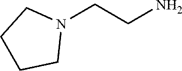
2-pyrrolidin-1-ylethanamine and isophorone diisocyanate,
(17) the reaction product of 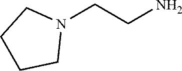
2-pyrrolidin-1-ylethanamine and hexamethylene-1,6-diisocyanate,
(18) the reaction product of 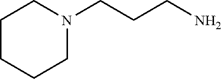
3-(1-piperidyl)propan-1-amine and isophorone diisocyanate,
(19) the reaction product of 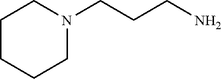
3-(1-piperidyl)propan-1-amine and hexamethylene-1,6-diisocyanate,
(20)the reaction product of 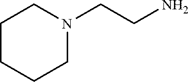
2-(1-piperidyl)ethanamine and isophorone diisocyanate,
(21)the reaction product of 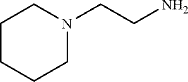
2-(1-piperidyl)ethanamine and hexamethylene-1,6-diisocyanate,
(22)the reaction product of 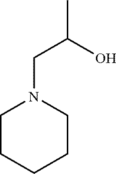
1-(1-piperidyl)propan-2-ol and isophorone diisocyanate,
(23)the reaction product of 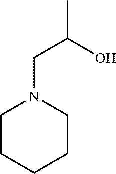
1-(1-piperidyl)propan-2-ol and hexamethylene-1,6-diisocyanate,
(24)the reaction product of 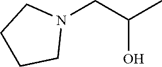
1-pyrrolidin-1-ylpropan-2-ol and isophorone diisocyanate,
(25)the reaction product of 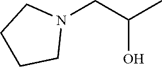
1-pyrrolidin-1-ylpropan-2-ol and hexamethylene-1,6-diisocyanate,
(26)the reaction product of 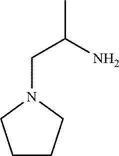
1-pyrrolidin-1-ylpropan-2-amine and isophorone diisocyanate,
(27)the reaction product of 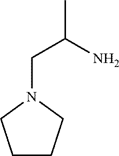
1-pyrrolidin-1-ylpropan-2-amine and hexamethylene-1,6-diisocyanate,
(28)the reaction product of 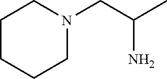
1-(1-piperidyl)propan-2-amine and isophorone diisocyanate,
(29)the reaction product of 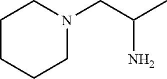
1-(1-piperidyl)propan-2-amine and hexamethylene-1,6-diisocyanate,
(30)the reaction product of 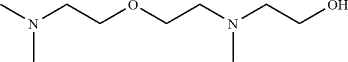
2-[2-[2-(dimethylamino)ethoxy]ethyl-methyl-amino]ethanol and isophorone diisocyanate,
(31)the reaction product of 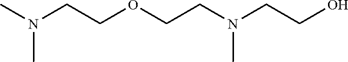
2-[2-[2-(dimethylamino)ethoxy]ethyl-methyl-amino]ethanol and hexamethylene-1,6-diisocyanate,
(32)the reaction product of 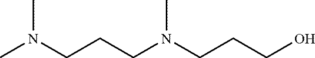
3-[3-(dimethylamino)propyl-methyl-amino]propan-1-ol and isophorone diisocyanate,
(33)the reaction product of 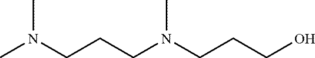
3-[3-(dimethylamino)propyl-methyl-amino]propan-1-ol and hexamethylene-1,6-diisocyanate,
(34)the reaction product of 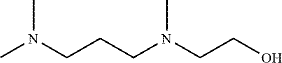
2-[3-(dimethylamino)propyl-methyl-amino]ethanol and isophorone diisocyanate,
(35) the reaction product of 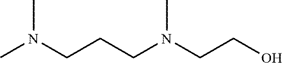
2-[3-(dimethylamino)propyl-methyl-amino]ethanol and hexamethylene-1,6-diisocyanate,
(36)the reaction product of 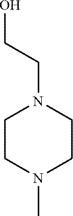
2-(4-methylpiperazin-1-yl)ethanol and isophorone diisocyanate,
(37)the reaction product of 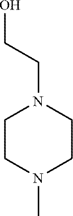
2-(4-methylpiperazin-1-yl)ethanol and hexamethylene-1,6-diisocyanate,
(38) the reaction product of 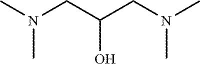
1,3-bis(dimethylamino)propan-2-ol and isophorone diisocyanate,
(39)the reaction product of 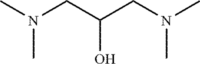
1,3-bis(dimethylamino)propan-2-ol and hexamethylene-1,6-diisocyanate,
(40)the reaction product of 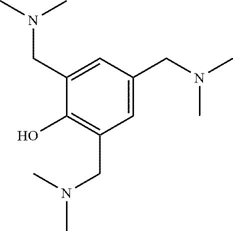
2,4,6-tris[(dimethylamino)methyl]phenol and isophorone diisocyanate,
(41)the reaction product of 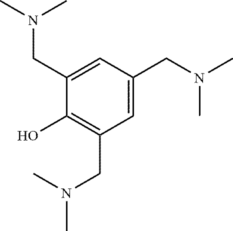
2,4,6-tris[(dimethylamino)methyl]phenol and hexamethylene-1,6-diisocyanate,
(42)the reaction product of 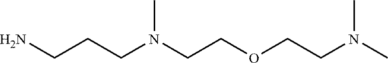
N′-[2-[2-(dimethylamino)ethoxy]ethyl]-N′-methyl-propane-1 ,3-diamine and isophorone diisocyanate,
(43)the reaction product of 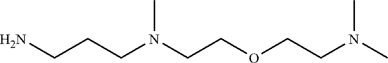
N′-[2-[2-(dimethylamino)ethoxy]ethyl]-N′-methyl-propane-1,3-diamine and hexamethylene-1,6-diisocyanate,
(44)the reaction product of 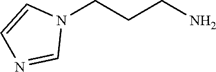
3-imidazol-1-ylpropan-1-amine and isophorone diisocyanate,
(45)the reaction product of 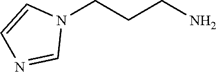
3-imidazol-1-ylpropan-1-amine and hexamethylene-1,6-diisocyanate,
(46)the reaction product of 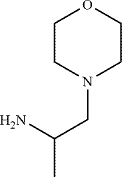
1-morpholinopropan-2-amine and isophorone diisocyanate,
(47)the reaction product of 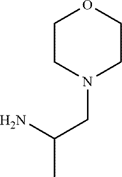
1-morpholinopropan-2-amine and hexamethylene-1,6-diisocyanate,
(48)the reaction product of 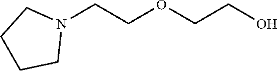 [SMILES: OCCOCCN1CCCC1]
2-(2-pyrrolidin-1-ylethoxy)ethanol and isophorone diisocyanate,
(49)the reaction product of 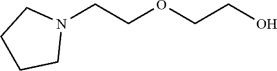 [SMILES: OCCOCCN1CCCC1]
2-(2-pyrrolidin-1-ylethoxy)ethanol and hexamethylene-1,6-diisocyanate,
(50)the reaction product of 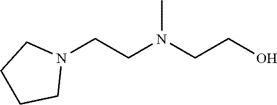
2-[methyl(2-pyrrolidin-1-ylethyl)amino]ethanol and isophorone diisocyanate,
(51)the reaction product 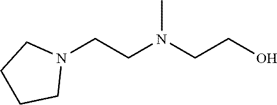
2-[methyl(2-pyrrolidin-1-ylethyl)amino]ethanol and hexamethylene-1,6-diisocyanate,
(52)the reaction product of 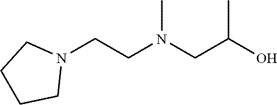
1-[methyl(2-pyrrolidin-1-ylethy)amino]propan-2-ol and isophorone diisocyanate,
(53)the reaction product of 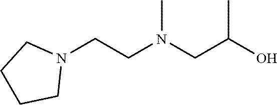
1-[methyl(2-pyrrolidin-1-ylethyl)amino]propan-2-ol and hexamethylene-1,6-diisocyanate,
(54)the reaction product of 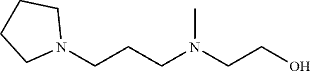
2-[methyl(3-pyrrolidin-1-ylpropyl)amino]ethanol and isophorone diisocyanate,
(55)the reaction product of 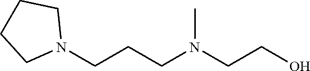
2-[methyl(3-pyrrolidin-1-ylpropyl)amino]ethanol and hexamethylene-1,6-diisocyanate,
(56)the reaction product of 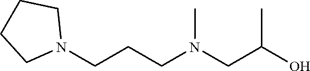
1-[methyl(3-pyrrolidin-1-ylpropyl)amino]propan-2-ol amine and isophorone diisocyanate,
(57)the reaction product of 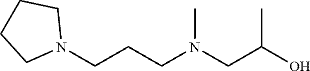
1-[methyl(3-pyrrolidin-1-ylpropyl)amino]propan-2-ol and hexamethylene-1,6-diisocyanate,
(58)the reaction product of 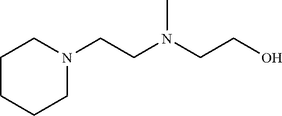
2-[methyl-[2-(1-piperidyl)ethyl]amino]ethanol and isophorone diisocyanate,
(59)the reaction product of 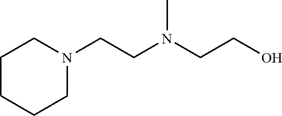
2-[methyl-[2-(1-piperidyl)ethyl]amino]ethanol and hexamethylene-1,6-diisocyanate,
(60)the reaction product of 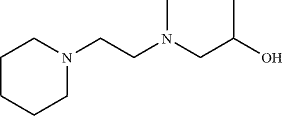
1-[methyl-[2-(1-piperidyl)ethyl]amino]propan-2-ol and isophorone diisocyanate,
(61)the reaction product 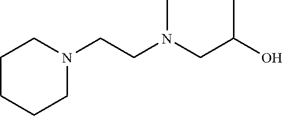
1-[methyl-[2-(1-piperidyl)ethyl]amino]propan-2-ol and hexamethylene-1,6-diisocyanate,
(62)the reaction product of 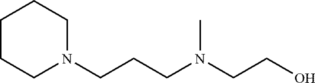
2-[methyl-[3-(1-piperidyl)propyl]amino]ethanol and isophorone diisocyanate,
(63)the reaction product of 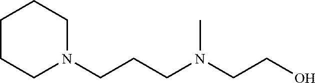
2-[methyl-[3-(1-piperidyl)propyl]amino]ethanol and hexamethylene-1,6-diisocyanate,
(64)the reaction product of 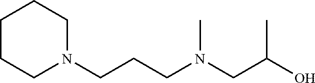
1-[methyl-[3-(1-piperidyl)propyl]amino]propan-2-ol and isophorone diisocyanate, and
(65)the reaction product of 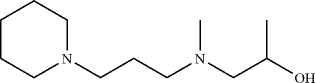
1-[methyl-[3-(1-piperidyl)propyl]amino]propan-2-ol and hexamethylene-1,6-diisocyanate.

14. The composition according to claim 1, wherein the at least one compound obtainable by reacting the at least one isocyanate compound and the at least one isocyanate-reactive compound having at least one tertiary amino group optionally in the presence of at least one Cu(II)-salt and optionally in the presence of one or more diluents, is reacted further with at least one isocyanate compound with the formation of biurets, allophanates, and isocyanurates of the compound.

15. The composition according to claim 1, wherein the at least one Cu(II)-salt is selected from Cu(II)-carboxylates.

16. The composition according to claim 1, comprising 10 to 99.991 wt-% of the compound(s) obtainable by reacting at least one isocyanate compound and at least one isocyanate-reactive compound having at least one tertiary amino group, 0.009 to 5 wt-%, preferable 0.05 to 3 wt-%, and 0 to 89.991 wt-% of the diluent(s), wherein the wt-% are based on the total weight of the composition.

17. The composition according to claim 1, which comprises one or more isocyanate-reactive compounds having at least one tertiary amino group.

18. The composition according to claim 1, which further comprises one or more additional catalysts for the formation of polyisocyanate polyaddition products.

19. The composition according to claim 1, which further comprises at least one carboxylic acid, selected from the group consisting of monocarboxylic acid compounds, polycarboxylic acid compounds, such as dicarboxylic acid compounds, and hydroxyl-functional carboxylic acid compounds.

20. The composition according to claim 1, which further comprises at least one carboxylic acid selected from the group consisting of salicyclic acid, benzoic acid, oxalic acid, malonic acid, succinic acid, glutaric acid, adipic acid, azelaic acid, sebacic acid, and citric acid,.

21. A process for the manufacture of the composition according to claim 1, which process comprises reacting at least one isocyanate compound and at least one isocyanate-reactive compound having at least one tertiary amino group in the presence of at least one Cu(II)-salt, and optionally in the presence of one or more diluents.

22. The process for the manufacture of the composition according to claim 1, which process comprises reacting at least one isocyanate compound and at least one isocyanate-reactive compound having at least one tertiary amino group, optionally in the presence of one or more diluents, and subsequently adding at least one copper(II)-salt.

23. The process for the manufacture of the composition according to claim 21, wherein the reaction is carried out at a temperature of about 20-140° C., more preferable about 40-120° C., and most preferable about 60-100° C.

24. The process for the manufacture of the composition according to claim 1 which does not comprise a Cu(II)-salt, as a catalyst.

25. (canceled)

26. (canceled)

27. (canceled)

28. (canceled)

29. A catalyst composition comprising the composition according to claim 1 which does not comprise a Cu(II)-salt.

30. A process for the manufacture of an isocyanate addition product comprising reacting an isocyanate compound with an isocyanate-reactive compound in the presence of the composition as defined in claim 1, which does not comprise a Cu(II)-salt.

31. The process for the manufacture of an isocyanate addition product, according to claim 30, wherein the isocyanate is a polyisocyanate and the isocyanate-reactive compound is a polyol, and the process is for producing a polyurethane, in particular a polyurethane foam.

32. The process for the manufacture of an isocyanate addition product according to claim 30, wherein the isocyanate addition product is a polyurethane selected from cellular or non-cellular polyurethanes, and the process optionally comprises a blowing agent.

33. The process for the manufacture of an isocyanate addition product according to claim 30, wherein the process is for producing a polyurethane, and the process optionally comprises the addition of a surfactant, a fire retardant, a chain extender, a cross-linking agent, an adhesion promoter, an anti-static additive, a hydrolysis stabilizer, a UV stabilizer, a lubricant, an anti-microbial agent, or a combination of two or more thereof.

34. The process for the manufacture of an isocyanate addition product according to claim 30, wherein the composition as defined in any of the previous claims is present in an amount of about 0.005 wt-% to about 5 wt-% based on the total weight of the total composition including all components.

35. An isocyanate addition product forming a foam obtainable from the process of the manufacture of an isocyanate addition product of claim 1 .

36. The isocyanate addition product forming a foam according to claim 35, selected from the group consisting of slabstock, molded foams, flexible foams, rigid foams, semi-rigid foams, spray foams, thermoformable foams, microcellular foams, footwear foams, open-cell foams, closed-cell foams, adhesives.
